(19) United States
(12) Patent Application Publication
(10) Pub. No.: US 2006/0178862 A1
(43) Pub. Date: Aug. 10, 2006

(54) Methods and systems for designing machines including biologically-derived parts

(76) Inventors: John Wing-Yui Chan, Research Triangle Park, NC (US); John Jacob Schwartz, Newton, MA (US); Joseph Jacobson, Newton, MA (US); Frank Don Lee, Chestnut Hill, MA (US)

Correspondence Address: GOODWIN PROCTER LLP;PATENT ADMINISTRATOR, EXCHANGE PLACE, BOSTON, MA, 02109-2881, US

(21) Appl. No.: 11/332,837

(22) Filed: Jan. 13, 2006

Related U.S. Application Data
(63) Continuation of application No. 09/996,249, filed on Nov. 28, 2001, now abandoned.
(60) Provisional application No. 60/262,983, filed on Jan. 19, 2001.

(51) Int. Cl. G06G 7/48; G06G 7/58

(52) U.S. Cl. 703/11; 716/1

(57) ABSTRACT

A preferred embodiment of the present invention comprises computer-implemented methods for providing user assistance in biomachine design that, first, retrieve one or more digitally-represented candidate design items stored in a bioengineering knowledge base by translating requirements provided for a biomachine according to a bioengineering domain model into queries to the knowledge base for design items capable of implementing the biomachine according to the domain model; then second, construct one or more digitally-represented candidate biomachines from the candidate design items by arranging part information represented in the candidate design items according to a selected structure, and next evaluate the candidate biomachines according to bioengineering operability knowledge associated with the candidate design items, wherein operability knowledge associated with a design item specifies requirements for that item to inter-operate with other design items. The methods may backtrack. If at least one candidate biomachine has not been satisfactorily evaluated, the methods backtracking to one or more of these steps. The invention further encompasses variations of these methods, systems and program products performing these methods, data products including digital representations of design knowledge used by these methods, data products with digital representations of designed biomachines. Also encompassed are further steps of constructing or synthesizing biomachines along with the actual biomachines themselves.

### CROSS REFERENCE TO RELATED APPLICATIONS

This application claims benefit of prior U.S. provisional application No. 60/262,983, titled “Modular Engineering of Biological Systems”, filed on Jan. 19, 2001, by inventors John J. Schwartz, and Joseph Jacobson.

### 1. FIELD OF THE INVENTION

The present invention relates to methods and systems for designing novel molecular-scale machines and processes. More particularly, the present invention is directed to computerized systems and methods for designing, as well as for assisting with designing, machines and processes including molecular components derived from, or patterned on, cellular and sub-cellular structures and processes.

### 2. BACKGROUND OF THE INVENTION

The extremely rapid development in all aspects of the biological sciences in the recent past is well known. Recent developments can be found in standard textbooks. For example, in the case of cell biology, see, e.g., Lodish et al., 2000, Molecular Cell Biology, W. H. Freeman and Co., New York, and for immunology, see, e.g. Riott, 1997, Riot's Essential Immunology, Blackwell Science Ltd., Oxford, U.K., and so forth. The accelerating pace of scientific development is easily seen by comparing these and other textbooks with their earlier editions (see, e.g., Lodish et al., 1986; Riott, 1971). There is no reason to believe that the pace of discovery will slacken in the coming years.

This development has resulted in great accumulation of highly detailed information. Examples include the sequencing and analysis of an increasing number of genomes, the determination and cataloging of the three-dimensional structure of tens of thousands of proteins, and the description of the organization and function of cellular control networks, and biochemical pathways. Electronic access and computer analysis of this data, much of which is routinely available over the World Wide Web (Web), has spawned the entirely new and rapidly growing field of bioinformatics. For recent developments in this field see, e.g., Baxevanis et al., 2001 2^{nd} ed., Bioinformatics A Practical Guide to the Analysis of Genes and Proteins, Wiley-Interscience, New York, and Kanehisa, 2001, Post-genome Informatics, Oxford University Press, Oxford, U.K.

These outstanding achievements have outdistanced the ability to Marshall the resulting information into novel, practical applications. Indeed, one key application of today's biological sciences is, as in the past, to find chemical compounds for physiologic activities that would suggest useful pharmacologic effects (lead compounds). Although todays lead compounds have much greater diversity and are searched for by increasingly sophisticated processes, the goal generally remains simply pharmacologic compounds and other agents.

In contrast, in other engineering arts such as electrical engineering, mechanical engineering, and chemical engineering, the growing body of technical accomplishments has led to many new applications and products. Well-known examples are found in electrical engineering where developments in semiconductor electronics and systems design have led to entirely new products such as microprocessors of geometrically increasing complexity and cell phones of ever diminishing weight. Among the practical factors enabling this innovation has been the development of algorithmically-based, computer-aided design (CAD) systems that have been able to automate many or most design-engineering tasks. In fact, especially in electrical engineering, it has become impossible to design complex microprocessors with millions of gates on a chip, or miniaturized multi-layer printed circuit boards without CAD systems.

Along with the development of CAD systems, has been the development of standardized classes of parts, which can be described by a modest number of broadly applicable interface parameters. For example, structural elements making up mechanical systems can often be characterized by a few numerical parameters such as the diameter and thread of a screw fastener or shaft power and RPM of a motor. Elements of different materials may be chosen on the basis of these parameters without detailed, or in many cases without any, knowledge of the material composition. In electronic systems, similarly, digital parts are typically parametrized by a logic description, and some types of analog parts by a transfer function. Useful circuits can often be designed without any knowledge of the semiconductor structures that implement the parts. Standardized parts enable CAD systems to exploit simplicity by “top-down” design through the regular application of and reuse of prior designs.

Biological systems have not heretofore generally been perceived as sources for corresponding bioengineering components or parts. The computational assistance supplied by the traditional CAD systems to enable engineering is not on a conceptual level appropriate for biological materials. In addition, the interactions between biological subsystems are complex. The behavior of biological components depends not only on intrinsic properties of the components themselves, but also fundamentally on the surrounding matrix of other components and interactions consequently, computer-assisted biomolecular engineering requires a more sophisticated data and knowledge management strategy than exist in available CAD systems.

For example, consider the problem of engineering protein parts to have a specified function. Since protein function is closely related to protein structure, traditional approaches to predictive design of a specified protein function would require predicting protein structure. But even a priori prediction of protein structure from a protein primary sequence is still beyond today's most advanced and powerful computers. Such a top-down approach to the design of a protein biomachine is therefore not presently practical.

Instead, much useful structure must instead be approximated in a “bottom-up” manner from known structures of proteins that have partially or fully homologous sequences. In other words, protein structure determination currently often depends on bottom-up study of individual proteins, and cannot yet be achieved by top-down application of general principles of molecular modeling. See generally, Leach, 2001 (2^{nd} ed.), Molecular Modeling Principles aid Applications, Pearson Education, Harlow, England; and Fersht, 1999, Structure and Mechanism in Protein Science: A Guide to Enzyme Catalysis and Protein Folding, W.H. Freeman and Co., New York.

Another reason for the inapplicability of engineering CAD systems is that, because engineering “parts” are considerably different from biological “parts,” prior computer representations of design knowledge are inapplicable, and even non-functional, for representing bioengineering design knowledge. In comparison to the parts available to, say, the electrical engineer, possible parts available in bioengineering exist in enormous diversity and phenomenal quantity. Specifically, nature provides a bewildering diversity of potentially useful types of entities, i.e., cells, sub-cellular organelles and components, individual molecular assemblies, molecules, molecular substructures such as domains and motifs, as well as organized metabolic pathways, control systems, signaling pathways and the like. Further, concrete and possibly useful instances of this diversity of types may be found in any of the incredible number of organisms that nature has evolved. Access to part instances will become easier as more and more organism genomes are sequenced. In contrast, the entire world's inventory of, e.g., mechanical and electrical parts may number no more than five to ten million and certainly has quite limited diversity.

Moreover, all of these engineering parts have been intentionally designed to a known intended purpose. For example, an electrical motor is designed to convert electrical power to mechanical power within selected constraints, and no more. However, each potential biological part, on the other hand, is likely to have a range of behaviors, each being exhibited in different specific conditions or in association with different specific cooperating entities. The computer-based knowledge representations and data structures of the more routine engineering arts simply fail to represent biological knowledge of such diversity, quantity, and behavioral diversity.

However, the biological sciences do not present insurmountable barriers to rational design. Close examination does suggest that natural entities are decomposable into subsystems that may be characterized in terms of purposes and behaviors likely to be useful in biomachines. For example, natural proteins are usually made up of domains that are homologous at least in structure to other domains successfully employed in other proteins. Large and complex biological machinery, such as eukaryotic RNA polymerases or chaperones, are assembled from many domains or modules often used for similar purposes in proteins of unrelated overall function. The ATPase motif found in chaperones for bringing misfolded proteins into the hydrophobic folding chamber is similar to the ATPase motif found in moving the myosin head for moving along an actin filament during muscle contraction. However, as “parts”, these decompositions have a different order of complexity than existing CAD systems are adapted to handle.

Further, although traditionally conceived of as an essentially descriptive science, current developments are beginning to uncover useful biological regularities. However, these regularities are often dependent as much on evolutionary principles as on the traditional conceptual frameworks relied on in other engineering design arts.

As explained below, the methods and systems of the present invention overcome these and other difficulties of computer-aided design of biomachines.

Citation or identification of any reference in this section or any section of this application shall not be construed that such reference is available as prior art to the present invention.

### 3. SUMMARY OF THE INVENTION

Objects of the present invention include overcoming these deficiencies in the prior art by providing systematic, computer-implemented methods to design, or to assist a user to design, a broad array of novel and useful entities (known as “machine designs”) using a diversity of biological starting materials, both naturally occurring and derived from naturally occurring materials, along with artificially synthesized materials (known as “parts”).

In one aspect, the present invention comprises a set of computerized methods and systems for accepting a partial biomachine design specification (also referred to herein as a “schema”), and automatically, or with additional prompted input, producing a more complete biomachine design specification. For example, a partial biomachine specification may comprise a purely functional description of a desired biomachine, or a partly structural and partly functional description. In either case, the more complete biomachine specification produced may range from a partly functional and partly structural description of a biomachine to a complete structural design specification with protocols for the manufacture or laboratory implementation of the biomachine.

In one embodiment, the invention comprises one or more ontologies for translating partial design specifications into one or more candidate sets of parts or part classes; one or more parts databases for storing and retrieving properties of parts; one or more sets of rules for determining the feasibility of assembly of candidate sets of parts; and one or more inference engines for verifying the feasibility of assembly.

In a first embodiment, the present invention includes a computer-implemented method for providing user assistance in biomachine design comprising: (a) translating requirements provided for a biomachine according to a bioengineering domain model into one or more digitally-represented candidate design items, the candidate design items represented being capable of implementing the biomachine requirements according to the domain model, and (b) constructing one or more candidate biomachines from the candidate design items by arranging the part information represented in the candidate design items according to a selected structure, whereby the candidate biomachines provide user biomachine-design assistance.

This embodiment includes the following further aspects: wherein the selected structure is represented in one or more of the candidate design items; wherein the selected structure represents an arrangement pre-determined independently of the candidate design items; further comprising the steps of: (a) evaluating the candidate biomachines according to bioengineering operability knowledge associated with the candidate design items, and (b) until one-or more candidate assemblies are satisfactorily evaluated, repeating one or more of the steps of translating, arranging, or evaluating; wherein the step of evaluating according to operability knowledge further comprises accessing the operability knowledge by means of digitally-represented links with the candidate design items; wherein the step of translating further comprises generating at least one candidate design item by applying digitally-represented bioengineering transition knowledge associated with candidate design items, wherein the transition knowledge associated with design items specifies how those design items may be transformed to related design items.

This embodiment includes the following further aspects: wherein the step of arranging further comprises combining digitally-represented manufacturing knowledge associated with the candidate design items of candidate biomachines into manufacturing plans for manufacturing physical realizations of the candidate biomachines, wherein manufacturing knowledge associated with a design item specifies sources for or protocols for making a physical realization of that design item; further comprising a step of manufacturing a physical realization of at least one candidate biomachine according to the manufacturing plan; further comprising a computer-implemented step simulating the operation of a physical realization of at least one candidate biomachine; wherein the steps of translating and arranging further comprises requesting user guidance; wherein design items are stored in a bioengineering knowledge base, and wherein the step of translating further comprises querying the knowledge base to retrieve candidate design items; wherein design items comprise digital representations of single physically-realizable entities; wherein design items further comprise digital representation of a plurality or class of physically-realizable entities; wherein the candidate design items comprise (i) structure information representing spatial arrangements of parts, and (ii) part information representing entities with composition and spatial structure, whereby the biomachines comprise spatially structured entities; wherein the candidate design items comprise (i) structure information representing arrangements of processing steps, and (ii) part information representing process transformations, whereby the biomachines comprise processes.

In a second embodiment, the present invention includes a computer-implemented method for providing user assistance in biomachine design comprising: (a) retrieving one or more digitally-represented candidate design items stored in a bioengineering knowledge base by translating requirements provided for a biomachine according to a bioengineering domain model into queries to the knowledge base for design items capable of implementing the biomachine according to the domain model, (b) constructing one or more digitally-represented candidate biomachines from the candidate design items by arranging part information represented in the candidate design items according to a selected structure, (c) evaluating the candidate biomachines according to bioengineering operability knowledge associated with the candidate design items, wherein operability knowledge associated with a design item specifies requirements for that item to inter-operate with other design items, and (d) until at least one candidate biomachine is satisfactorily evaluated, backtracking to steps (a), (b), or (c), whereby satisfactorily-evaluated candidate biomachines provide biomachine design assistance.

This embodiment includes the following further aspects: wherein the step of constructing further comprises arranging the part information according to structure information represented in one or more of the candidate design items; wherein digitally-represented candidate biomachines comprise at least one schema-type design item including the selected structure, and at least one part-type design item which is arranged according to the selected structure; wherein the requirements provided for the biomachine requirements further comprise at least one pre-determined design item, and wherein the candidate biomachines comprise the pre-determined design item; wherein the pre-determined design item includes purpose information for the biomachine; wherein the pre-determined design item includes part information for the biomachine; wherein the provided biomachine requirements further comprise one or more constraints that the candidate biomachines must satisfy; comprising a step of generating at least one candidate design item by applying digitally-represented bioengineering transition knowledge associated with the candidate design items, wherein transition knowledge associated with a design item specifies how that design item may be transformed to related design items.

This embodiment includes the following further aspects: wherein the step of arranging further comprises combining digitally-represented manufacturing knowledge associated with the candidate design items of the candidate biomachines into manufacturing plans for manufacturing physical realizations of the candidate biomachines, wherein manufacturing knowledge associated with a design item specifies sources for or protocols for making a physical realization of that design item; further comprising a step of manufacturing a physical ealization of at least one candidate biomachine according to the manufacturing plan; wherein the operability knowledge, the transition knowledge, and the manufacturing knowledge are stored in the knowledge base, and wherein the steps of evaluating, generating, and combining further comprise accessing this knowledge by means of digitally-represented associations with design items stored in the knowledge base.

This embodiment includes the following further aspects: wherein the step of retrieving requests user guidance for translating requirements into design-item queries; wherein the step of constructing further comprises requesting user guidance for arranging part information into candidate biomachines; further comprising a computer-implemented step simulating the operation of a physical realization of at least one candidate biomachine; wherein the knowledge base comprises: (a) schema-type design items having purpose information and structure information for arranging parts to achieve the purpose, and (b) part-type design items having information a physical description and behavior information; wherein the part-type design items having structures including biochemical items, or protein items, or genetic items, or cellular items, or multicellular items, or scaffold items; wherein the biochemical items include metabolites, or sugars, or polysaccharides, or lipids, or lipo-polysaccharides, or ions, or metal ion complexes, or coupling moieties, or phosphate, or amino acids, or phospholipids, or polynucleotides, or polypeptides; wherein the protein items include enzymatic proteins, or fluorescent proteins, or allosteric proteins, or DNA binding proteins, or signal transduction proteins, or transmembrane proteins, or transport proteins, or motor proteins, or mutlimeric proteins, antibodies, or single chain antibodies, or protein assemblies, or modified proteins, or proteins with conjugated moieties, or protein domains; wherein the genetic items include nucleic acids, or protein-encoding nucleic acids, or transcription control elements, or promoters, or translation control elements, or expression vectors, or polylinkers, or self-reproducing genetic elements, or cloning vectors, or polylinkers, or plasmids, or viral genomes or components thereof, or prokaryotic genomes or components thereof, or eukaryotic genomes or components thereof; wherein the cellular items include genetic regulatory networks, or signal transduction networks, or metabolic networks, or protein trafficking networks, or organelles, or lysozomes, or proteosomes, or spliceosomes, or ribosomes, or mitochondria, or chloroplasts; wherein the scaffold items include polymer linkers, or polypeptide linkers, or polynucleotide linkers, or lipid membranes, or lipid micelles and vesicles, or planar substrates, or glass substrates, or silicon substrates, or polymer substrates, or nylon substrates, or compartments, or arrangements of compartments linked by channels, or microtitre plates; wherein the multicellular items include tissue of uniform cell types, or tissue of mixed cell types, or a plurality of hepatocytes, or a plurality of myocytes, or a plurality of dermal cells, or a plurality of neurons, or a plurality of glial cells, or a plurality of lymphocytes, or a plurality of adipocytes.

This embodiment includes the following further aspects: wherein the digital representation of purposes and behaviors comprise a graph having nodes and edges, (i) the nodes being labeled by structural configurations and the edges being labeled by transitions between structural configurations, or (ii) the nodes being labeled by process transformations and the edges being labeled by flows between process transformations; wherein the step of constructing further comprises: (a) combining the behavior graphs of the candidate parts according to the candidate structures, and (b) accepting only candidate biomachines for which the combined behavior graphs are similar to the purpose graph of the biomachine requirements; wherein two behavior graphs are similar if (i) both are approximately isomorphic as graphs, and (ii) the labels of isomorphic pairs of nodes and edges are related according to a bioengineering ontology; wherein the step of translating further comprises testing that all or a portion of the purpose graph of the biomachine requirements is homomorphic the behavior graphs of the candidate design items, and wherein two behavior graphs are homomorphic if both are homomorphic as graphs, and if the labels of homomorphic nodes and edges are related according to a bioengineering ontology.

This embodiment includes the following further aspects: wherein the bioengineering domain model further comprises digital representations of a bioengineering domain ontology, a biomachine parts ontology, and a biomachine design ontology; wherein the biomachine design ontology includes a configuration sub-ontology, a behavior sub-ontology, and a purpose sub-ontology.

In a third embodiment, the present invention includes a computer-readable medium having biomachine design knowledge digitally-encoded therein, the design knowledge comprising representations of: (a) design items including structure information and part information, wherein a plurality of biomachine can be represented by combinations of part information according to structure information, and (b) bioengineering operability knowledge associated with the candidate design items, wherein operability knowledge associated with a design item specifies requirements for that item to inter-operate with other design items.

This embodiment includes the following further aspects: wherein the design items further comprise: (a) schema-type design items having purpose information and structure information for arranging parts to achieve the purpose, and (b) part-type design items having physical description information and behavior information; wherein the operability knowledge further specifies a likelihood that the associated design item inter-operates with other design items; further comprising transition knowledge associated with design items, wherein the transition knowledge associated with a design item specifies how that design item may be transformed to related design items; further comprising manufacturing knowledge associated with design items, wherein manufacturing knowledge associated with a design item specifies sources for or protocols for making a physical realization of that design item; further comprising a bioengineering domain model; wherein the bioengineering domain model further comprises: (a) a bioengineering ontology that represents semantic relations among bioengineering design concepts, (b) a bioengineering parts ontology that represents semantic relations among bioengineering parts, and (c) a bioengineering design ontology that represents semantic relations among bioengineering designs.

This embodiment includes the following further aspects: wherein the biomachine design ontology further comprises a configuration sub-ontology, a behavior sub-ontology, and a purpose sub-ontology; further comprising at least one computer-readable medium that is transferable between computers; further comprising at least one or more memory units accessible to one or more computer processors; wherein at least one memory unit is physically located remotely from at least one other memory unit, both memory units being communicatively connected.

In a fourth embodiment, the present invention includes a computer data product comprising at least one computer-readable media according to the third embodiment.

In a fifth embodiment, the present invention includes a computer-implemented method for providing user assistance in biomachine design comprising: (a) retrieving one or more digitally-represented candidate design items stored in a bioengineering knowledge base, the design items being retrieved by translating according to a bioengineering domain model design requirements provided for a biomachine, wherein the translating (i) generates retrieval queries for design items from the knowledge base, or (ii) generates additional design items from stored design items by applying associated bioengineering transition knowledge, the transition knowledge associated with a design items specifying how that design item may be transformed to related design items, wherein the knowledge base includes (i) schema-type design items having purpose information and structure information for arranging parts to achieve the purpose, and (ii) part-type design items having physical description information and behavior information, and wherein the domain model comprises data structures relating semantic structure of biomachine requirements to design items in the knowledge base, and (b) constructing at least one digitally-represented candidate biomachine, the biomachine representation including structure information referencing at least one part-type design item, wherein a biomachine representation is constructed from selected structure information referencing part-type design items by instantiating at least one referenced more-generic part-type design items with more-specific candidate part-type design items having description information encompassed with the description information of the more-generic design item, (c) evaluating the candidate biomachine according to digitally-represented operability knowledge, wherein operability knowledge associated with a design item specifies requirements for, or a likelihood that, that design item will inter-operate with other design items, and wherein the operability used for evaluation is select by association with the design items referenced by the candidate biomachines, and (d) until at least one candidate biomachine is satisfactorily evaluated, backtracking to steps (a), (b), or (c), whereby satisfactorily-evaluated candidate biomachines provide biomachine design assistance.

This embodiment includes the following further aspects: wherein the step of constructing comprises selecting structure information from candidate schema-type design items; wherein the step of backtracking further comprises: (a) performing the step of evaluating for all constructed candidate biomachines until at least one candidate biomachine is satisfactorily evaluated, and (b) if no candidate biomachine is satisfactorily evaluated, performing the steps of constructing and evaluating until at least one candidate biomachine is satisfactorily evaluated, and (c) if no candidate biomachine is satisfactorily evaluated, performing the steps of retrieving, constructing, and evaluating until at least one candidate biomachine is satisfactorily evaluated, and (d) if no candidate biomachine is satisfactorily evaluated, seeking guidance from a user.

This embodiment includes the following further aspects: wherein the domain model further comprises: (a) a bioengineering ontology that represents semantic relations among bioengineering design concepts, (b) a bioengineering parts ontology that represents semantic relations among bioengineering parts, and (c) a bioengineering design ontology that represents semantic relations among bioengineering designs; wherein the step of retrieving further comprises seeking user guidance in order to limit retrieval of candidate design items of less interest to the user, wherein the step of constructing further comprises seeking user guidance in order to limit construction of candidate biomachines of less interest to the user, and wherein the step of evaluating retrieving further comprises seeking user guidance in order to limit application of operability knowledge of less interest to the user.

In a sixth embodiment, the present invention includes a computer-implemented method for providing user assistance in biomachine design comprising: (a) retrieving one or more digitally-represented candidate design items stored in a bioengineering knowledge base by translating requirements provided for a biomachine according to a bioengineering domain model into queries to the knowledge base for design items capable of implementing the biomachine according to the domain model, (b) constructing one or more digitally-represented candidate biomachines from the candidate design items by arranging part information represented in the candidate design items according to a selected structure, (c) evaluating the candidate biomachines according to bioengineering operability knowledge associated with the candidate design items, wherein operability knowledge associated with a design item specifies requirements for that item to inter-operate with other design items, and (d) until at least one candidate biomachine is satisfactorily evaluated, backtracking to steps (a), (b), or (c), (e) combining digitally-represented manufacturing knowledge associated with the candidate design items of satisfactorily evaluated candidate biomachines into manufacturing plans for manufacturing physical realizations of the candidate biomachines, wherein manufacturing knowledge associated with a design item specifies sources for or protocols for making a physical realization of that design item, whereby satisfactorily-evaluated candidate biomachines accompanied by manufacturing plans provide biomachine design assistance.

In a seventh embodiment, the present invention includes a computer-implemented method for providing user assistance in selecting design items for biomachine design comprising: (a) translating requirements provided for a biomachine according to a bioengineering domain model into queries to a knowledge base for design items capable of implementing the biomachine according to the domain model, wherein the domain model comprises (i) a bioengineering ontology that represents semantic relations among bioengineering design concepts, (ii) a bioengineering parts ontology that represents semantic relations among bioengineering parts, and (iii) a bioengineering design ontology that represents semantic relations among bioengineering designs, and wherein the knowledge base includes (i) design items comprising structure information and part information, wherein a plurality of biomachine can be represented by combinations of part information according to structure information, and (ii) bioengineering operability knowledge associated with the candidate design items, wherein operability knowledge associated with a design item specifies requirements for that item to inter-operate with other design items, (b) retrieving at least one candidate design item and associated operability knowledge from the knowledge base according to the queries, and (c) providing to the user the retrieved design item information and operability knowledge as design assistance, whereby the user may select design items for biomachine design.

This embodiment includes the following further aspects: wherein the knowledge base further comprises (i) transition knowledge associated with design items, wherein the transition knowledge associated with a design item specifies how that design item may be transformed to related design items, and (ii) manufacturing knowledge associated with design items, wherein manufacturing knowledge associated with a design item specifies sources for or protocols for making a physical realization of that design item, wherein the step of retrieving further comprises retrieving transition knowledge and manufacturing knowledge associated with retrieved design items, and wherein the step of providing to the use further comprises providing the retrieved transition knowledge and manufacturing knowledge wherein the step of translating further comprises seeking user guidance in requirements translation.

This embodiment includes a computer-implemented method for providing user assistance in configuring a biomachine design from predetermined digitally-represented design items retrieved from a bioengineering knowledge base, wherein the design items comprise structure information and part information, the method comprising: (a) constructing one or more candidate biomachines from the pre-determined design items by arranging part information represented in the candidate design items according to a selected structure, and (b) evaluating the candidate biomachines according to bioengineering operability knowledge associated with the pre-determined design items, wherein operability knowledge associated with a design item is stored in the knowledge base and specifies requirements for that item to inter-operate with other design items, wherein candidate biomachines and their evaluations provide biomachine design assistance.

This embodiment includes the following further aspects: further comprising combining digitally-represented manufacturing knowledge associated with the candidate design items of satisfactorily evaluated candidate biomachines into manufacturing plans for manufacturing physical realizations of the candidate biomachines, wherein manufacturing knowledge associated with a design item is stored in the knowledge base and specifies sources for or protocols for making a physical realization of that design item; wherein the step of constructing further comprises arranging the part information according to selected structure information represented in one or more of the candidate design items; wherein digitally-represented candidate biomachines comprise at least one schema-type design item including the selected structure, and at least one part-type design item which is arranged according to the selected structure; further comprising a computer-implemented step simulating the operation of a physical realization of at least one candidate biomachine, and wherein the design assistance further comprises simulation results.

In an eighth embodiment, the present invention includes a method of manufacturing a biomachine comprising: (a) determining an manufacturing plan for a biomachine according to the method of claim 60, and (b) performing the manufacturing plan in order to manufacture the biomachine.

This embodiment includes the following further aspects: wherein at least one portion of the manufacturing plan comprises instructions for automated equipment, and wherein that portion of the manufacturing plan is performed by automated equipment in response to the instructions; further comprising a step of testing a manufactured instance of the biomachine.

In this embodiment the invention also includes a biomachine manufactured according to this embodiment.

In a ninth embodiment, the present invention includes a biomachine data set comprising digital data representing: (a) at least one part-type design item, wherein a part-type design item has physical description information and behavior information, and (b) selected structure for arranging the part-type design items as a biomachine, and (c) a manufacturing plan for manufacturing physical realizations of the biomachine.

This embodiment includes the following further aspects: further comprising at least one schema-type design item that has purpose information and structure information for arranging parts to achieve the purpose, and wherein the selected structure is provided by the schema-type design elements; further comprising (a) bioengineering operability knowledge associated with the design items, wherein operability knowledge associated with a design item specifies requirements for that item to inter-operate with other design items, (b) transition knowledge associated with design items, wherein the transition knowledge associated with a design item specifies how that design item may be transformed to related design items, and (c) manufacturing knowledge associated with design items, wherein manufacturing knowledge associated with a design item specifies sources for or protocols for making a physical realization of that design item, and wherein the manufacturing plan is a combination of the manufacturing knowledge associated with the design items; wherein the manufacturing plan is determined according to the eighth embodiment.

The embodiment also includes a computer data product comprising at least one computer-readable media having recorded therein at least one biomachine data set, and a physical realization of a biomachine data set according to claim 73, and a biomachine comprising an implementation of a biomachine part according to claim 78.

In a tenth embodiment, the present invention includes a computer system for designing an instance of a biomachine model comprising: (a) a computer processor, and (b) a computer memory accessible to the processor and storing digital data representing (i) a bioengineering knowledge base comprising (i) schema-type design items having purpose information and structure information for arranging parts to achieve the purpose, and (ii) part-type design items having information a physical description and behavior information, (ii) a bioengineering domain model comprising digital representations of a bioengineering domain ontology, a biomachine parts ontology, and a biomachine design ontology, and (iii) a program for causing the processor to perform the steps according to first embodiment.

In an eleventh embodiment, the present invention includes a computer system for designing an instance of a biomachine model comprising: (a) a computer processor, and (b) a computer memory accessible to the processor and storing digital data representing (i) a bioengineering knowledge base comprising (i) schema-type design items having purpose information and structure information for arranging parts to achieve the purpose, and (ii) part-type design items having information a physical description and behavior information, (ii) a bioengineering domain model comprising digital representations of a bioengineering domain ontology, a biomachine parts ontology, and a biomachine design ontology, and (iii) a program for causing the processor to perform the steps according to the second embodiment.

This embodiment includes the following further aspects: wherein the computer memory further stores digital data representing: (a) bioengineering operability knowledge associated with the design items, wherein operability knowledge associated with a design item specifies requirements for that item to inter-operate with other design items, (b) transition knowledge associated with design items, wherein the transition knowledge associated with a design item specifies how that design item may be transformed to related design items, and (c) manufacturing knowledge associated with design items, wherein manufacturing knowledge associated with a design item specifies sources for or protocols for making a physical realization of that design item, and wherein the manufacturing plan is a combination of the manufacturing knowledge associated with the design items; wherein the computer memory comprises a plurality of individual, physically-distinct memory units all accessible to the processor; wherein one or more of the individual memory units is located remotely from the processor, and wherein the system further comprises one or more network links communicatively connecting the processor and the remote memory units.

This embodiment includes the following further aspects: wherein the computer memory further stores digital data representing a program for causing the processor to display to the user an interface for seeking user guidance and for displaying progress of the design; wherein the user display is structured as a graphical user interface.

This embodiment also includes a program product comprising a computer readable medium, the computer readable medium comprising stored digital data representing the program recited and a data product comprising a computer readable medium, the computer readable medium comprising stored digital data representing the bioengineering domain model and knowledge base as recited.

Citation or identification of any reference in this Section or any section of this application shall not be construed that such reference is available as prior art to the present invention.

### 4. BRIEF DESCRIPTION OF THE FIGURES

The present invention may be understood more fully by reference to the following detailed description of the preferred embodiment of the present invention, illustrative examples of specific embodiments of the invention and the appended figures in which:

FIG. 1—schematically depicts one preferred set of methods of the present invention;

FIG. 2—schematically depicts preferred design knowledge representations according to the present invention;

FIG. 3—an exemplary portion of parts in the design item knowledge-base;

FIG. 4—an exemplary design process according to the present invention;

FIG. 5—partial schema of parts database;

FIG. 6—system architecture;

FIG. 7—state diagram;

FIG. 8—example of design ontology segments;

FIG. 9—example of sensor ontology segments;

FIG. 10—example of transducer ontology segments;

FIG. 11—example of optical transducer ontology sub-segments;

FIG. 12—schematic design case;

FIG. 13—concrete design case structure without bound ligand;

FIG. 14 concrete design case structure with bound ligand;

FIG. 15—example of graphical user interface (GUI) for inputting requirements into the system;

FIG. 16—example of a spreadsheet used for entering the operational states of the biomachine;

FIG. 17—example of a state diagram (drawn using the GUI) that represents the operation of the biomachine;

FIG. 18—example of the GUI prompting for additional requirements of the design;

FIG. 19—example of the GUI prompting for additional requirements of the design, with ongoing real-time synchronization;

FIG. 20—example of the knowledge-base search for existing parts and biomachines that potentially match requirements;

FIG. 21—example of the knowledge-base search results for a specific part;

FIG. 22—example of GUI window showing the structure of a specific part;

FIG. 23—example of design assembly and simulation of a biomachine; and

FIG. 24—EXAMPLE OF THE DESIGN DETAILS AND SIMULATION RESULTS FOR A DESIGN.

### 5. DETAILED DESCRIPTION OF THE PREFERRED EMBODIMENTS

The present invention provides systematic computer-implemented methods, computer systems, and program and database products that design, or that assist a user to design, a broad array of novel and useful biomachines built from parts including a diversity of biological starting materials, both naturally occurring and derived from naturally occurring materials, along with artificially synthesized materials. In many embodiments, the outputs of the invention are digital representations of biomachine designs from which a biomachine may be synthesized or otherwise constructed. In other embodiments, the invention contemplates actually synthesizing or constructing a biomachine according to an output design, and optionally testing or otherwise verifying the actual function of the design.

Biomachines Generally

Specifically, a biomachine according to the present invention is an entity explicitly designed from, or in analogy to, natural sources so that it performs or expresses one or more pre-determined functions or purposes. Biomachine designs necessarily prescribe some molecular-scale (taken to be on the order of nm or tens of Å) manipulations or modifications, although they may also optionally include further manipulations at other larger, even macroscopic (taken to be of the order of 0.1 mm to 1 mm or greater), scales. For example, a biomachine designed according to the present invention may specify a protein engineered to have a new combination of functions; another design may specify attaching this protein to a macroscopic surface so that the surface may have the new functions; and a further design may specify incorporating this protein into a virus or a single-celled or multicellular living thing, and so forth. Thus, although operation and construction a biomachine according to the design necessarily involves molecular-scale manipulations, the scale of the biomachine itself may be molecular, microscopic (taken to be of the order of 1 μm), or macroscopic, and the biomachine itself may be inanimate or animate. The purpose of a biomachine may also simply be to do what nature already does, but to do it differently or better.

The molecular-scale manipulations may in many embodiments include alterations to chemical bonds in biochemically-known compounds. Such biochemical compounds may be from any known biochemical class, for example, proteins (including peptides), nucleic acids (including RNA and DNA of all lengths), lipids, polysaccharides, small molecules (such as cofactors, ions, and so forth), and include compounds with mixed building blocks, for example, post-translationally modified proteins, lipo-polysaccharides, and so forth. In many other embodiments, molecular-scale manipulations and/or modifications may be limited alterations in non-bonding interactions. In still other embodiments, a biomachine design may prescribe altering a temporal structure of molecular-scale interactions (instead of a spatial or a structural alteration) that is modified from, or in analogy to, a natural system. One temporal structure may be the sequential interactions of a metabolic pathway, which may be altered to produce a new product or a new distribution of existing products and may be implemented in vitro or in vivo. For a further example, a temporal structure may be molecule-molecule interactions, which achieve metabolic or genetic regulation. Here the regulatory unit may be adapted in an animate biomachine so that it regulates a new function or a new molecule.

In summary, then, a biomachine that may be designed by the present invention includes a temporal or spatial structure that has been altered from, or in analogy to, a naturally occurring structure in order to achieve the pre-determined design purpose that may be implemented from a molecular to a macroscopic scale, and in animate (in vivo) or inanimate (in vitro) systems

The Methods and Structures of this Invention Generally

In certain preferred embodiments, the methods and systems of the present invention that produce a biomachine design, starting from functional requirements for a biomachine and returning a biomachine design. More particularly, starting from a digitally encoded representation of biomachine requirements, these preferred embodiments produce a digitally encoded design representation for a biomachine that meets (or nearly closely meets) the input requirements. Also, the methods may start from input of a partial or complete biomachine design (instead of or in addition to functional requirements) and return a more complete, or an improved or altered, design, respectively.

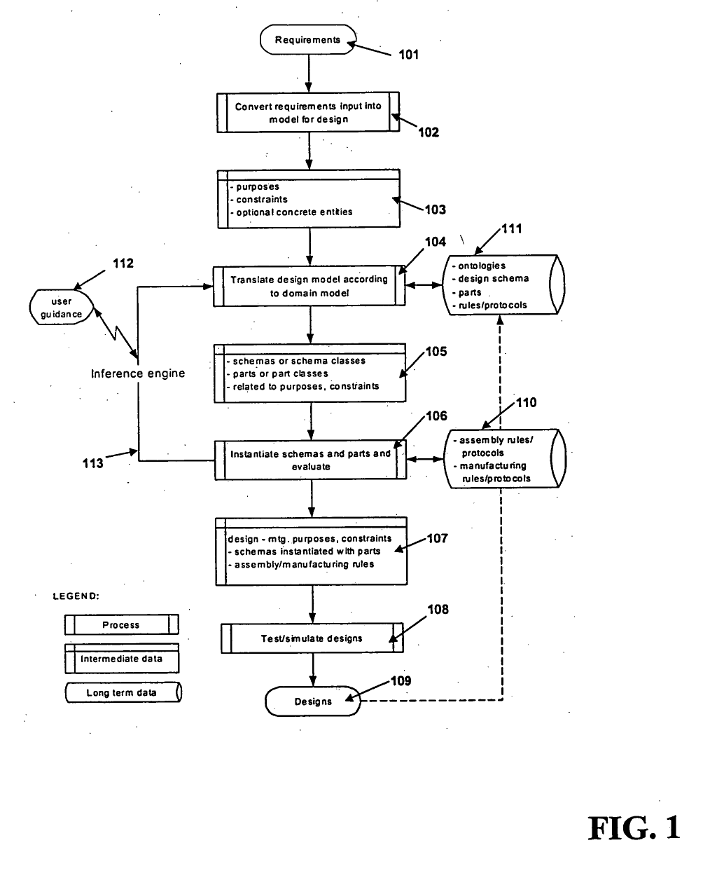

FIG. 1 schematically illustrates one set of preferred methods of the present invention. Starting from input requirements or designs, the methods refer to design knowledge (preferably also digitally encoded) to first determine candidate parts or candidate classes of parts 105, including bio-derived parts, which are estimated to be suitable for realizing the requirements. Also derived, especially where the input is limited to functional requirements without prior design information, are candidate designs, or classes of designs, which (along with the candidate parts) are estimated to meet the input requirements. Preferably, during this candidate-selection process, the invention's methods may communicate 112 with a user in order to resolve requirements ambiguities and to narrow requirements scope. Associated with individual candidate parts and candidate designs (collectively, “design items”) is further knowledge, preferably derived from concrete (for example, laboratory) experience that conveys requirements, limitations, and so forth on the uses and combinations of the design items that actually achieve functions and results. This knowledge may be expressed as, for example, rules, which relate functions achievable with individual design items to the requirements and combinations necessary to achieve these functions. Candidate biomachine representations are assembled from the design items, along with any input design information and requirements. Only assemblies of design items that meet all applicable rules 106 are considered as candidate design items.

Candidate assemblies may then be optionally tested 108 in several manners. Simulation methods and products may be employed to verify components of the designed machines. For example, do molecular designs behave (when simulated) in accord with expectations from the assembly rules? Are simulated chemical reactivities, chemical transformations, mechanical conditions, and so forth, in accord with the expectations? In some cases, simulation tools may be used to verify function of the biomachine as a whole. Confidence that a candidate will function as required is enhanced by such simulation.

The present invention further contemplates laboratory testing after actually making a biomachine according to a candidate design. A biomachine design that has been successfully laboratory tested may be added to design knowledge, and used as an item in future designs.

Additionally, the invention includes systems that perform, and software products that encode, the above methods. Transferable data products are also included in the invention, including representations of biomachine designs, portions or all of the design knowledge employed by the above methods, and so forth. The invention also contemplates data-mining methods for extracting additional design knowledge from various sources, such as journal publications, public databases, and so forth. New design items, parts and designs (having known functions), may be found in this manner.

### 5.1 Knowledge Representation and Inference Processes

This subsection describes in detail general, but preferred, embodiments of the present invention. First the representations of parts, designs, and biomachines are discussed. This is followed by discussion of design knowledge (domain models and design items), then of the inference process, and lastly of optional design testing.

5.1.1 Biomachine Representations

Biomachine design representations are used for several purposes in the present invention, namely, as elements of design knowledge and as inputs to, and outputs from; the design methods. In preferred implementations, design knowledge includes information about known designs with (preferably) tested functions, which can be used as models for further designs. Also, inputs to the design methods may be considered as partial designs, and outputs as more complete or more specified designs. Requirements for a biomachine are simply a highly generic design (such as a functional specification) for one or more biomachines satisfying the requirements. On the other hand, a user may already have a partial design, which needs to be completed in order to be makeable. Parts of the design needing completion may be referred to as, for example, variables to be instantiated. Design output may then be considered a more complete, but not necessarily a manufacturably complete, design.

It is accordingly advantageous that uses of design representations in the invention have a consistent and standard format. In the following, the present invention is described as if that were the case, and moreover for economy and concreteness, a particular exemplary format for design representation is chosen. However, in other embodiments, it may be advantageous to use other format standards, or even to use specialized, or even entirely different, design representations for different purposes.

Design Representations—Purposes

A design representation according to the present invention preferably includes at least a purpose attribute that describes at least one function or goal that the design is intended to achieve. If the design representation is a functional requirement input to the design methods, it may not hold further information. However, in most cases, a design representation will also hold at least some structure, including component parts and their arrangement in greater or lesser detail, for a biomachine that can achieve the represented purpose. Further, in preferred embodiments, design representations will hold (or accomodate) many additional design attributes, of which some important ones are discussed in the following. Other embodiments may include or accommodate attributes not discussed herein.

The purpose attribute of a biomachine represents what the biomachine is designed or intended to accomplish, its actions or outputs, and the conditions necessary to cause the actions or outputs with minimal reference to implementation. There can be, of course, no exhaustive list of purposes. Each particular biomachine application typically will require biomachines with particular actions or outputs, that is, with particular purposes that may perhaps never have been previously implemented in a biomachine. As long as (molecular-scale) biological entities may be found with behaviors that can be adapted to the new purpose, the methods of this invention can suggest likely biomachine designs.

Additionally, the present invention may be applied to design protein machines based on developments such as are reported by, for example, the following set of references (and descriptions). Baird et al., 1999, Proc Natl. Acad. Sci. USA 96:11241 (insertions of domains and proteins change can modify fluorescence of GFP and related proteins; circular permutations can alter orientations without modifying fluorescence). Baron et al., 1999, Proc. Natl. Acad. Sci. USA 96:1013 (mutation of DNA binding region of tetracycline transactivator confers new operator sensitivity so that combinations of wild type and modified transactivators can be controlled to switch expression between two genes in a mutually exclusive manner). Benson et al., 2001, Science 293:1641 (uses hinge bending motion known in bacterial periplasmic binding proteins coupled to redox-active Ru(II) that interact with electrode surface to create ligand sensitive bioelectronic devices). Brennan et al., 1995, Proc. Natl. Acad. Sci. USA 92:5783 (insertion of linear epitope in E. coli alkaline phosphatase creates signaling protein sensitive to anti-epitope Ab). Chemla et al., 2000, Proc. Natl. Acad. Sci. USA 97:14268 (magnetic detection of ligand bound to surface by use of Abs with attached magnetic nano-particles, magnetc field measurements made with SQUID). Eisenberg et al., 2000, International publication no. WO 00/42219 (methods for selecting a target site within a target sequence for a zinc finger proteins). Firestine et al., 2000, Nature Biotech. 18:544 (system for detection of enzymatic activity in bacteria). Hofman et al., 1996, Proc. Natl. Acad. Sci. USA 93:5185 (a retroviral vector for Tet inducible regulatory cassette for transgene expression in eukaryotic cells). Malby et al., 1998, J. Mol. Biol. 279:901 (an scFv with a 15 amino acid linker is sufficiently flexible for the VH and VL domains on one molecule to associate, with a 5 amino acid linker two molecules dimerize with the VH and VL domains of different molecule associated). Marvin et al., 1997, Proc. Natl. Acad. Sci. USA 94:4366 (E coli maltose binding protein has identified regions allosterically responsive to maltose binding, environmentally sensitive fluorophores attached to which exhibit fluorescence changes on maltose binding). Porumb et al., 1994, Protein Eng. 7:109 (Ca²⁺ binding protein with large allosteric effect; a fusion of CaM, glycylglycine linker, CaM binding region of myosin light-chain kinase, M13). Tsien et al., 1999, U.S. Pat. No. 5,998,204 (discloses and claims a clasp-like device where ligand binding induces a conformational change in a binding protein that is transduced by a FRET transducer, in particular where the binding protein is a CaM-M 13 fusion and the FRET transducer is a pair of GFP variants). Tsien, 1998, Annu. Rev. Biochem. 67:509 (properties of GFP and mutants; uses as a passive tag or indicator; uses as an active indicator including pH and phosphorylation sensitive mutants and uses as a FRET pair where a protease separates GFPs, transcription factor dimerization associates GFPs, and calmodulin or CaM binding peptides, such as skeletal muscle M13 or from avian smooth muscle, either associate or separate in the presence of Ca²⁺ and CaM). Whaley et al., 2000, Nature 405:665 (peptides can be found from phage display that bind with specificity, univalent or bivalent, to semiconductor and other inorganic crystal surfaces, such peptides having potential use in directing the assembly of nano-structures).

Without limitation, therefore, the following lists some common purposes and related actions or outputs: real-time sensors for various classes of molecules (proteins, metal ions, etc.), or for specific molecules, having various types of observable outputs (fluorescent signals, chromogenic changes); event recorders that preserve and output a record (by permanent, observable changes in the recorder, etc.) of specific events (presence or absences of specific molecules. etc.) for later analysis; molecular traps and sieves that act by sequestering (or precipitating, tagging, altering) particular molecules when encountered; control systems that act to regulate (intra- or extra-cellular) concentrations of particular molecules; controlled movers that act as transports or delivery systems, moving select molecules or nano-particles to specified locations or repositories; chemical conversions (constitutive or triggered by stimuli, or so forth); force generators that act to generate forces for control of nano-assemblages upon receipt of signals (and nano-machines incorporating force generators); and so forth. Such purposes have utility in a wide number of medical and engineering fields, for example: in vivo monitoring of diagnostic or therapeutic indicators; macrophage-like in vivo targeting of therapeutics; sensing and monitoring of environmental conditions and toxins; industrial process control; biocatalysis, energy generation, conversion and storage, etc.

For example, tetracycline control system may be incorporated as parts of biomachines relating to cellular control. See, e.g., the following references: Alberts, 1998, Cell 92:291 (complex multimeric machines including protein components are key in many cellular functions such as protein folding, linear motion, and so forth); Blau et al., 1999, Proc. Natl. Acad. Sci. USA 96:797 (tetracycline controllable transcriptional regulators delivered to eukaryotic cells by by retroviral vectors); Gossen et al., 1992, Proc. Natl. Acad. Sci. USA 89:5547 (E coli tetracycline repressor TetR fused with C terminal of VP16 activator from HSV stimulates CMV-derived minimal promoter fused to tetracycline operator sequences in a tetracycline controlled manner); Kringstein et al., 1998 Proc. Natl. Acad. Sci. USA 95:13670 (demonstrates graded response to tetracycline responsive transactivators); Shockett et al., 1996, Proc. Natl. Acad. Sci. USA 93:5173 (summarizes Tet controllable expression systems).

Further developments of genetic regulation adaptable to biomachine design by the methods of this invention include, e.g.: Becksei et al., 2000, Nature 405:590 (negative feedback gene-transcription regulation circuit designed by tetracycline repressor GFP fusion gene controlled by lambda promoter with tetracycline operator); Dunlap, 1999, Cell 96:271 (molecular bases of circadian clocks); Elowitz et al., 2000, Nature 403:335 (an oscillatory genetic transcription-translation network using three sequentially acting repressors); Gardner et al., 2000, 403:339 (a bistable genetic transcription-translation network using two linked repressors); Glansdorffet al., 1971, Thermodynamic Theory of Structure, Stability, and. Fluctuations, Wiley-Interscience, London; Ishiura et al., 1998, Science 281.: 1519 (gene expression in cyanobacteria as a circadian feedback process); Monod et al., 1961, Cold Spring Harb. Symp. Quant. Biol. 26:389 (construction of general regulatory circuits from a limited number of basic control elements).

Additionally, useful parts and design knowledge may be found from commercial sources. See, for example, Molecular Probes, Inc., Eugene Oreg. (www.probes.com/handbook/sections/0069.html) (fluorophore sensitivity to environmental factors can be utilized in transducers, such sensitivities as pH and solvent polarity, changes in quantum yield on binding, self-quenching and other quenching processes, ekcimer formation, and so forth).

The conditions necessary for biomachine function, like purposes, actions, and outputs, can not be exhaustively listed, because any condition to which a biological entity is responsive may be adapted to the biomachines designed according to this invention. Briefly, necessary conditions include both general environmental factors as well as particular external stimuli. General environmental factors may include, for example, physical and chemical factors such as temperature, pH, ionic strength, concentration of certain ions (Mg²⁺, Ca²⁺, etc.), redox state (glutathione, NAD/NADH, etc.), energy sources (ATP, GTP, etc.). Particular external stimuli may include, for example, chemical stimuli such as concentrations of ligands, substrates, cofactors, and so forth, of all types (small molecules, proteins, lipids, nucleic acids, etc.), physical stimuli such as applied voltages, radiation, and so forth.

Representation of purposes (also referred to as purpose attributes) is structured so that this invention's computer-implemented design methods have ready access to the condition, stimuli, and response components of a purpose. Advantageously, the representation is according to descriptive paradigms or languages already known in the computer arts. Two exemplary descriptive paradigms are finite-state-machine state diagrams, such as Unified Modeling Language (UML) state diagrams, and a procedural language subset limited to (for example) IF-THEN-ELSE statements, perhaps combined with CASE statements. See, e.g., Rumbaugh et al., 1998 1^{st} ed., The Unified Modeling Language Reference Manual (UML), Addison Wesley Longman, Inc. Generally, any finite state diagram can be represented by similar code having one case alternative for each state, and vice versa. More compact representations are also possible. Further, CASE statements may be eliminated by nested F-THEN-ELSE statements.

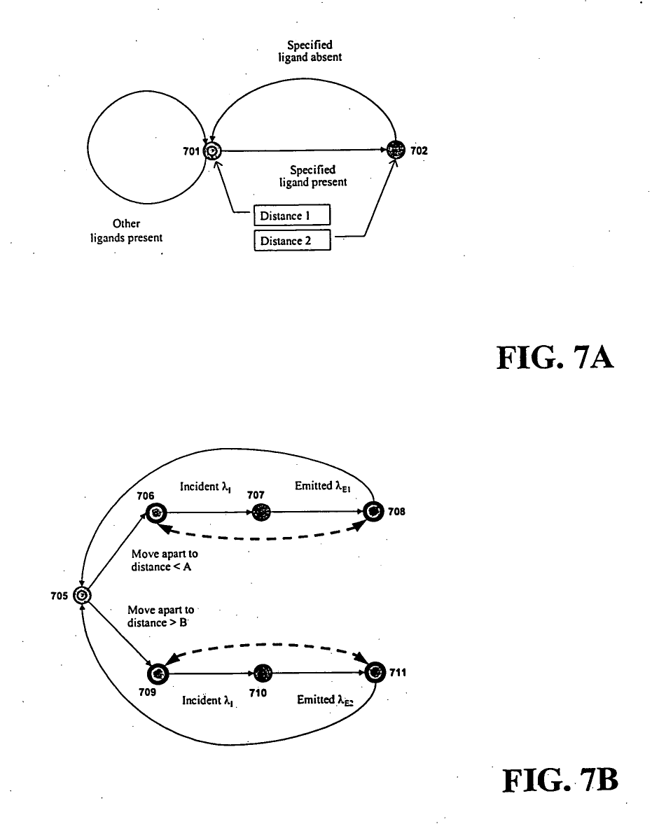

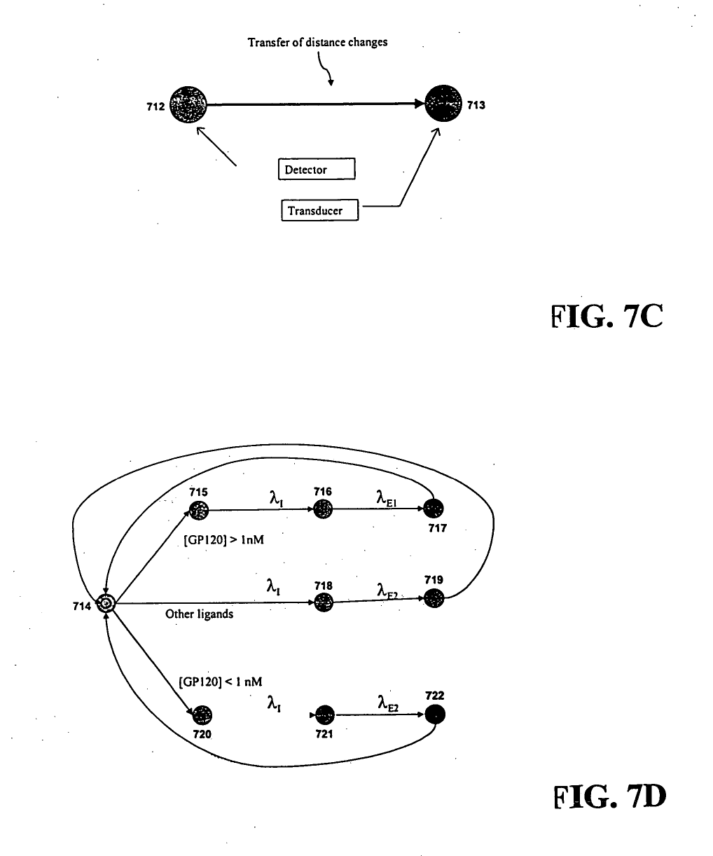

Examples of these exemplary preferred representations are discussed next. The state diagram of FIG. 7A, and the equivalent “code”, exemplify a particularly simple design purpose, a spatially-allosteric sensor that is sensitive only to a specified ligand (such as a protein antigen), and that produces a known distance change (for example, between identified surface residues) upon binding the specified ligand. (Another sensor may respond to the distance change, for example, by emitting a visible signal or sequestering the ligand.) No other ligands produce any allosteric effect. This state diagram has a “start” state, S₀ at 701 in which the identified residues are at a first distance 1. In this state, the sensor is receptive only to the specified ligand, which, if present, causes the machine to transition to a “bound” state, S₁ at 702, in which the residues are at a second distance 2. No other ligands cause any allosteric transition out of the start state. (Sensors that exhibit only minimal or no allosteric effect on binding of the desired ligand, i.e. distance 1=distance 2, would not satisfy the expressed design purpose.) When in the bound state, the machine is not sensitive to any ligands, but, if the specified ligand is removed, the bound state reversibly returns to the start state and during decay back to the start state So, performs the “response.”

For purposes of storage in a computer memory, this and other state diagrams may be represented as a list of nodes. For each node the list containing the transitions from this node to other nodes is labeled by the cause or effect of the transition.

State diagrams can, of course, be routinely translated in equivalent procedural code. The following procedural code in a Java-like syntax defines a class of ligand detectors, which is a subclass of a (hypothetical) more generic class of detectors of any sort. Here, the class representation responds to the presence or absence of a ligand by changing the inter-residue distance, which may be externally sensed. The detector uses two states to remember whether or not the ligand is currently bound.

| // design class: allosteric ligand detector | |
|---|---|
| public class LigandDetector extends Detector { | |
| distance | : distance between identified residues in Å |
| S0, S1 | : states |

```
    public SetLigandPresentOrAbsent (ligand_present) {
        current_state = S₀;
        distance = distance_1
        CASE (current_state)
            S₀:  { IF (ligand_present)
                    THEN { (current_state = S₁;
                        (distance = distance_2) }
                    ELSE { (current_state = S₀); } };
            S₁:  IF (NOT ligand_present)
                    THEN { (current_state = S₀);
                        (distance = distance_1) }
                    ELSE { (current_state = S₁); } };
        END_CASE }
    public CheckDistance (current_distance) {return distance}
    }
```

This object-oriented ligand-detector representation advantageously separates the external parameters available for use, namely, ligand presence or absence, and the resulting inter-residue distance, from the internal details, namely, the current binding state. In other words, the external interface is separated and hidden from internal functioning. Of course, in a representation of an actual allosteric ligand detector, additional external and internal information is likely to be present.

Alternately, for input and output to a user, it may be advantageous to employ a simple, more intuitive interface representation that avoids explicit references to states and does not require the syntactic niceties of an actual programming language. In this case, the effective code becomes simply (for example) the following:

```
// ligand detector
distance := distance_1;
IF (ligand_present)
    THEN (distance := distance_2)
    ELSE (distance := distance_1);
```

The latter representation, referred to herein as an “IF-THEN-ELSE” representation, by directly expressing the biomachine purpose, is, perhaps, a more convenient and intuitive representation for a user to communicate with the present invention. The former representation and the equivalent state diagram, by representing actual transitions needed in a biomachine implementing the purpose, is, perhaps, more convenient for internal use by this invention.

FIG. 7B illustrates a further example of a state diagram that represents a transducer based on fluorescence resonance energy transfer (“FRET”) between a pair of fluorophores (which are chosen such that the emission spectrum of one fluorophore overlaps with the excitation spectrum of a second fluorophore). Briefly, FRET is a well known phenomenon in which a first fluorophore will, upon excitation, transfer the excitation energy to the second fluorophore (instead of emitting fluorescent photons with its first emission spectrum). The second fluorophore then, in turn, emits with its second emission spectrum. Because the excitation energy transfer is via a dipole-dipole interaction, which decreases in strength as the inverse sixth power of the separation of the two dipoles, efficient FRET will occur only if the first and second fluorophore are closely spaced (i.e., within a few tens of Angstroms of each other). Thus, a fluorophore pair interacting via FRET will emit photons, depending on the proximity of the pair, in either the first or the second spectrum (or both spectra, depending on the efficiency of the FRET coupling with the separation.).

Accordingly, from start state 705, the pair of fluorophores is moved apart either no more than distance A at state 706, or more than distance B at state 709. (For simplicity, two thresh old values of separation of the two fluorophores will be considered: distance A, below which there is efficient FRET coupling; and distance B, above which there is no FRET transfer.) In this exemplification distance A is sufficiently small such that FRET energy transfer occurs efficiently. Upon excitation of the first fluorophore to state 707, the second fluorophore of the pair emits with its emission spectrum at state 708. On the other hand, distance B is sufficiently large such that FRET transfer does not occur. Upon excitation of the first fluorophore to state 710, no energy is transferred to the second fluorophore, and the first fluorophore emits photons in its emission spectrum (different from that of the second fluorophore) at state 711.

State diagrams (as well as code-based) representations need not be unique. For example, FIG. 7B also illustrates, along with the prior state diagram, an alternative and disconnected state diagram for the FRET-based transducer. In this alternative, states 706 and 708, and 709 and 711, are indicated in heavy outline, and are related by reversible transitions (as indicated by the two dashed arrows), to represent a FRET transducer. The following simple “IF-THEN-ELSE” code is equivalent to this alternative state diagram:

```
// FRET-based transducer
IF (distance between fluorophores < A)
    THEN (emit fluorescence at λ_{E1});
IF (distance between fluorophores > B)
    THEN (emit fluorescence at λ_{E2});
```

Also, one of skill in the art will immediately understand how to further translate this FRET-based transducer class, which might be a subclass of the more generic fluorescence transducer class. The following FRET-based transducer class is an immediate such translation.

| // design class: FRET-based transducer | |
|---|---|
| public FRETBasedTransducer extends Transducer { | |
| distance | : distance between fluorophores in Å |
| A, B: | : constant FRET threshold distances in Å |
| λ_{E1}, λ_{E1}: | : constant emission wavelengths |

```
    public SetFluorphoreDistance (input_distance) {distance =
    input_distance}
    public StimulateEmission (λ) {
        IF (distance < A)
            THEN (emit fluorescence at λ = λ_{E1})
        IF (distance > B)
            THEN (emit fluorescence at λ = λ_{E2}) }
    }
```

Static-type parts, for a final example, have a particularly simple representation. A scaffolding part might have one state that does not respond to any stimuli. A functional part, which merely transforms input to output, might be represented by several, disconnected states, with one single state for each output value.

Conversion between state diagrams, object-oriented representations, and IF-THEN-ELSE-type representations (and other similar representations) may be performed by methods known in the arts of compiler design and code generation and analysis. From the vantage of these arts, the former representation, or a representation in a more formal and structured language, may be considered an “intermediate” code compilation of the latter representation (the intermediate code here having “states” instead of instruction addresses).

It will be apparent that these representations of biomachine purposes (along with other similar representation paradigms) make explicit the types of entities and their functional interactions specifying a design purpose, so that they are formally available for computer-implemented analysis with minimum syntactic ambiguity. In the prior examples, the interacting entities, including “specified ligand,” “specified response,” and so forth, along with their interactions, can readily be parsed from the representations. For example, interactions are immediately retrievable as links of a state diagram or the procedural flow of design code. For purposes of storage in a computer memory, this and other similar code may be represented by a table of the symbols used (e.g.: “specified ligand”, S₀, etc.) and three parameter pseudo-machine instructions. As depicted, it may be advantageous to include with a design purpose, a comment or other data structure indicating the generic biomachine type of the purpose.

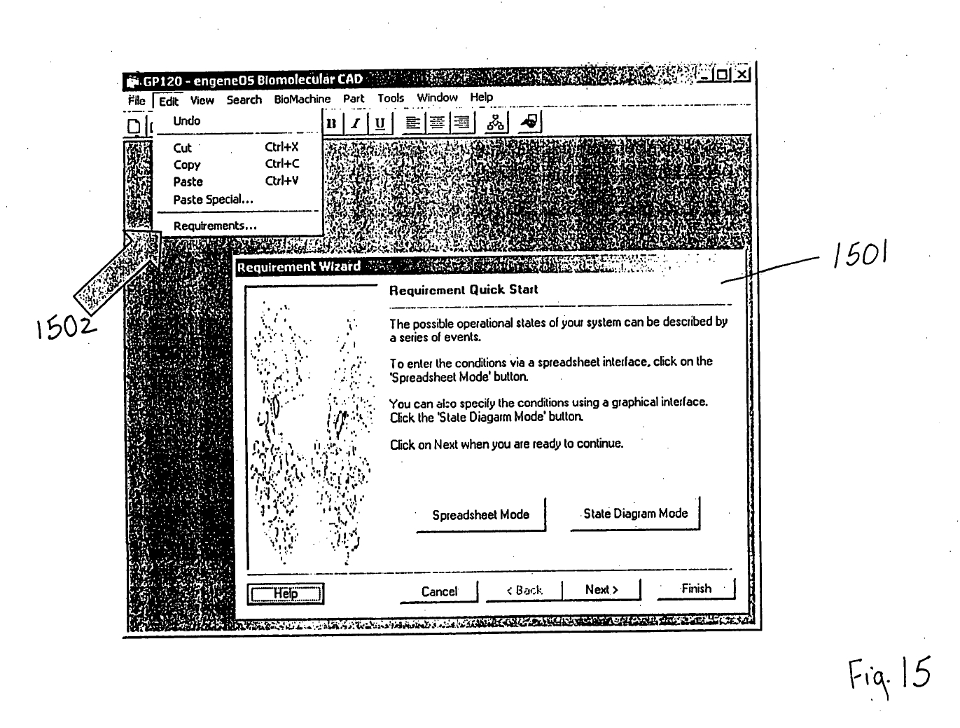

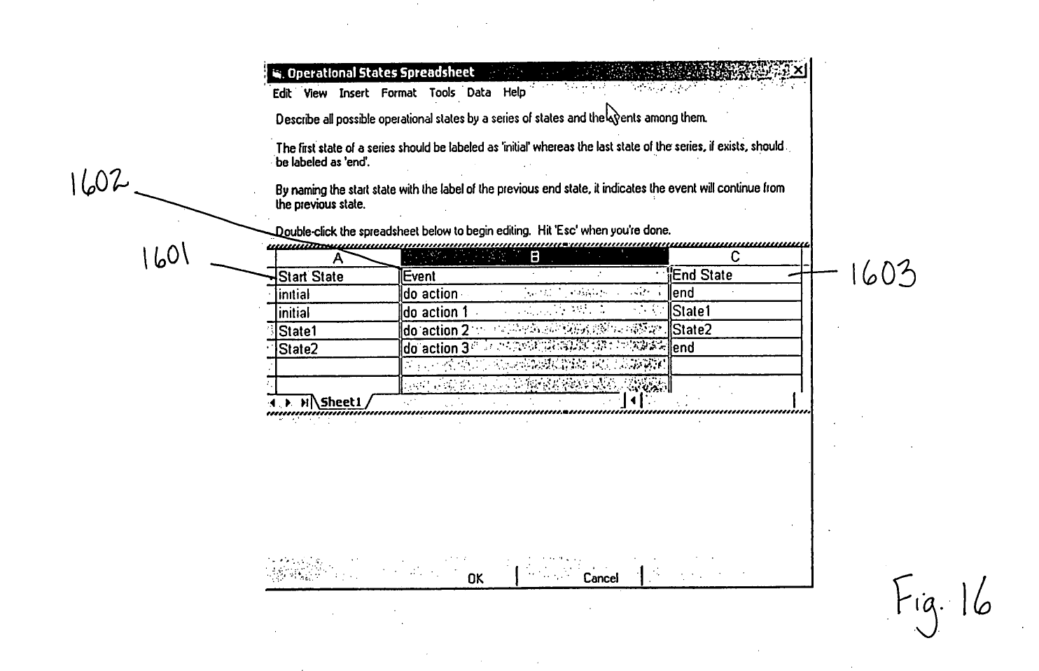

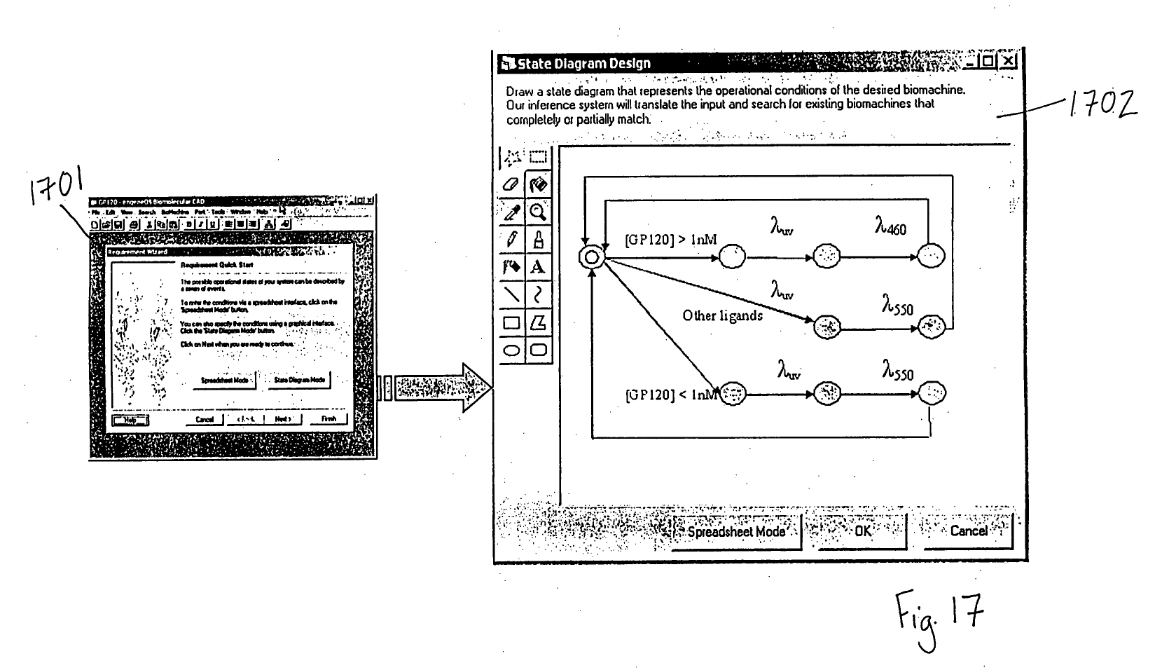

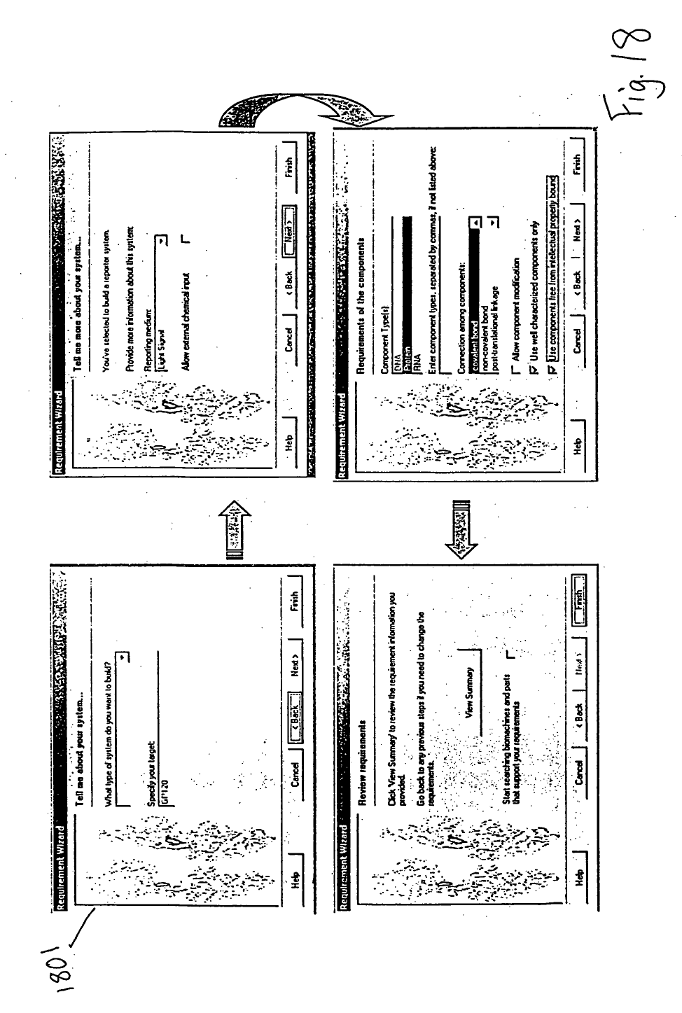

Limitations that may be found in the above examples are not to be taken as limitations of this invention. Biomachines include processes as well as apparatuses, and the representations described may be easily adapted to represent processes as well as of biomachine apparatuses. Also, the present invention may be used with other representations of design purposes, which, preferably, will be as complete and formally transparent as these exemplary representations. Additionally, purposes are not limited to the simple state diagram of FIG. 7A, in which each stimulus has a uniquely defined response. More complex purposes may specify responses to particular stimuli that depend on the stimulus context, in particular on sequences of prior stimuli. State diagrams of such purposes will have sequences of transitions between several states. For example, FIG. 7D illustrates a biomachine purpose according to which the response to incident radiation depends on prior exposure of the biomachine to ligands. As exemplified in FIG. 16, the user inputs the operational states of the biomachine using the “Operational States Spreadsheet”, entering the start state 1601, the event 1602, and the end state 1603. FIG. 17 exemplifies a GUI (which the user accesses through the “Requirement Wizard” 1701) for entering (drawing) the desired operational states of the proposed biomachine (as exemplified in FIG. 7D), to form the “State Diagram Design” 1702. As necessary, the system uses employs GUI windows to prompt the user for more information on the requirements of the biomachine (as exemplified in FIG. 18).Moreover, this invention is not limited to discrete states with binary transitions, such as occur when biomachine transitions are driven by large free energy differences (5 kT to 10 kT or greater, where k is Boltzman's constant). Biomachines may also include transitions with smaller (on the order of a kT to a few kTs, or less) free energy differences that result in graded or proportionate responses to stimuli. Such purposes may be represented by attaching percentages or probabilities (for example, functions of ligand concentrations) to the states in order to specify that a biomachine ensemble may be in a graded equilibrium between two or more states. They may also be represented by directly attaching the free energy associated with each transition in the state diagram.

Design Representations—Structure Information/Parts

In most cases, a design representation will also hold structure information describing a possible biomachine that can achieve the purpose also represented in the design. Structure information, according to this invention, includes part information, describing the one or more parts to be included in the biomachine, and configuration information, describing the arrangement and relation of parts to form the biomachine.

Part representations are more fully described subsequently; here they are more briefly illustrated in connection with structure information. Part representations describe either specific, actual entities (also referred to as “concrete” parts) or classes of similar parts, known as generic parts or as parts “class-es.” Specific parts may be directly derived or modified from, or constructed in analogy to, known biological entities, and include, for example: a specific monomeric protein, a specific multimeric enzyme, a specific oligonucleotide, a membrane delimited vesicle such as a liposome, and so forth. Specific parts are also not necessarily biologically derived, and may include, for example, small molecule fluorophores, metal nanoparticles, small organic molecules generally, scaffolding for a biomachine (such as a substrate prepared for attachment), incident radiation of a specific wavelength, and so forth. Most specific parts are identified by their particular physical and chemical components. One key component of a part representation is a representation of its behavior, or of its multiple behaviors, which make it useful for constructing biomachines in general, or at least useful for constructing a particular class of biomachines of interest in a particular implementation of the present invention. Parts are used in design because their behaviors are configured according to the configuration information to cooperate to achieve the design purposes. Behaviors include dynamic behaviors and static behaviors. Certain useful behaviors are dynamic and involve transitions (or changes) under the influence of external factors. For example, protein function may change or be reconstituted upon monomeric units binding into a multimeric complex; a precursor metabolite may be consumed in an enzymatic or other chemical process which yields a product metabolite; a DNA binding protein may enhance transcription in proportion to the concentration of a ligand; and so forth. Dynamic behaviors are preferably described using formalisms that are the same or similar to those used for describing the purposes of designs, because both may be described as transitions between states. Therefore, dynamic behaviors may be represented by state diagrams, IF-THEN-ELSE code, and other similarly capable paradigms.

Other useful behaviors may be static, i.e., not involving transitions or state changes. Scaffold parts, for example, may be of a type that provides controlled spatial relations between other parts attached to the scaffold. For example, a substrate surface for attachment of an ensemble of biomachines should be rigid, without significant random changes in the surface flatness at room temperature (such as a PDZ protein). However, a hinge scaffold should permit free bending in certain degrees of freedom, while preventing changes in other degrees of freedom (for example, lengthening). Constrained rigid behavior or unconstrained bending behavior is preferably represented simply by description of the behavior, such as “rigid surface,” or “hinge with two degrees of freedom,” and so forth (instead of by state diagrams with a single state, or a large number of only slightly different states).

Generic parts and classes of parts may now be simply described; they are parts having similar behavior in more or less detail. For a simple example, a more generic class may be all molecular-scale hinges; less generic classes may be all molecular-scale hinges having two-degrees of freedom or having only one degree of freedom; another less generic class may be all polypeptide hinges. Finally, a specific polypeptide hinge may be described by the formula:
(Gly₃-Ser)_{N} N=1, . . . , 10.
Here, as the value of N increases, motion of the hinge becomes less constrained. As a further example, a generic class of dynamic parts may be allosteric proteins. A less generic class may be allosteric proteins, where the allosteric effect is the spatial transformation of surface residues, or a class where the allosteric effect is alteration of enzyme function. A more specific class may be spatially-allosteric proteins, where at least some surface residues move by at least 5 nm upon ligand binding. A specific allosteric protein may be E. coli Maltose Binding Protein (MBP) (See, infra.).

Further information components of part representations are described in detail subsequently.

In addition to specific and generic parts of the nature described above, designs may also include previously-completed designs as components, or parts (herein, designs and parts are referred to collectively as “design items”). Preferably, designs used as parts have been verified by testing or simulation to achieve the stated purposes. Considered as parts, the “behaviors” of designs include at least their purposes. Design behaviors are not limited to purposes, because experiments with biomachines of particular designs may reveal additional functional capabilities, which may be included in the design representation as additional, perhaps unexpected or surprising, behaviors. Also, when used as a part, the fact that a biomachine is an intentionally-constructed entity with a particular internal structure is not relevant. What is principally important is only that a biomachine has behaviors that are useful in achieving the purpose of the new design. (See also, infra, the discussion of structure rules and protocols.) Accordingly, a biomachine may include one or more other biomachines as parts; the latter biomachines may further include additional biomachines as parts, and so forth; all without attention to the internal structure of the biomachines at any level.

Next, parts (including designs as parts) are configured according to configuration information also present in the design representation. This configuration information describes the functional relations of the parts, so that their behaviors cooperate to achieve the design purpose. Described subsequently are configuration rules (assembly rules) which determine if a design can be made, and, if so, how to make it (transition and manufacturing rules/protocols). Generally, according to configuration information, the behavior of certain parts (“downstream” parts) may be compatibly linked to the behaviors of other parts (“upstream” parts). For example, the downstream part may be from-time-to-time in two or more different states, each characterized by different values of a parameter to which the upstream parts are sensitive. Then, upon linking this parameter between downstream and the upstream parts, their behaviors are coupled into a combined behavior. Alternately, where the upstream part's behavior may be linked to parameter changes and not values, the downstream transition is linked to the upstream parts. Parameters of this sort are often physical, such as configuration change or binding of components.

For another example, a downstream part in a state, or as an effect of a state transition, may produce an output parameter, which, if transferred, will affect the behaviors of the upstream parts. Such output parameters are often chemical, such as an intermediate metabolite or a phosphorylation or de-phosphorylation of the upstream protein.

In one embodiment, configuration information may be represented in graphical form (or the equivalent), where nodes represent design items and links between nodes represent coupling of corresponding aspects of behavior between parts. FIG. 7C illustrates a particularly simple instance of configuration information. Here, the distance changes of a ligand detector according to FIG. 7A are linked to a FRET-based transducer according to FIG. 7B so that ligand binding may influence fluorescence. Therefore, a biomachine design using parts illustrated in FIGS. 7A-B, configured according to FIG. 7C, forms a fluorescent ligand detector (FIG. 7D). As described later, for this design to actually function, additional requirements (in addition to configuration) may need to be satisfied. For examples at least the distance changes of the detector must be sufficient to affect the FRET interaction.

Configuration information may be similarly represented in the object-oriented design code representation of parts. Here, an object representing a configured design may be derived from objects of the parts classes by composition of methods. For example, the following is a portion of a FRETBasedLigandDetector class configured from LigandDectector and FRETBasedTransducer classes.

```
// design class: FRET-based ligand detector (using multiple inheritance)
public FRETBasedLigandDetector extends LigandDectector,
FRETBasedTransducer
{...
    public DetectLigand (ligand_present, λ) {
        SetLigandPresentOrAbsent (ligand_present)
        SetFluorophoreDistance (CheckDistance (current_distance))
        Stimulate Emission (λ) }
... }
```

Configuration information is limited in these simple examples. A single downstream part may be linked to several upstream parts; several downstream parts may be linked to a single upstream part; different aspects (transitions, states, parameters, outputs, or so forth) of a downstream part may be linked to the corresponding aspects of one or more upstream parts; and so forth.

Finally, the design represented by the configuration information may require additional parts (of the nature of a framework, or scaffold) for performing the linking. To link parameters, linker moieties or conjugation chemistries may be needed to join actual parts. To transfer intermediate metabolites, parts may need to be held in proximity (for diffusion), or conduits or transporters provided. Also, the configured parts may need one or more environments for proper functioning. Additional “background” parts may be needed to establish and maintain the required environments.

Further Aspects of Design Representations

In addition to purpose, parts, and configuration, design representations may include a wide variety of additional information. (Unless otherwise noted, most of this additional information applies also to part representations.) Some types of additional information have already been mentioned. In most embodiments, designs will also include configuration rules relating to actually constructing a biomachine according to the design. Designs also usually include behaviors. Each verified design behaves at least according to its purpose, and may behave in other manners that are also potentially useful. Such additional behaviors are represented as described above in designs.

Designs are also usually mutually linked. One set of links forms a generic-specific hierarchy, also known as an “isa” (or subset-of) hierarchy. Designs at similar levels of specificity may also be linked together, with transition rules indicating how to transfer among the specific designs.

Designs may also include references to external biotechnology databases, such as sequence databases, structure databases, taxonomy databases, pathway databases, publication databases, and so forth. These preferably link background information, all information needed for design having been placed in the databases of the systems of this invention.

Designs may also include extracts of the manufacturing rules and protocols for quick reference. These extracts may include the presence or absence of vendors, estimated manufacturing cost, estimated turn around time for synthesis or construction, presence of steps requiring special care. Also of importance may be intellectual property information, such as coverage by patents, presence of confidential information in the design, licensing terms and conditions, and so forth.

Input—Biomachine Model/Specification

In one important use scenario, the methods and systems of the present invention are used to design a biomachine from a design request (also called a biomachine design “model”). A model may be as simple as “It is a protein sensor,” which can be satisfied by a very large number of possible biomachines. Usually, a model contains more detail, as much about the desired design as known. For example, “It is a sensor for gp120 (an envelope protein of the Human Immunodeficiency Virus 1), producing a fluorescent output signal, and constructed as a fusion protein not requiring post-translational modification.“

The model may be input by a user in any number of formats. In one format, the model is a logical model (or a logical hypothesis) of the desired biomolecular device, and is input as a set of declarative and/or conditional statements that define the use conditions and requirements of the desired biomolecular device (an “IF-THEN-ELSE” style language). Alternatively, a model state diagram may be sketched in UML format with standard symbols with the aid of a graphical UML editor. Optionally, the system may include language recognition modules to accept free text input, perhaps with a controlled vocabulary and simplified grammar. All input methods may be aided by a graphical interface that presents the user with lists of design options of the appropriate generality.

Once provided and input to the system, the model can be represented internally in a number of fashions known in the arts of computer science and artificial intelligence. For concreteness of the subsequent description only (and without intended limitation), it is convenient to translate the design model as a partially complete design representation, referred to herein as a “design schema,” which is a query to the design methods. Design schema may relate to apparatuses as well as processes. For example, certain information types may be completely specified, so that any resulting design must have matching information of that type. Other information types may be marked (as an optional default) as “do not care,” meaning that a resulting design may have any values for such information types. Also information types may be partially specified: parts are to be of certain generic classes; manufacturing costs are to be less than a certain amount; and so forth.

Stated differently, a design schema may be considered as a design with certain fully specified information types, but with the remaining types of design information simply replaced by variables. For partially specified types of information, corresponding variable values have constrained values, and for “do not care” types of information, the corresponding variables are entirely free. The methods of this invention then instantiate (or fill in value for) the variables in a manner guided by the system design knowledge. In most cases, many possible specific designs will satisfy a model.

Several limiting cases of models and design schema are now described. If the model and design schema specify nothing, the methods will essentially allow a user to review the entire design knowledge in the system. If only a generic class of parts is specified, perhaps with constraints such as cost, the methods will search for all parts of that class meeting the optional constraint whatever design they might be suitable for. If a complete and known design is input, except for manufacturing protocols and rules, for example, the methods will retrieve all manufacturing protocols for that biomachine known to the system (of which there is at least one). Accordingly, the present invention encompasses not only design as usually understood, but also cases where design knowledge is searched along particular dimensions or for limited types of information.

Further, a design schema that specifies only a generic class of designs along with generic classes of parts and configuration information may be considered a design “case.” Especially when this invention's methods return known and verified designs instantiating such a design schema, or case, the design case can be entered into the design knowledge to represent that the design returned is an instance of the design case.

Output—Biomachine Design

Briefly, the methods and systems of the present invention input a model and convert it to a design schema, a partially-specified design with variables standing for the unspecified portions. The variables are instantiated in view of the system's design knowledge, and one or more designs are output with more complete representations than the input model. The degree of completeness is preferably under user control, so that the output may range from partially to entirely completed designs.

While instantiating the variables, or evaluating the design schema, the methods select increasingly specific designs and parts, typically more than one of each. Thus, the design process may be viewed as sequentially “filling in” the design schema, creating a plurality of more complete designs that meet the input query. In some cases, the number of alternatives may become too large for the problem at hand, and the methods will interact with the user in order to return better focused and more relevant designs.

Accordingly, exemplary design problems solved by the methods of this invention include the following. Given a known biomachine: a query may seek a better or a more appropriate part; or a better structure, configuration, or arrangement of the parts; or a new purpose for the biomachine or for closely related biomachines; or new manufacturing or linking protocols; and so forth. The present invention is structured to respond flexibly to many different types of user queries (input design models).

5.1.2 Design Knowledge—Domain Models

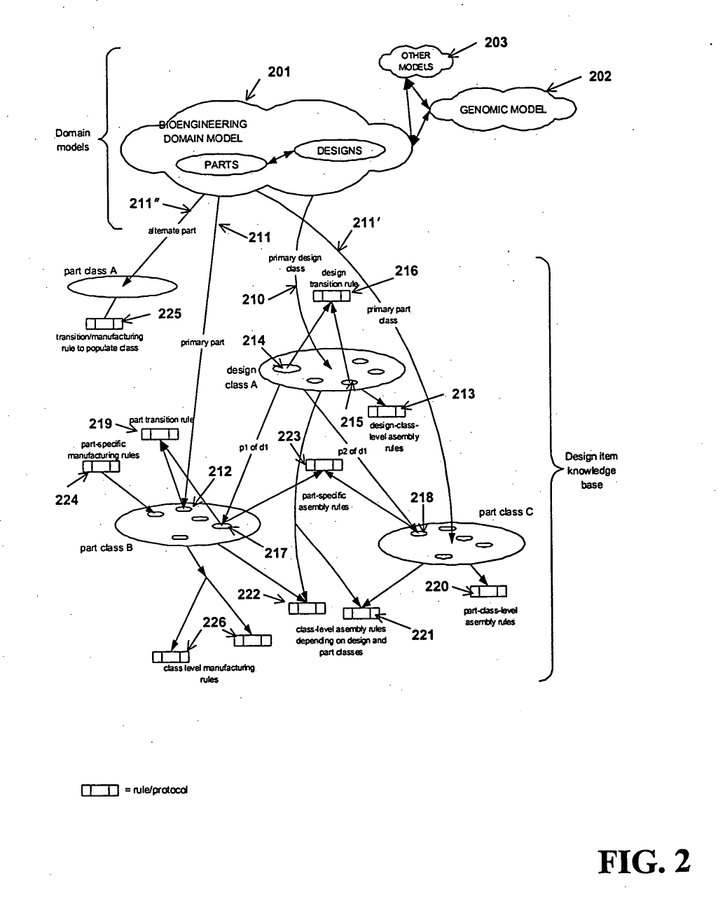

Using the design representations and schema described above as input, the methods of this invention return more complete designs by applying inference procedures to available design knowledge. Generally, design knowledge (also referred to as the design knowledge-base) includes two principal divisions, the first being domain models, described in this subsection, and the second being design item knowledge-bases, described in the subsequent subsection. FIG. 2 generally exemplifies design knowledge according to this invention and its principal divisions.

Domain models (also known as “ontologies”) used in an embodiment of this invention describe the structure and interrelationships of the knowledge from which biomachine designs are formed, specifically, for example, the terms or words (such as “fluorophore”), the concepts (such as “allosteric protein” or “ligand sensor”), and the objects (such as “parts,” “designs,” or “configuration rules”) used to describe and design biomachines. On the other hand, the design item knowledge-bases contain the actual knowledge, the parts, the designs, and the configuration rules, that make up biomachine designs. These two divisions of design knowledge are linked so that the domain modes provide semantic structures for design item knowledge-bases.

In certain embodiments of the invention, it is preferable for the design methods to be partitioned into separate areas of expertise, for example, into biosensor design, or into biomotor design, and so forth. Then the design knowledge, both the domain model and the design item knowledge-base, may be similarly partitioned and focused so that the design knowledge need not span all possible biomachine designs at once. In these embodiments, the methods of the invention appear as several design assistants having separate and limited expertise.

Examples of ontologies include the following references: Baker et al., 1998, TAMBIS: Transparent Access to Multiple Bioinformatics Information Sources. An Overview, Proc. of the Sixth Intl Conf on Intelligent Systems for Molecular Biology, Montreal, 1998 (which is a system for transparent access for disparate biological databases incorporating a biological concept model or ontology); Baker et al., 1999, Bioinformatics 15:510 (same description as previous reference); Gene Ontology Consortium, Nature Genet. 25:25 (which is a dynamic controlled vocabulary that can be applied to all eukaryotes, even as knowledge of gene and protein roles in cells is accumulating and changing); National Institutes of Health, Unified Medical Language System Project, National Library of Medicine, Bethesda, Md. (http://www.nlm.nih.gov/research/umls/) (meta-thesaurus, lexicon, and semantic network for medical and biological discourse and natural language processing); Noy et al., 2001, Ontology Development 101, Report SMI-2001-880, Stanford Medical Informatics, Stanford University School of Medicine (development of ontologies in Protege); University of Tokyo, Takagi laboratory, Human Genome Center, http://ontology.ims.utokyo.ac.jp/OntologyCommittee/Collection.html (which is an exemplary list of ontologies in biology).

Domain Models

The domain models used in embodiments of the invention, which establish semantic structures for the design items, preferably cover both bioengineering knowledge along with several additional and related areas of knowledge. Preferred additional domain models cover broadly domains in the biological sciences (such as genomics, enzymes and metabolic pathways, cell structure function and control), relevant portions of domains in associated sciences (such as chemistry and physics), and also domains of general engineering knowledge. The latter domain preferably models temporal and spatial knowledge, interactions between components, causation, and so forth. The additional domain models may be adapted from existing ontologies. Here the focus is the bioengineering domain model.

FIG. 2 illustrates design knowledge generally, and its two principal components, the domain models and the design item knowledge-base. The domain models include bioengineering domain model 201 (also referred to as the bioengineering ontology or “bio-ontology”), along with domain models 202 relating to other biological sciences and additional domain models 203 relating to associated sciences and engineering. These models are illustrated as network clouds in FIG. 2 to highlight that they are actually a network of relations among numerous terms and concepts (without any implication intended that these domain models are fuzzy or inexact). The bioengineering domain model provides semantic structure relating individual parts, parts classes, individual designs, design classes, as well as other design item data to the domain concepts. FIG. 2 illustrates this structuring by links between the two components of the database.

The additional domain models have accessory roles, principally to describe and structure terms and concepts appearing in the bioengineering model but related to other arts and sciences. Therefore, they are illustrated as linked to the bioengineering model, but with few if any links directly between these additional models and the design item knowledge-bases. These additional ontologies may also facilitate access to heterogeneous external databases by providing translations of terms and concepts used in external databases to corresponding terms and concepts used in the design knowledge directly available to systems of the present invention. Useful external databases may include well known databases of genomic, structural, taxonomic, enzymatic, and other information.

Next, preferred implementations of the bio-ontology are described with reference, first, to their use in the design methods and, second, with reference to their internal structure. Generally, design problems, specified externally as models to be designed, are specified internally as design schema with partial information to be completed or absent information to be provided. Missing information may be represented as variables to be later instantiated. In most cases, the nature of the incomplete or missing information in design schemas is insufficiently precise or bounded to permit direct and productive retrieval of design items from the knowledge-base. Without precision or specific bounds, a query of the knowledge base is likely to return too many design items, or items that are inappropriate in one way or another for the intent of the schema, and so forth. Here, the bio-ontology may be advantageously employed to translate incomplete or missing information in the schema into one or more related classifications or concepts that are sufficiently specific and precise to function as useful design item queries. Stated differently, the bio-ontology may be said to expand the available information in the design schema into more specific concepts or classifications and associated candidate design items. This use of the bio-ontology is referred to herein as “descending” from the more general to the more specific.

On the other hand, where partial or missing information to be instantiated is already precisely limited or bounded in the design schema, the design methods may be able to use this partial information to directly formulate a query and retrieve immediately candidate design items (parts, designs, configuration rules, or other data elements) from the design item knowledge-base. For example, if a design schema is well specified, except that an appropriate allosteric protein is requested, the design methods may be able to retrieve candidates directly. Although not required in this case, the bio-ontology may nevertheless advantageously serve to generalize the design, and thereby suggest design possibilities not previously considered. In this case, the bio-ontology is accessed with the specific information to find related but more general concepts or classifications, which then lead to new more specific concepts that may be considered siblings or cousins of the initial information. This use is referred to herein as “ascending” (or “ascending, then descending”) the bio-ontology from more specific to more general.

Ascending the bio-ontology may be useful when a user wishing to design motility into a biomachine is accustomed to using a myosin-based motor or an F1-ATPase-based motor, and specifies these types of parts in the new design. But, if the design methods may ascend the bio-ontology from the examples of motors to a functional motility requirement (Le., move an object by a small increment), a new alternative such as an RNA polymerase may be suggested. This suggestion can be reached by ascending from the specific myosin or F1-ATPase motors to a “motor” concept and then to a movement transducer concept, and then descending to RNA polymerase as an instance of a movement transducer.

Therefore, according to the present invention, the bio-ontology groups one or more specific concepts or classifications “under” a single more general concept, so that generalization and specialization may both be accomplished. At least bio-ontologies useful in this invention provide for generalization and specialization along a genus-species dimension in the composition or substance design items. This relationship is also known in the art as an “is_a” (also “isa”) hierarchy, or a “can_be” hierarchy, or a “subset_of” hierarchy. For example, an RNA polymerase “isa” enzyme, which “isa” protein, which “isa” material.

Preferably, the bio-ontologies provide for generalization and specialization along multiple other dimensions (also referred to as “hierarchies” or “segments”), several of which are now described. Any particular embodiment of the present invention may include a bio-ontology with any combination of, or all of, these hierarchies, or also additional hierarchies that may have importance for particular biomachine designs. These multiple dimensions may be represented in single data structure (e.g., a tree, a directed graph, and so forth). Alternatively, the multiple dimensions may be represented in multiple separate data structures, which may be more or less extensively interconnected. The choice is advantageously made according to implementation convenience and performance advantages.

In preferred embodiments, the bio-ontology includes a segment (or hierarchy) with terms, labels, identifiers, and so forth (collectively, identifiers), which are used to identify biomachines, parts, and configuration rules, and which are arranged in hierarchies according to conceptual relatedness including generality and specificity. These identifiers may be used to describe biomachine purposes, behaviors, configurations, and so forth; part behaviors, configurations compositions, sources, and so forth; configuration rule classes, input, outputs, and so forth; and other characteristics and properties of biomachines and design items. Term and identifier bio-ontology segments may be used to translate and expand words and terms used in a design schema into standard internal designations that unambiguously refer to appropriate entities in the design item knowledge-base.

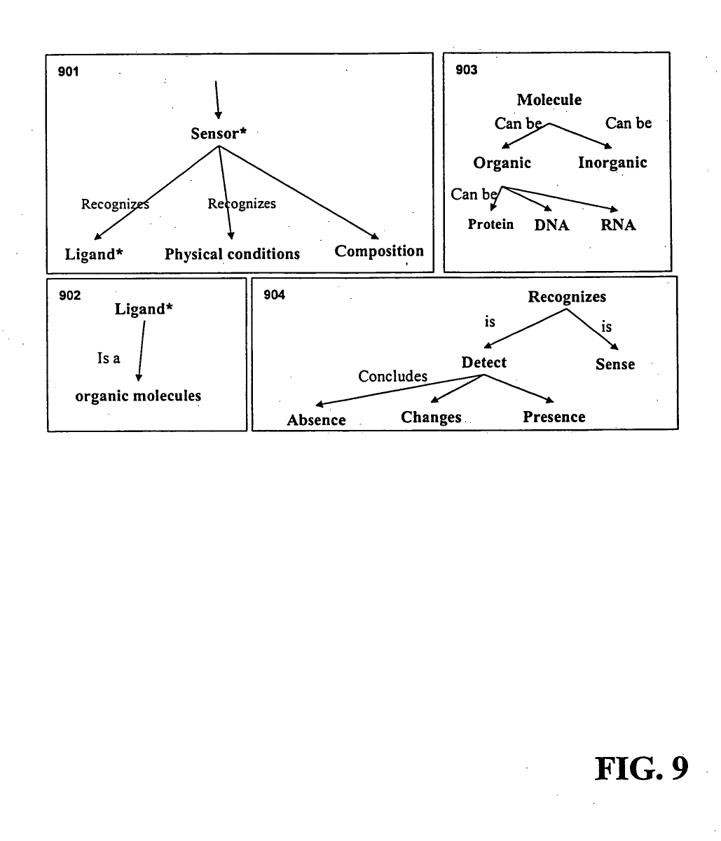

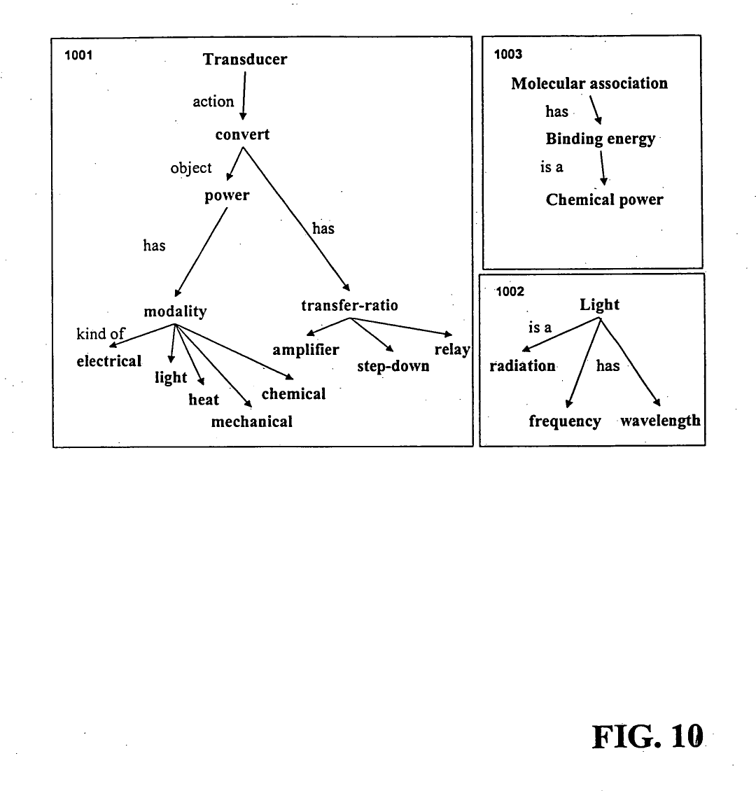

For example, ontology segments 903 and 904 in FIG. 9 provide exemplary references for “molecule,” “recognizes,” and certain dependent terms and identifiers. Thereby, use of these terms in design schema (or in other data structures) ultimately designates design items related to entities, which are proteins, DNA, RNA, inorganic molecules, or design items related to absence, change, presence, and sense actions. Segment 902 indicates that any organic molecule may be considered a “ligand.” Similarly, segment 1002 in FIG. 10 illustrates examples of bio-ontology portions allowing unambiguous reference to design items generally related to “light” because they are specifically concerned with radiation, frequency, or wavelength. Segment. 1003 indicates that use of “molecular association” may lead ultimately to design items involving chemical power.

Additionally, in preferred embodiments, the bio-ontology also has conceptual segments for parts and designs, for example, as illustrated in FIG. 2. Ontologically, parts have functional behaviors that are not further decomposable, whereas designs are decomposable, having been configured from component parts and designs (in some cases from a single part or design). Therefore, parts and designs are typically extensively interrelated along “configured-from” and “configured-in” dimensions, because designs may be linked to the parts from which they are configured, and parts may be linked to the designs in which they are employed. However, whether a design item is considered as a part or as a design may vary from one implementation to another of the present invention. Research advances may make visible the internal functioning of a part so that it may be considered as a design configured from components; or in one application of the present invention, it may be convenient to consider as parts certain design items that are considered as design in another application.

Further, the part and design segments may be interrelated by a shared (or partially shared) logical and functional hierarchy that relates concepts and objects having or utilizing more-or-less similar purposes, behaviors, principles of operation, and so forth. These hierarchies advantageously classify logical and functional aspects of bioengineering knowledge (optionally designated with terms and identifiers) into sub-concepts and sub-classifications (similarly designated with terms), and then map the concepts and classifications onto design items classe and finally onto the design items to which they apply. To the extent that the bioengineering behaviors reference physical, and general engineering concepts, structures in the additional ontologies may provide further refinement of concepts and classifications. Using both the logical/functional hierarchy with the part/design interrelationships, the inference engine may find all designs having a specified function for its purpose (at some level of generality), or all parts behaving according to that function, or all parts included in designs having the function, or all designs requiring parts with that function, and so forth.

For example, sub-segment 1001 in FIG. 10 illustrates an exemplary logical hierarchy that classifies transducers primarily according to their quality and intensity of transduction. Specifically, to find “transducers” that “convert” “power” of a “chemical” modality” With a certain “step-down” “transfer-ratio,” an inference engine may look for design items referred to by both branches of the illustrated sub-segment. The design items retrieved by this search may be parts, such as a chemiluminescent part that converts chemical power into light in a unitary fashion, or they may be designs, such as a fluorescent design that uses an intermediate binding protein to couple chemical output to an environmental change around a fluorescent moiety.

More specifically, the parts segment advantageously includes separate sub-segments directed to concepts and objects for sensors, transducers, biomaterials and catalysts. These sub-segments are classified both by the above logical and physical hierarchy, as well as by a subset or inclusion hierarchy, according to which parts are structured into classes of sets of increasing generality. Practically, parts (and design items generally) may be linked to the most specific bioengineering concepts that best answer the question “what is the usefulness of the item?” Sensor parts may be sub-segments according to the following exemplary questions:
1. Does the item recognize (by chemically binding, by being modified by, or by otherwise interacting with) a specific biomolecule?
2. Does the item exhibit a structural, energetic or chemical change with the recognition event?
   Specific concepts may then be linked to more generic class concepts. New concepts and segments and new generic classes may be added if existing concepts prove insufficiently comprehensive. It is likely that a design item may be reachable along more than one hierarchy, or belong to more than one sub-segment of items.

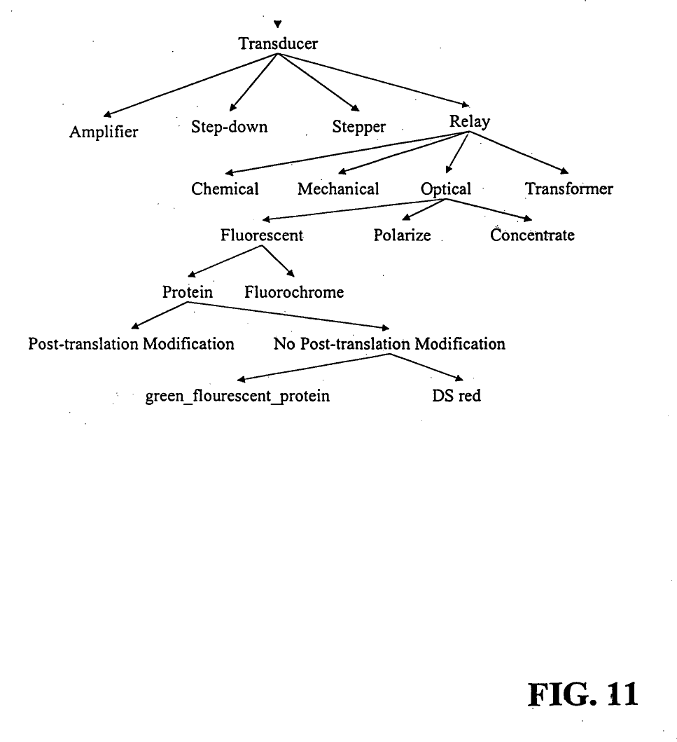

For example, the sub-segment in FIG. 11 illustrates an exemplary hierarchy that classifies transducers primarily according to the specificity of their behavioral or functional characteristics: whether or not a transducer is of a relay type, or a stepper type, and so forth, and whether a relay-type transducer produces outputs of a chemical, mechanical, or optical, or some other nature, and so forth. Again the retrieved design items may be either parts or designs. The more specific of the classifications is preferably linked to individual design items in the design item knowledge-base, and the less specific classifications may be linked to classes of design items.

Further parts (or design, or common) sub-segments in a preferred embodiment may include: an environmental conditions sub-segment, under which parts of biomachines function; a performance descriptions sub-segment; a configuration rules sub-segment; a part attributes sub-segment; and a material relatedness sub-segment, under which, for example, genomic homologies, protein homologies, and so forth, are organized.

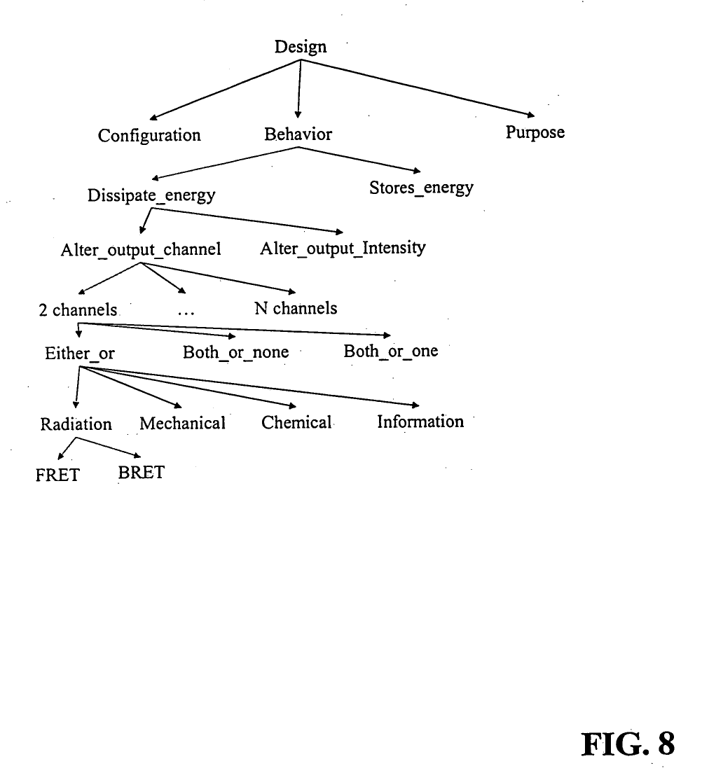

In current versions, the design bio-ontology segment preferably includes sub-segments directed to design purposes, behaviors, and configurations. Again, there advantageously may be several hierarchies in the design segment. One hierarchy, possibly shared with the part segment, logically and functionally relates design concepts and design objects having or utilizing more-or-less similar purposes, behaviors, engineering principles of operation, and so forth. Another hierarchy may relate more generic parent designs to their more specific child designs. FIG. 8 illustrates an exemplary portion of a design bio-ontology segment that includes the principal sub-segments of purpose, behavior, and configuration sub-segments along with further details of the behavior sub-segment. The body of behavioral sub-segment details is classified primarily according to principles or operation; the leaves reflect, namely, radiation (FRET, BRET), mechanical, chemical, information, and particular parts classes, and may have direct links to the design item knowledge-base. The FRET and BRET nodes may represent part sub-classes of the more generic radiation part class.

A specific biomachine design machine or theoretical design might be found through one or more of these subclasses. For example, the input to output ratio is captured in the “Behavior” branch of the “Design” ontology. The “Behavior” branch organizes the biomolecular machines or designs by their responses to their environment, which includes input of substrate or other signals. Other design sub-classification might be added at a later time as needed to facilitate the accurate matching of designs to the product specification.

Other major bio-ontology segments may include manufacturing knowledge, including cost, with further segments added as needed for particular applications.

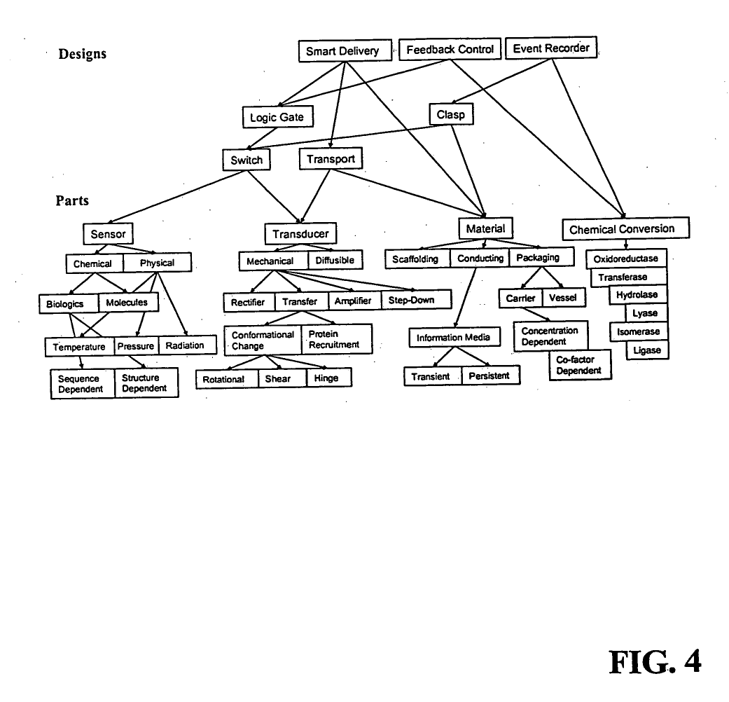

FIG. 4 illustrates exemplary portions of the relationship of the design and parts segments in an embodiment of the present invention. The illustrated portions of the segments are those concerned with the hierarchial classification of generic design classes and designs into their component parts classes and individual parts. Additional relationships between these segments arise from the shared (or partially shared) logical and functional hierarchy (not illustrated) relating design and parts concepts and objects having or utilizing more-or-less similar purposes, behaviors, principles of operation, and so forth. From FIG. 4, it can be seen how design and parts classes are classified into a hierarchy from the more generic to the less generic. It can also be seen how generic and specific design classes are configured from generic and specific parts classes. For example, a “smart delivery” biomachine class is described by a transport biomachine class, and a material parts class classifying the material being delivered. Further, a transport biomachine is configured from a transducer and a scaffolding material for the transducer. The transducer may be a protein, which transfers by means of a mechanical conformation change, or a rotational, shear, or hinge type. Following further specific bio-ontology links (not illustrated), it can be appreciated how concrete examples of “smart delivery” biomachines derived from actin and myosin or from microtubules and kinesin (or dinesin) may be retrieved from the design item knowledge-base.

Bio-Ontology Implementation

The bio-ontologies, and the bioengineering domain model generally, may thus be considered a collection of concepts and objects (part, designs, configuration rules, and the like) of various degrees of generality or specificity. The concepts and objects are preferably considered as multiply linked or interrelated by, for example, functional, structural, and specificity hierarchies (or bio-ontology sub-segments).

For use by the computer-implemented methods of this invention, the domain model is stored in a computer-readable memory of adequate capacity. In certain embodiments, it may be stored as, for example, a semantic network, or a frame-based inference network, or the equivalent. See, e.g., Giarratano et al., 1998, Expert Systems Principles and Programming, PWS Publishing Co., Boston, Mass. (describing the BCAD frame-based inference system). As such a network, the nodes containing attribute information would be related by links labeled by the relationships represented, and therefore would be a graph of general structure. Attributes may be inherited along some or all of the relationships. In special cases, the graph of nodes and relationships may be limited to a directed acyclic graph or even a tree. Other representations known in the art of artificial intelligence programming may also be used, such as production rules or logic sets.

However, since the purpose of the domain model is to assist users, and the method is to find appropriate classes of parts and designs (and individual parts and designs) from which to derive the solution to a new design problem, other representations of the domain model adequate to this purpose may be used. One representation that focuses on user assistance may include dictionaries, or thesauruses, or the like that a user may access as needed to efficiently search the design item knowledge-base. Thus, where a user has a cleat understanding of what is needed, perhaps from similar design experience, the search may be commenced with detailed terms and conditions without access to the domain model. On the other hand, where a user needs design assistance for a design problem (or wishes to seek solutions not yet considered), the search would access dictionaries, in order to more narrowly focus on specific meanings of the terms defining the problem, and thesauruses, in order to broaden a search to include related meanings.

A semantic-network or frame-based representation may be generally related to a dictionary/thesaurus representation. Dictionary entries for a term may include the attributes of a node (concept or object), and may list nodes related according to the formal bio-ontology hierarchies principally in a parent-child manner. Thesaurus entries, which may be part of the dictionary entries, may list nodes related as “synonyms” (or “antonyms”), permitting easy access to sibling and cousin relationships.

In summary, the information in domain models and the component bio-ontologies may be represented in a more regular format more suitable for computer-based implementation of part and design retrieval. The information may also be represented in a more user-accessible format for more-or-less manual browsing and retrieval from the design item knowledge-base. In whatever representation, it serves to organize the great complexity of biologically derived parts and designs.

Finally, this invention also encompasses domain models, as described, and concretely represented as products recorded on computer-readable media or made available by means of network interconnections.

5.1.3. Design Knowledge-Base

Design knowledge (principally parts, designs, and configuration rules) is collectively contained in the design knowledge-base (equivalently the design item knowledge-base). Because design knowledge in bioengineering using parts and designs derived from the biological sciences has highly unique aspects, the structure and contents of this knowledge-base are important to the end-to-end functioning of the present invention.

Reasons for this uniqueness include, inter alia, lack of predictability, immense complexity of parts and designs, and natural “purpose.” Concerning the first reason, the lack of general predictability of structure-function relationships for biological components and systems is well known. In the physical and related sciences, knowledge is generally represented by unifying mathematically-expressed theories, and, through this unifying, numerically precise knowledge is reflected in the associated design arts by unifying and numerically precise structure-function models. For example, considerable portions of electronic design may be performed with laws derived from Maxwell's four equations along with lumped-parameter part models.

In the biological sciences, on the other hand, knowledge is expressed in more qualitative forms, often based on taxonomies derived from evolutionary considerations. Precise prediction of protein function and structure from primary sequence is not possible, depending as it does on residue configuration, often to sub-nm or sub-Angstrom precision. Similarly intractable is prediction of cellular responses from genomic sequence. Currently, approximate suggestions are possible from considerations of taxonomy and homology.

Further, the biological world has immense diversity. Immense numbers of organisms and components and parts of organisms abound and are ready for adaptation and exploitation in biomachine designs. Additionally, an ever increasing number of synthetic products (from transgenics to fluorophores) are becoming commercially available.

Finally, complicating use and exploitation of the natural components available is their lack of clear “purpose.” Natural components were not “designed” for a known intended purpose and with known side-effects or alternative behaviors. Instead, the natural function of each component must be carefully, often laboriously, determined. Even once determined, a component may have other important behaviors in other environments, or adverse behaviors in its natural environment, that are not at all apparent from its natural function.

Because of this uniqueness, and to exploit its possibilities, the present invention generally associates design knowledge in the form of purposes, behaviors, rules and limitations for use, rules for integration into biomachine designs, and the like, with individual parts and part classes (collectively, configuration rules). Configuration rules may also be associated with designs and design classes when they are used as parts. However, this invention associates design knowledge in a manner so that advances in biological knowledge and theory may be accommodated. Where general rules are discovered, they may be associated with general classes to which they apply, and inherited (perhaps supplemented) for specific members of the class. Further, the rules may be structured and classified as part of the domain model (bio-ontology configuration rule segment).

Relevant design knowledge is derived from numerous sources and related to applications intended for a particular embodiment of the present invention. For example, protein design information includes the following references: Baker et al., 2001, Science 294:93 (protein structure prediction based on >50% (30-50%, <30%) sequence identity with known structures lead to about 1 Å RMS errors (1.5 Å, rapidly increasing RMS errors, respectively; de novo methods in which short segments sample configurations of that segment in known structures); Blau et al., 1999, Proc. Natl. Acad. Sci. USA 96:797 (tetracycline controllable transcriptional regulators delivered to eukaryotic cells by by retroviral vectors); Dahiyat et al., 1996, Protein Sci. 5:895 (correct secondary structure and overall tertiary structure have been attained based on physical properties of sequences such as hydrophobic/hydrophilic patterns; described as an inverse folding method that seeks amino acids to populate a known backbone); Dahiyat et al., 2001, International publication no. WO 01/59066 (computational methods to prescreen large combinatorial libraries to find smaller libraries suitable for in vitro screening); Dietmann et al., 2001, Nature Structural Biology 8:953 (method for determination of protein homology based on evolutionary principles)

Configuration Rules—Content and Relationships

The content of configuration rules, their storage in the design knowledge-base, and their relationships to design items, and classes of design items, are now described. Preferably, configuration rules include the separate types of rules known as assembly rules, transition rules, and manufacturing rules/protocols. Briefly, assembly rules associated with a selected part (or a part class) specify the conditions, limitations, or restrictions that must be met when this selected part (or parts in this class) is configured into a design. When a particular selected part is considered for configuration into a proposed biomachine design, its associated assembly rules may be applied to the proposed design, especially to the other parts with which the selected part is to exchange interactions, to determine if the selected part will “fit.” For example, assembly rules for a specific allosteric protein may specify certain amino acid residues that must be preserved, e.g., in order that ligand specificity is not altered, or may specify steric constraints that any conjugated or fused moieties must meet to preserve the allosteric response. Assembly rules also exist for designs when used as parts.

Transition rules and protocols specify whether, and how, parts in a parts class may be transformed into other target parts in that class (or how to transform entire parts classes that are related by being in turn subsets of a more generic parts class). For example, a proposed design may require a target part not yet in the design item knowledge-base, although similar parts in the same parts class are known. In this case, transition rules associated with the parts class or with similar parts in the class may be applied to the target part to specify whether the target part may be constructed from, or in analogy to, known parts. Transition rules also exist for similar designs in a class.

Finally, manufacturing rules, also associated with parts and parts classes as well as, importantly, with design and design classes, specify how to synthesize, make, or construct this part or design. For parts directly derived from natural, biological components, the natural (or corresponding commercial) source may be specified; for modified or constructed products, these rules would include protocols for modification and construction. For designs, protocols would specify how to carry out synthetic or other processes to put the component parts together according to the configuration information. This making maybe either in the laboratory or for commerce. In preferred embodiments, manufacturing protocols are at least in part derived from the compendiums of laboratory procedures available in the various field of biology.

FIG. 2, the general structure of which has already been described above, illustrates also exemplary details of configuration rules and their relation to design items in the design knowledge-base that might be germane to a particular stage in solving a design problem or query. As illustrated, the design query (or model) has been resolved to a level of specificity by means of the domain model, such that the design bio-ontology sub-segment links 210 to design class A, which contains candidate specific designs for this problem (typically additional candidate designs or design classes also result from query resolution). The parts sub-segment indicates candidate parts for these candidate designs, namely, candidate specific part 212 in parts class B by link 211, candidate parts class C by link 211′, and candidate parts class A by link 211″ which is an alternate to candidate parts class C (again, typically a design query may lead to additional candidate parts and parts classes). In this figure, design item classes are designated by larger ovals. Specific design items are designated by smaller ovals within the class ovals.

Next, the candidate designs in design class A are tested according to class-level assembly rule 213 for their fit with the design query. Rule 213 is indicated as being sufficiently general to apply to all designs in class A, and as not requiring further design item inputs (such as proposed candidate parts), but as possibly requiring inputs from the design query. Design specific assembly rules may also be present, although not illustrated. FIG. 2 supposes that specific designs 214 and 215 have survived the test of rule 213, and further indicates that they are closely similar, but inter-convertible by transition rule 216 specific to these two designs.

Considering now design 214, which is a candidate design by virtue of its membership in candidate design class A. As FIG. 2 indicates, it is configured from two specific parts, part 217 of part class B and part 218 of part class C. Although part 217 is not specific part 212 recommended by the bio-ontology resolution, both parts are closely similar because they belong to the same part class and are related by transition rule 219. (Even if transition rule 219 were not present, part 217 would be available as a candidate at least because backtracking within the part bio-ontology segment would retrieve all parts in class B as generic to part 212.)

The instantiated candidate design of design 214, and parts 217 and 218, may now be further evaluated by the additional assembly rules illustrated. First, part class-level assembly rule 220, being applicable to all parts in the class, is applied to part 218 along with optional information from the design model. Second, since assembly rule 221 tests members of part class C and members of design class A for configurability, it may be applied to this candidate instantiated design. Assembly rule 222 is similarly applicable because it tests pairs from part class B and design class A. Third, assembly rule 223 tests members of parts classes B and C for compatibility without regard to the design they are configured into, and should also be applied here.

Finally, supposing this instantiated candidate design meets all assembly rules, it may be evaluated for actual manufacturability (or synthesis). For example, class level manufacturing rules 226 may test the cost, time, and other manufacturing parameters of part 217.

The structures and rules illustrated in FIG. 2 are not intended to be limiting. For example, parts may have part specific manufacturing rules (illustrated as rule 224) as well as class level rules. Importantly, specific and class-level design manufacturing rules may evaluate the manufacturability or synthesizability of a design configured with specific parts. Further, rules may have additional arguments, such as an assembly rule depending jointly on two parts and a design, or a manufacturing rule depending on a design and on its parts, and so forth. Finally, alternate part class A is illustrated as not having any member-specific parts. This may occur, for example, if it has been added to the knowledge-base to complete a part bio-ontology in the part segment and not based on actual parts. In this case, transition/manufacturing rule may populate this class, testing the possibility of a proposed member.

Further, in other embodiments, rules of other types may be added to the knowledge-base to address particular problems of assembly, configuration, manufacturing, or the like.

Next, the three preferred classes of rules are described in more detail. Assembly rules provide guidance as to whether or not a design can be made from certain parts or parts classes, and what requirements or constraints of the design must be met by the parts. These rules (also known as assembly plans or protocols) test whether two sorts of parts can be functionally combined as contemplated in a design, and thus in many cases they depend jointly on the parts to be combined and the configuration according to which they are to be combined.

They are generally related to the other classes of rules, in that assembly rules provide a first series of tests that excludes candidate instantiated designs that are not feasible. However, designs that are “not infeasible” may still not be makeable. Thus transition rules may evaluate whether parts of the precise requirements can be constructed. Manufacturing rules evaluate whether protocols are available to actually put the design together.

Determination of assembly rules is driven by two criteria: to avoid disruption of the native function and structure of the parts and to enable the correct communication of functional relationship between the parts. Guidance for avoiding disruption of the parts when they are configured together may be obtained from two sources: extrapolation from comparative analysis of the successful pairings in natural systems and extrapolation from the successful and unsuccessful instances of artificially paired parts. The naturally derived rules are generally considered positive rules because instances of unsuccessful pairing of parts rarely survive in nature. These rules may be supplemented with analysis of a synthetically generated combination of parts. Artificial design rules generally have a narrower scope, applying to the specific design until more generality is verified in fact.

In physically coupled biomachines, assembly rules may arise from spatial limitations or steric consideration related to coupling. In temporally coupled systems assembly rules may arise from considerations of reaction kinetics, substrate affinities, diffusivities, and so forth, needed to integrate the temporal processes.

Integration rules are a special class of assembly rules that evaluate whether domains may be folded independently while preserving function. Because it is generally observed that protein domains have completed their folds prior to collapsing into a stable multi-domain structure, the interface or “contact patch” between neighboring domains within a protein are “designed” to avoid disruption of its neighbor. Measuring and summarizing the physical and chemical properties of the interfaces between neighboring domains of monomeric proteins will allow boundaries to be set for conditions that permit non-disruptive assembling of parts. As the biological sciences add more structural models of proteins obtained through either X-ray crystallography or NMR experiments, confidence in these interface-based assembly rules will be increased by re-tabulating the interface characteristics of the entire population of proteins. The characteristics of the interface that appear to affect structural integrity are planarity and circularity of the surface, the size of the interface surface area, the amino acid composition of the contact patch, the packing volume of the amino acids, the segmentation of the interface.

Manufacturing (or synthesis) rules or protocols indicate how to make an actual design on a scale from testing and prototyping to a commercial scale. If an instantiated design is manufacturable, then it is necessarily assemblable. But the converse is not necessarily true; if a candidate design is assemblable, then it may still not be makeable according to currently known protocols. In simple cases, manufacturing rules may simply be indications of a commercial source of a part or design. In other cases they will be protocols as known and used in the biological sciences. Where a protocol implementation is available as a kit from a supplier, manufacturing rules may be considered as parts.

Transition rules are a type of knowledge different from assembly rules and manufacturing protocols. They describes protocols that would “convert” one specific part or into another specific part, or one specific design to another specific design. For example, transforming a cyan-fluorescent protein (“CFP”) into a yellow-fluorescent protein (“YFP”) requires changing a few known amino acids; transforming a protease reporter into a calmodulin reporter requires substituting a sensor domain. As another example, protocols which may serve as transition rules are known to produce polyclonal antisera from an arbitrary antigen; rules for making monoclonal antibodies (Abs) from an immunized animal are known; further it is known how to convert multimeric Ab into a single chain Ab, such as an scFv.

Derivation of rules may be derived from reports concerning observed regularities respected in nature which appear to be guides for biomachine design. For example, various assembly type rules may be derived from such references as, e.g. Ledvina at al., 1998, Protein Science 7:2550 (binding of phosphate to periplasmic phosphate binding protein is entirely dependent on attractive local dipolar and hydrogen bond interactions in presence of repulsive surface charges); Lo Conte et al., 1999, J. Mol. Biol. 285:2177 (characteristics of non-permanent protein recognition sites include minimum and standard sizes, average hydrophobicity, average of 10 hydrogen bonds, as closely packed as protein interior, and so forth); Malby et al., 1993, Proteins 16:57 (constructed a scFv from the VH and VL chains of a monoclonal specific for N9 neuraminidase which had 2 fold lower binding than parent Fab); Orengo et al., 1999, Nucl. Acids. Res. 27:275 (provides a hierarchical classification of protein domain structures into evolutionary and structural groupings); Perisic et al., 1994, Structure 15:1217 (diabodies, dimeric bivalent antibody fragments, include two monomer of a VH chain, a VL chain, and a short linker from two Fabs each with one of the bivalent specificities); Silverman, 2001, Proc. Natl. Acad. Sci. USA 98:4996 (hydrophobic moments of globular proteins demonstrate conserved spatial scaling properties); Valdar et al., 2001, Proteins 42:108 (binding patches of permanent oligomers are more core-like, having fewer charged and more hydrohobic residues than the surface, binding patches of transient oligomers are more surface-like, being more stabilized by salt-bridges and hydrogen bonds than the core (both being highly complementary) and also demonstrating more evolutionary conservation than the rest of the protein).

Finally, manufacturing rules may be obtained from known synthesis knowledge and protocols, which appear in standard compendiums. See, e.g.: Ausubel et al., 2001, Current Protocols in Molecular Biology, John Wiley & Sons, Inc., New York; Beaucage et al., 2001, Current Protocols in Nucleic Acid Chemistry, John Wiley & Sons, Inc., New York; Bonifacino et al., 2001, Current Protocols in Cell Biology, John Wiley & Sons, Inc., New York; Coligan et al., 2001, Current Protocols in Immunology, John Wiley & Sons, Inc., New York; Coligan et al., 2001, Current Protocols in Protein Science, John Wiley & Sons, Inc., New York; Robinson, et al., 2001, Current Protocols in Cytometry, John Wiley & Sons, Inc., New York.

Designs Item Content—Parts and Designs

Next design item definition and content are described. For the purposes of providing a new design in a particular embodiment or implementation of the present invention, parts may be defined, or considered, to be non-decomposable, unitary entities, which have, inter alia, behaviors available for configuration to achieve an intended purpose of a design model or query. Parts thus have “functions” provided by internal “structures” in a manner that cannot be decomposed within a particular implementation of the design item knowledge-base. The description of part behaviors is, to the greatest extent possible, independent of part internal structure. However, configuration rules applied to a part usually do refer to aspects of the part's internal structure. For example, although the behavior of a fluorophore is largely specified by the wavelengths of the incident and emitted radiation (independent of its internal chemical structure), this structure is relevant to such assembly rules as the conjugation chemistry needed to link fluorophore to a sensor, and to steric hindrance of the fluorophore on sensor operation.

Designs, on the other hand, are composites, being configured from one or more parts according to con figuration information. The purposes and behaviors of designs result from the cooperating behaviors of its parts configured according,for example, to physical attachment (such as association by chemical bonds or non-bonding interactions), to temporal arrangement (such as a metabolic pathway, for example, as a sequence of metabolic steps), to control arrangement (such as transcriptional regulatory system functioning intracellulary).

However, the properties of being “decomposable” or of being a “composite,” or the lack thereof, are relative and not necessarily absolute. An entity that is not decomposable at one time may become so at a later time, due to progress in the biological sciences. A design in one implementation of this invention may be considered as (and used as) a part in another implementation. In fact, new designs often make use of known behaviors (or purposes) provided by prior designs. In such cases, the prior designs may be considered “parts,” albeit decomposable, or composite parts, of the new design. Since both parts and designs may be used to instantiate new designs, they are collectively referred to as design items.

In addition to the (relative) distinction between parts and designs generally, the knowledge-base may include both specific (that is, physical, or actually existing) parts and designs, as well as representations of classes of design items. In FIG. 2, design item classes, represented as larger ovals, enclose groups of design items, represented as smaller ovals. Classes of design items are equivalently representations of generic design items, or vice versa, the generic item being defined by the property controlling class membership. The generic fluorescent-protein-parts is a part with fluorescent behavior (having an incident and emitted wavelength), and is also an intrinsically-fluorescent protein (having a primary amino acid sequence). An actual fluorescent protein has a particular incident and emitted wavelength and a particular primary sequence.

Generic design items may be considered as what are otherwise known as “design cases.” A generic design item is typically a class of actual design items that are similar by sharing closely related actual configurations, closely related parts, and so forth. Like a design case, a generic design item may thus be considered as a design with variables, or slots, that may be filled in with the parts or designs defining the class.

The generic-specific hierarchy in the domain model and knowledge-base is illustrated in FIGS. 7A-D, 12A-C, 13 and 14. These figures are discussed in more detail elsewhere; here they are used simply to illustrate this hierarchy. FIG. 7A illustrates, in a state-diagram for mat, a ligand sensor with a spatially allosteric output; and FIG. 7B illustrates, in a similar format, a FRET-based fluorescence transducer. FIG. 7C illustrates configuration information by which the output of the sensor of FIG. 7A may be coupled to the input of transducer of FIG. 7B to design a detector biomachine. Next, FIG. 7D is a partial instantiation of the resulting biomachine design where a specific ligand (gp 120) is sensed and specific fluorescence responses are produced (λ₁, λ_{E1}, and λ_{E2}). These figures are highly generic, and would preferably belong to the domain model and describing objects, parts and designs, of the indicated classes.

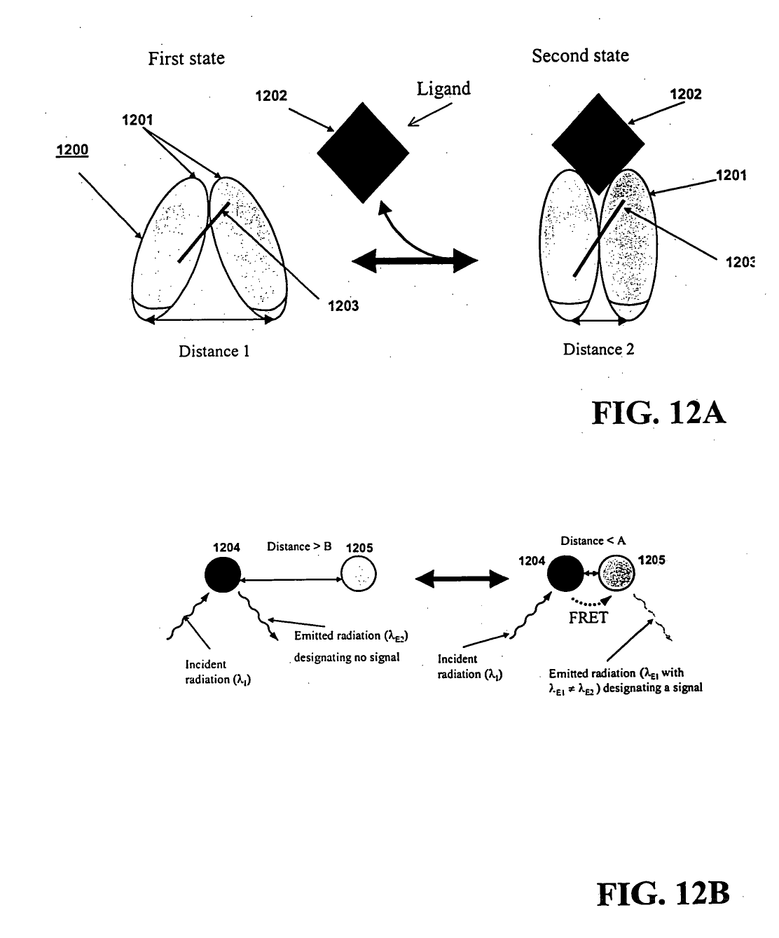

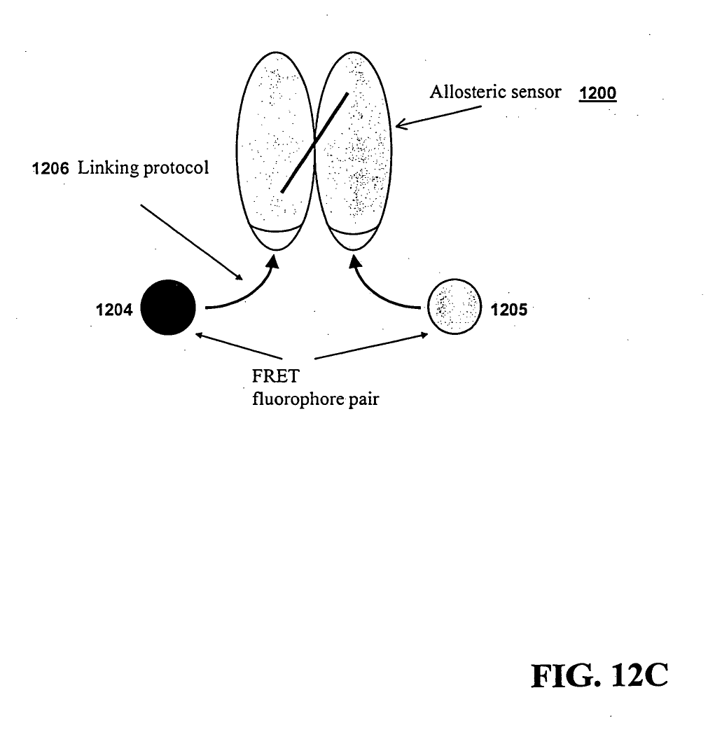

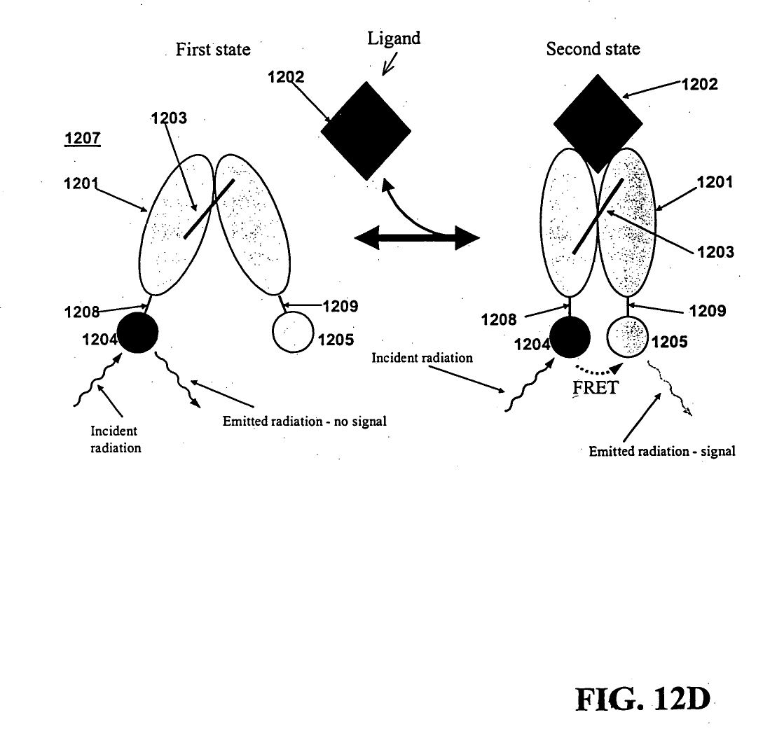

FIG. 12A is a more specific allosteric ligand sensor. Here, the sensor is a protein with two domains linked by a linker that flexes as indicated in response to ligand binding. FIG. 12B is a more specific FRET transducer where the interacting fluorophores have the particular sizes and responses indicated. FIG. 12C is an illustrative representation of assembly rules that, first, indicate that fluorophore linking or conjugation must occur to the inferior linking region to avoid interference with the ligand binding pocket; and second, that the fluorophore must not be too big to prevent the flex motion of the protein domains on binding. Finally, FIG. 12D is a generic ligand detector that may be configured from the sensor of FIG. 12A and the transducer of FIG. 12B according to the assembly rules of FIG. 12C. These figures would typically represent parts and design classes and would preferably be represented in the design item knowledge-base.

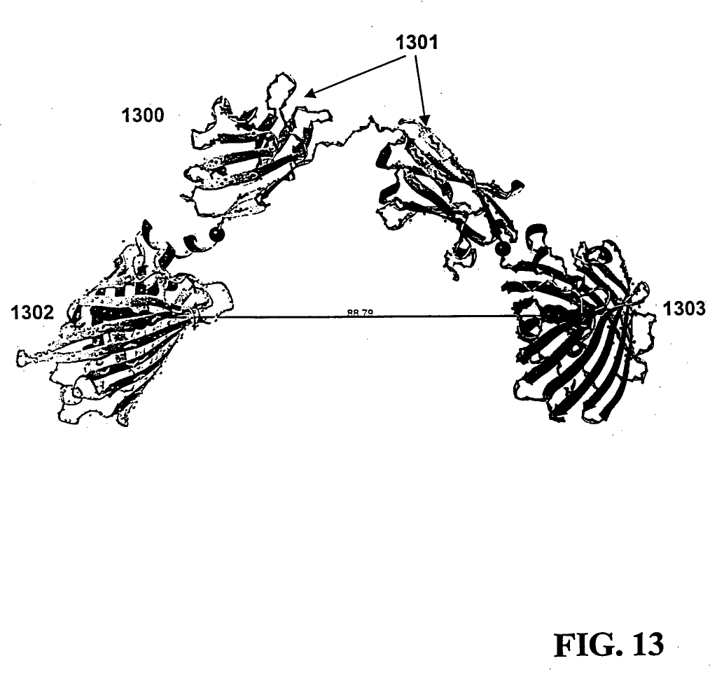

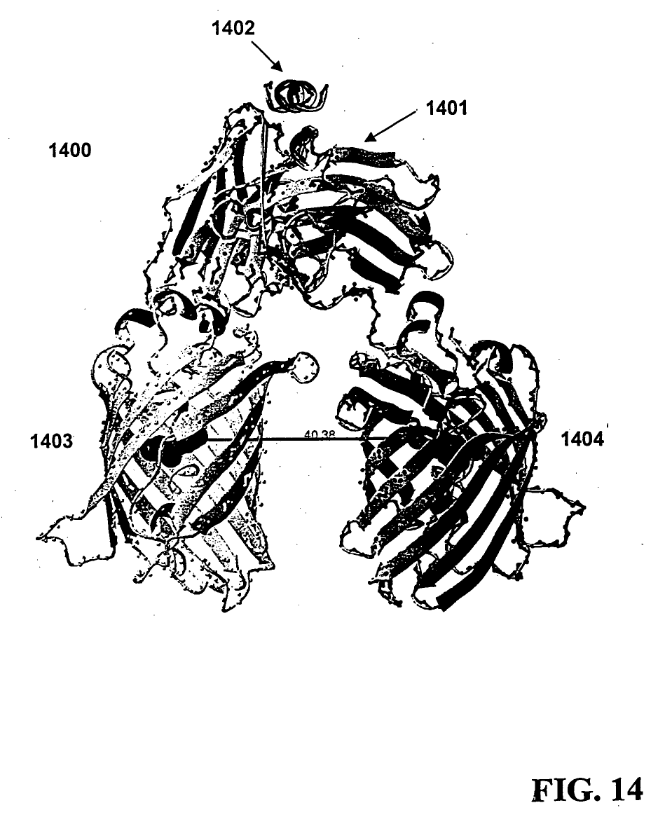

Finally, FIGS. 13 and 14 represent an actual detector of the generic class represented by FIG. 12D. The allosteric sensor is a scFv antibody specific for gp120. The FRET fluorophore pair is YFP (yellow-fluorescent protein) and CFP (cyan-fluorescent protein). FIG. 13 illustrates the detector without bound ligand (open configuration), and FIG. 14 represents the detector with bound ligand (closed configuration).

A design item knowledge-base is not limited to a single level part-class hierarchy; generic classes of classes, and so forth, may also be represented. Whether a generic-specific hierarchy is best represented in the design item knowledge-base or in the bio-ontologies of the domain models is essentially only an implementation consideration. More classification and structure may be represented in the design item knowledge-base and less in the bio-ontology, or vice versa. Generally, as in FIG. 2, the knowledge-base includes actual design items and classes of design items.

Next, turning to the actual content of the design item knowledge-base, designs may include as many known biomachines as possible, either discovered in nature, derived from theory, or successfully designed by the methods of this invention. As subsequently described, formal attributes of designs may be physically in a core database in relational format. Individual attributes may include identifiers of function and behavior (such as purpose, for example “reporter”, “transporter”), how a design interacts with the environment, its input/output ratio, its structure (such as, sequence, composition), intellectual property claims, commercial source (if any), and so forth.

Actual content of parts in the design item knowledge-base are illustrated by the following examples. An actual part may be a domain of a protein that has a specified function, for example, the SH3 domain for protein ligand binding or the ATPase domain for ATP binding and hydrolysis. A part may also be an entire protein, especially when the structural mechanism for its function is not yet known and hence the protein is not divisible without losing its function.

For example, such is the case for the Green Fluorescent Protein. Splitting of GFP in a manner destructive of the intrinsic fluorophore results in an inoperative fluorescent protein. However, the amino acids residues that govern and form the chromophore are well known, making possible a number of directed mutations resulting in fluorescent proteins with different emission wavelengths. These engineered GFP-mutants may be represented as distinct parts closely related according to the part segment of the bio-ontology. Alternatively, the GFP-mutants may be clustered as a single generic part in the knowledge-base. If certain of the mutants have variant physical properties, they may also appear in a separate classification according to the variant properties.

Continuing, a part may also be a system of proteins such as enzymes of the glycolysis pathway or of the polyketide synthetase pathway. A system of proteins may be treated as a part with a total behavior of producing outputs from inputs, such as alcohol from glucose, or a polyketide antibiotic form acetyl-coA moieties. It may also be appropriate to treat such systems as designs or biomachines. A part may also be a hybrid of inorganic and organic material, such as the metallic (gold) “nano-antennae.” Conjugation of a nano-antenna to a molecule, such as a DNA strand or a protein, may permit predictable control of molecular folding. When a gold particle is associated with an RNA, DNA strand or protein molecule, and they are then irradiated with radio-frequency electromagnetic radiation, the RNA, DNA strand or protein molecule will reversibly disassemble (i.e. enough energy is radiated to cause the reversible dissociation of some of the bonds, including hydrogen bonds, Van der Waals interactions, etc).

In contrast, the gold particle is not a part in the building of the nano-antennae since the behavior of the gold particle is predictable only in the context of the nano-antennae at this time. Similarly, a single amino acid is not a part for the building of a polypeptide until the engineering purpose of the amino acid as, for example, a linker and the behavior of utilizing the linker can be described. Therefore, proline may be a design item of the “linker” class having specific structural consequences when inserted into a protein.

Part representations in the knowledge-base capture a spectrum of attributes for specific parts, such as the exemplary parts just described, including, for example, their engineering purposes and behaviors, their assembly and integration rules, their sources and manufacturing rules, internal structural and architectural characteristics (such as, structure description from primary to quartenary), transition rule for making related parts, links to prior design in which the part has been utilized both in natural and in engineered environments, and its performance under these conditions, back-links to related items in the bio-ontology, and so forth. Those attributes that are sufficiently formalizable may be physically stored in a core database in relational format along with the designs. Additional attributes may be stored in databases with appropriate schema.

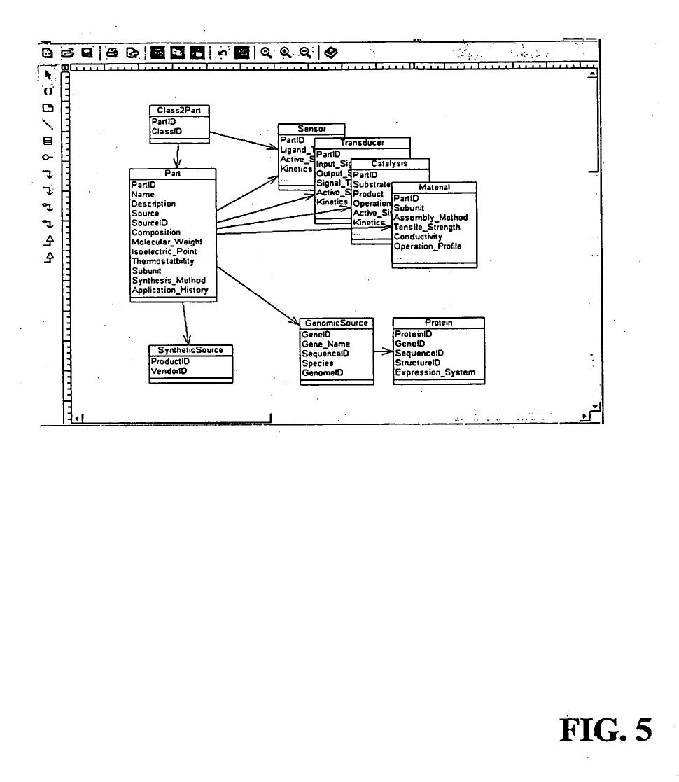

FIG. 5 illustrates certain attributes of a part in the core relational database component of the knowledge-base. The part representation has the following exemplary portions (or tables). A Class2Part table relates parts to their classes and vice versa. The main table (Part) stores basic part physical and identification data. Manufacturing rules and protocols here are stored as a SyntheticSource table, if commercially available, or as linked GenomicSource and Protein tables, if manufacture from a genomic source is necessary. The principal bio-ontological classifications of parts as sensors, transducers, materials, and chemical conversions (illustrated in FIG. 4) is reflected in FIG. 5 by the Sensor, the Transducer, the Material, and the Catalysis tables, respectively, with particular attributes for parts of the classifications.

Design Item Encapsulation

An important aspect of this invention is now apparent, namely that the use of parts in designs is encapsulated by behaviors and configuration rules. Rules may be implemented as methods having access to the internal structure of parts while presenting an external interface that does not requires such internal knowledge. Therefore, this appears as a black-box-like interface according to which extensive use of a part does not require internal knowledge and significant design activities, such as biomachine construction and evaluation, may be simplified. Later, during more detailed simulation, internal knowledge may be necessary, but then only biomachines highly likely to be successful need be simulated. The following code is exemplary of such encapsulation presenting an black-box interface.

// design class: allosteric ligand detector
public LigandDetector extends Detector {

| | |
|---|---|
| distance | : distance between identified residues in Å |
| S0, S1 | : states |

```
    public AssemblyRuleDistance
        { AssemblyRuleDistance = distanace_2 − distance_1 }
    public SetLigandPresentOrAbsent (ligand_present) {
        current_state = S₀;
        distance = disatnce_1
        CASE (current_state)
            S₀:  { IF (ligand_present)
                    THEN { (current_state = S₁;
                        (distance = disatnce_2) }
                    ELSE { (current_state = S₀); } };
            S₁:  IF (NOT ligand_present)
                    THEN { (current_state = S₀);
                        (distance = disatnce_1) }
                    ELSE { (current_state = S₁); } };
        END_CASE }
    public CheckDistance (current_distance) {current_distance =
    distance}
    }
// design class: FRET-based transducer
public FRETBasedTransducer extends Transducer {
```

| | |
|---|---|
| distance | : distance between fluorophores in Å |
| A, B: | : constant FRET threshold distances in Å |
| λ_{E1}, λ_{E1}: | : constant emission wavelengths |

```
    public AssemblyRuleDistance (distance_change RETURN true/false)
        { distance_change > B−A }
    public SetFluorphoreDistance (input_distance) {distance =
    input_distance}
    public StimulateEmission (λ) {
        IF (distance < A)
            THEN (emit fluorescence at λ = λ_{E1})
        IF (distance > B)
            THEN (emit fluorescence at λ = λ_{E2}) }
    }
transducer::AssemblyRuleDistance (detector::AssemblyRuleDistance)
```

Updates/Supplements to the Knowledge Base

Items in the knowledge-base, parts, designs, configuration rules, and so forth, may be entered and updated by a variety of means. Items may be added by experts, either manually or guided by a knowledge acquisition engine. “Knowledge engineers” may interface between experts and the knowledge-base, especially its class and bio-ontological structure. Various automatic processes and agents may also mine data for entry into the knowledge-base from genomic databases, structure databases, literature databases, and so forth. Typically, automatic processes may find new or updated information that will need to be screened by an expert or other user before it can be reliably entered into the knowledge base. Also, patterns of experimental data may be gathered and mined from, for example, a Laboratory Instrument Management System (LIMS).

The knowledge based may be updated from current developments in the biological sciences that provide parts, design, rules and so forth. References describing developments that are entirely exemplary include, e.g.: Donner et al., 1998, J. Mol. Biol. 283:93 1 (key residues identified in lambda repressor dimerization interface mutations of which affect by dimerization and DNA binding by apparent C-N terminal interactions); Fuh et al., 2000, J. Biol. Chem. 275:21486 (phase display with carboxyl-fused peptides identified ligands for naturally occurring PDZdomains); Giannattasio et al., 2000, Antimicrobial Agents and Chemotherapy 44:1961 (constructed by phase display inhibitory peptides to Erm methytransferase important in conferred resistance to macrolide antibiotics);. Han et al., 2000, J. Biol. Chem. 275:14979 (peptides binding to the Ga180 repressor can act as transcriptional activating domains); Joung et al., 2000, Proc. Natl. Acad. Sci. USA 97:7382 (improved bacterial two-hybrid systems for screening libraries with complexities to 10⁸); Katz, 1999, Biomolecular Eng. 16:57 (studies of streptavidin binding specificities); Wyatt et al., 1998, Nature 393:705 (gp120 has a recessed conserved core with neutralizing epitopes, on binding to CD4 further neutralizing epitopes are revealed for chemokine binding, the receptor core is surrounded by a variable, heavily-glycosylated, protective regions).

Implementation of the Design Item Knowledge-Base

The design item knowledge-base is preferably implemented with a core relational database of design item records associated (by direct or indirect pointers or other references) with additional information stored in convenient formats. The core relational database (RDB) stores, for parts and designs and classes of parts and designs, records (or tuples) in standard formats with fields representing those attributes that can be formalized with the relational schema. Certain information in the knowledge-base, which may not conveniently fit into the relational schema may be stored in associated databases (or alternatively as binary objects, or “blobs,” in the core RDB). For example, purpose and behavior may be represented as state machines or software objects in object-oriented databases (OODB). Configuration rules, to the extent they are not methods of design item software objects, may be stored also as software objects which test argument objects for transformability or configurability and return proposed transformation or configuration protocols.

The physical representation of the design item knowledge-base in one or more separate databases of whatever type is largely an implementation consideration. The present invention does, however, include that the knowledge-base may be distributed among several remote databases with particular contents, where each remote database is preferably maintained by individuals with particular expertise in its contents.

In addition to RDB or OODB databases, the knowledge-base may be partly or wholly formatted according to XML, or stored as a PROLOG logic base. Rules may be stored as LISP functions. Preferred RDB implementations are the database products of Oracle, Inc. The present invention may also employ other knowledge-base implementations.

5.1.4 Inference Engine

In a preferred embodiment, the present invention accepts design models or design schema of a wide range of detail and in the formats described above, translates or expands unspecified aspects of the schema according to the bio-ontologies of the domain model, instantiates the schema with candidate design items from the design item knowledge-base, and tests the instantiated schema with configuration rules associated with the candidate design items. In nearly all cases, these steps do not progress in a linear fashion from design schema input to successfully configured candidate designs. Typically, the translation/expansion returns too many options to fully consider, requiring that more likely options be selected for instantiation and evaluation first, with less promising options held for later evaluation. Also options may be returned which cannot be directly instantiated because there are no design items which meet all requirements. Finally, candidate instantiated designs may not satisfy the associated configuration rules.

Therefore, in this preferred embodiment, the present invention preferably includes an inference engine which helps to automate the choices that are usually needed to successfully search for configurable, candidate designs that instantiate design models or schema. This subsection describes preferred inference engines in detail.

In an alternative embodiment, the translation, expansion, and instantiation processes are substantially under full user control. Here, the domain model serves as the equivalent of dictionaries/thesauruses to aid the user in formulating selective queries for candidate design items to solve a design problem. The knowledge base is preferably structured to provide for access by sufficient candidate keys (in the case of a relational database) so that queries retrieve one or a few actual design items or design item classes. The user then selects the candidates to instantiate and test for configurability.

In this user directed embodiment, inference assistance preferably includes a graphical interface that provides intuitive search and configuration guidance. For example the interface may list search term options at increasing levels of refinement, estimate the sizes of possible searches and retrieval queries, display results in useful orders and details, and so forth. Alternatively, the interface may operate according to a query-by-example paradigm, for example, retrieving partial results and suggesting completions.

Although, the following is directed primarily to the inference engine embodiment, techniques used by an inference engine may be adapted for user control.

Inference Processes and Design Methods—Generally

With reference again to FIG. 1, the methods of this invention commence with a preparatory step 102, which converts the design problem 101 (or design requirements or query) into standard form 103. FIG. 15 exemplifies a graphical user interface (GUI) that the user initially encounters for inputting the requirements of the proposed design into the system of this invention. The “Requirement Wizard Quick Start” 1501 guides the user through the process. A more advances user accesses the “Requirement Modeler” 1502 through a menu option. The standard form is preferably a design that might appear in the knowledge-base, but lacking information that must be “designed.” This design schema at least includes purposes; optionally it may include constraints on the missing information (e.g., the biomachine must be a fusion protein), and specific or concrete design information provided in advance. Although the purpose may generally have the representations already described, for concreteness in this subsection, the purpose is described in the state-diagram representation.

Next, the methods translate or expand the design schema 104 to reach candidate specific designs or design classes and specific parts or part classes 105 that may be instantiated to correspond to the design purpose while meeting any design constraints and incorporating any specific design information. The candidate instantiated designs are then tested 106 for configurability according to the assembly, the transition, the manufacturing, and other configuration rules. Steps 104 and 106 use information from the domain model and the design item knowledge-base as indicated by 110 and 111, and are controlled by inference engine 113, which optionally employs user guidance 112.

Certain of these steps are now discussed in more detail, beginning with search methods for meeting design purposes. Typically, in design schema 103, the purpose state diagram includes only the minimal nodes and transitions needed to represent the design purpose. The goal of the design methods is, at least, to find a complete state diagram representing an actual design using actual parts which corresponds to the purpose indicated in the diagram of the design schema. This goal may be achieved according to the following search strategy. First, it may be possible to focus the search by first locating identifiers describing the design schema purpose in the domain model, and then limiting further searching to designs more specific than the located identifiers. These designs are generally linked to parts from which they may be configured.

After possible focusing, it is then necessary to search for a complete corresponding state diagram. A complete state diagram is constructed from the state diagrams representing the behaviors of the parts by composing these diagrams (in a manner similar to subroutine calls or method invocations) according to the configuration information contained in the design. Therefore, it is necessary to search for parts that have behaviors that correspond to portions of the schema state diagram, and to search for a design that can configure the parts into a complete state diagram corresponding to the entire schema state diagram.

For purposes of this search, state diagrams correspond in the following manner. Nodes and transitions in a state diagram are labeled according to the inputs and outputs of the purpose or behavior described. Generally, for two state diagrams to correspond, the nodes and the transitions in both must correspond so that the labels on the nodes and transitions correspond in meaning according to the domain model. If the two diagrams that correspond are equal, the correspondence is an isomorphism; if one more complete diagram corresponds to another less complete diagram, the correspondence is a homomorphism. In other words, the necessary search is for parts and a design so that the parts are homomorphic to portions of the design schema state diagram, but when configured according to the design, form a diagram homomorphic to the entire schema state diagram.

Graph theory teaches well-known algorithms for finding graph and sub-graph isomorphisms and homomorphisms. These algorithms may be applied to test whether a candidate design instantiated with specific parts actually corresponds to the original design purpose. Examples of algorithms include the following references: Barratt et al., 2000, J. of Photochem. and Photobiol. 58:54 (a rule based expert system for predicting toxicity of various sorts from presence of specific molecular substructures extended to predict photoallergens from presence of key substructures); Kanehisa, 2000, Post-genome Informatics, Oxford Univ. Press, Oxford, U.K. (chap. 4 discusses significant of graph comparisons and present approximate comparison algorithms); Kuhl et al., 1984, J. Comp. Chem. 5:24 (graph analysis algorithms); Ogata et al., 2000, Nucl. Acids Res. 28:4021 (a heuristic graph comparison algorithm seeking similarities or homologies analogous to sequence homologies and its application to detect functionally related enzyme clusters, the genome as indirect protein-protein interactions).

Next, the inference engine 113 may be implemented according to a variety of known strategies. A simple (but less preferred) strategy is generally known as breadth-first search. According to this strategy, essentially all possible designs are considered together at each step. Translation is preformed and all possibilities are saved; next, translation possibilities are searched and possible design items are retrieved and saved; then all design items are instantiated and evaluated for configurability. In one pass through the steps 104-106, since all possibilities are saved and considered, all successful designs, if any, will be found. Another simple strategy is known as depth-first search. Here, the method focuses on only one possibility at a time. First, an initial translation result is considered; one design item retrieval is performed based in this initial results; the single search results are then instantiated and evaluated; then the next translation result is considered; and so forth until all possibilities have been exhaustively considered.

A preferred inference process uses heuristics to guide which possibilities are considered next. These heuristics may be user guidance 112 provided during the course of performing the design methods. Alternatively, heuristics may be recorded and used to guide the inference engine, perhaps along with user guidance. Heuristics may be recorded, for example, as rules interpreted by an expert system for guiding the inference process. A variety of heuristic-guided inference engines (e.g., CLIPS, JESS, EXSYS) maybe used in this invention (see Giarratano et al., 1998, Expert Systems Principles and Programming, PWS Publishing Co., Boston, Mass., for example). Preferably the search engine is JESS (see, for example, http://herzber.ca.sandia.gov/jess/), a JAVA based system that supports the Rete algorithm for tree searches.

Inference Processes and Design Methods—Details

In more detail, translation and expansion of the input design schema (or model) preferably begins along parallel segments in the domain model, at least where there are multiple concepts in the input request that need to be resolved. Therefore, expansion may proceed in parallel in the design segment to refine the input design query and in the parts segment to locate parts classes cross-referenced from the successively refined designs. The translation process advantageously enters the domain model bio-ontologies at the level of specificity appropriate to information unspecified in the design schema, instead of commencing at the roots (where the bio-ontologies are separate but cross-referenced with separate roots) in all cases

Typically, the translation/expansion process will encounter multiple nodes in the bio-ontologies at which choices need to be made for the subsequent translation. In one embodiment, choices may be made automatically according to standard search algorithms, or preferably under control of the previously described heuristics. Preferably, the translation process may interactively seek additional design requirements from the user. It is likely that unexpected options will be uncovered during translation, some wandering from the design, but others being possibly productive. When options are presented to the user, informed choices may be possible that were not apparent when the problem was first formulated. Therefore, at many nodes of the domain models are one or more questions that describe the criteria for discriminating within that level. The questions at each node of each level of the ontological tree are used both as a mean of organizing the parts, designs, manufacturing procedures, cost planning strategies, or other objects in the biomolecular engineering domain, and to guide the user to the relevant concepts and considerations in engineering a biomolecular device.

During translation, it is advantageous to save in a temporary buffer the location and order of choices made (backtracking positions). Then if backtracking is needed to explore alternative designs, alternate choices may be made at the backtracking positions. Stated differently, the backtracking positions may provide a dynamic measure of “similarity.” A basic a priori measure of similarity between two alternatives may be based on the length of shortest path in the domain model between the alternatives. The length measure may be simply the number of links in the path. More preferable measures include weights on the links to represent that certain design choices lead to greater design differences than others. In the case of design schema translation, the similarity path may be the shortest path through the backtracking positions, so that the search may explore other alternatives in the case that a similarity measure in the initially-chosen alternatives is not successful.

An alternative method is to find multiple subsets of possible choices and then to select alternatives to explore from the intersection or combination of these subsets (alternatives in the most sucessful intersections being explored and expanded first).

For example, the design schema requirement might seek a biomachine that “senses” the presence and absence of a “toxin.” Expansion may discovers that “detection” is ontologically related to “sensing” and “sensor,” that “toxin” is a specific form of a biologic “ligand,” and that “ligands” intersect “sensors.” The initial expansion follows the alternatives in this intersection. Within this region of the bio-ontology are “question” nodes that activate the inference engine to ask specific questions that will further define the specific candidate classes or subclasses of parts. By combining bio-ontologies with classification rules (as for example, the rules used in identifying the conditions required for integrating neighboring parts) along with a set of inference rules, the methods of this invention exceed the performance of an algorithmic and keyword-based approach to retrieving parts.

At more generic stages of the translation/expansion process, choices maybe made according to logical and semantic criteria, such as, for example, by general (but standardized) descriptive terms identifying the intended purpose of the biomachine. At more specific stages, it is preferably for the translation/expansion process to choose based on details of intended purpose in view of details of generic designs and parts that require operations on state diagrams (where that is the representation of function used in an implementation). These operations are generally as described above for finding components that can be configured into the diagram representing the intended purpose.

After translation/expansion, the next step is to use the (initially-chosen) alternatives to formulate search requests to retrieves actual design items or classes of design items that are within (or exemplary of) the alternatives. The retrieved design cases, designs, parts classes, and parts are referred to as candidates. The candidates are then assembled into instantiated candidate designs, that is, candidate parts are fit into candidate designs according to their cross-references. Instantiation of purposes and behaviors from component design items is advantageously performed by composition of state diagrams as previously described. Although, as a result of the translation/expansion step, the candidates should meet other constraints and conditions (such as the use of pre-determined parts or designs) in the design schema, it is advantageous to first check that the instantiated candidate designs do fully satisfy the design schema. This check uses the complete record of each part and design from the knowledge-base. Additional information from the records is compared to the schema to check for conflicts. The instantiation process is likely to involve the combinatorial combination of parts classes (or parts) with design classes (or design).

Next the instantiated candidates are evaluated principally for their configurability and then for their manufacturability. Thus, assembly rules associated with the design items are executed with respect to the candidates. As described, these rules may test design items individually as well as in the instantiated combinations and sub-combinations. Candidates that are configurable may then be returned as solutions to the design query, or may be further evaluated for manufacturability.

Accordingly, manufacturing protocols associated with the successful candidate design items are retrieved and tested to determine if a combination is possible, according to which the candidate-instantiated design may be manufactured (in the laboratory or commercially). The protocol combination may include transition rules that construct or synthesize a particular part (or other design item) from one or more closely related parts. If manufacturable, the assembled manufacturing protocol is output along with the design, and may serve as instructions for manual construction of the instantiated candidate or may be converted to control automated synthesis equipment.

The output manufacturing protocols that best meet the engineer's manufacturing requirements for synthesizing the design preferably include such information-as DNA and protein sequences of the peptide or peptides, and cross-linking chemistry (if appropriate), as well as the projected cost of the reagents, cost of the recommended manufacturing process, time required for the manufacturing process, and vendor contact information. The domain model and the knowledge-base have an integrated repository of data and links to data that are relevant for development and production decisions.

Retrieval from the design item knowledge-base, and instantiation and evaluation to obtain candidate design solutions, may involve local search and backtracking that does not return to alternatives in the domain model. For example, the design items retrieved according to queries formulated after the translation/expansion process may lead to candidates that fail the configuration evaluation according to the associated assembly rules. Instead of backtracking into the domain model, it is advantageous to instantiate and evaluate designs similar to those indicated by the domain model according to design item information. For example, specific parts or part classes are “similar” for these purposes if there are transition rules for converting among the parts or the classes. Also, transition rules may be available for converting design and design classes. Thus if the first instantiated candidates cannot be configured according to the rules, transition rules may be used to find “similar” design items for instantiation. If these are configurable, they may be returned to the user for consideration. Also, similarity in the design item knowledge-base may be inherited from similarity in the domain model.

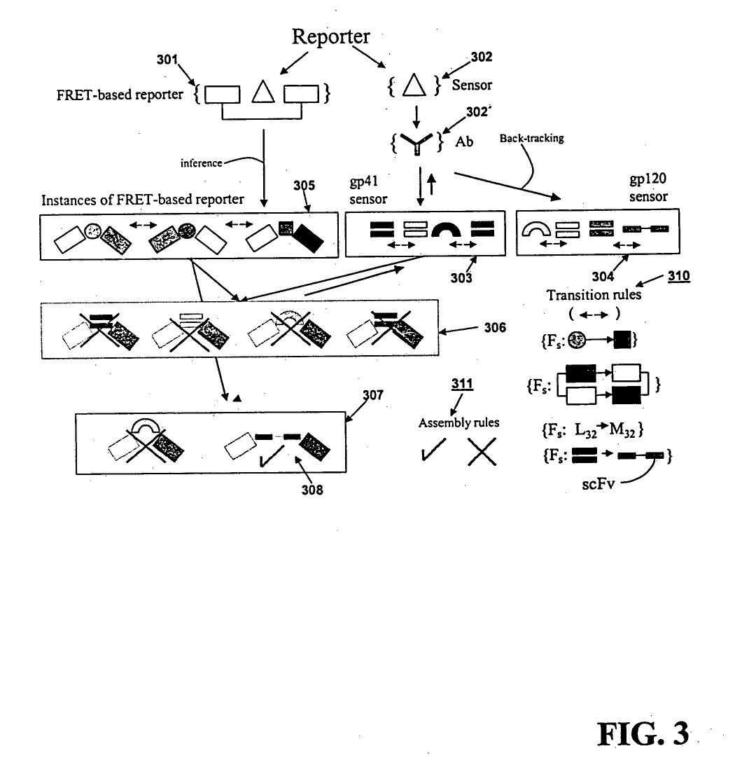

FIG. 3 illustrates this local search process for the design of an HIV envelope protein reporter. Translation using the domain model results in retrieval of generic FRET-based reporter design 301, where each pair of rectangles represents a FRET fluorophore pair and the triangle represents an allosteric sensor. Also retrieved is generic sensor 302, which leads to a single more specific class, namely class 302′ of antibody (Ab) based sensors, both for gp41 and for gp120. Transition rules associated with these retrieved design items, indicated at 310, provide, in top-to-bottom order, for substituting different sensors in the generic reporter 301, for substituting various FRET sensor pairs in the reporter 301, and for converting among Abs of the same specificity, such as, for example, converting a double chain Ab to a single chain Ab. The generic sensor 301 leads to class 305 of more specific sensors according to the relevant transition rules. Assembly rules are schematically illustrated at 311 as indicating that either an instantiated candidate is configurable or is not configurable.

The illustrated instantiation process first attempts to instantiate the available gp41 sensors 303 into the reported instances 305. Because the assembly rules indicate that none of these candidates are configurable, the process backtracks to try to instantiate a sensor similar to the gp41 sensor. Ascending to Ab-based sensors 302, the process is led to gp120 sensors 304 that are similar because they are of the same generic sensor class (being Abs), and they are specific to the same type of ligand for the organism of interest, HIV envelope proteins (this latter-similarity is advantageously inherited from the bio-ontology and not stored entirely in the knowledge-base). The process then descends to instantiate reporters 305 with sensors 304. In this case, the assembly rules indicate candidate 308 instantiated with a scFv Ab specific for gp120 is configurable. This successful, instantiated, candidate design is then returned to the user for consideration.

The methods described above also encompass apparent variations and alternatives among which are the following. First, a successful design output, preferably after actual testing, may be entered in the knowledge-base of the invention as an actual design or a part or both. Further, it is advantageous to record an audit trail of the progress of the inference engine, the branches explored, and the assumptions used. User inspection of such audit trails may either allow fine-tuning of the progress of a particular design or permit improvement to the inference engine or its heuristics. Accordingly, inference procedures that do not provide for audit trails, such as neural networks, are less preferred.

For example, translation of the requirement for a “well characterized” part may have been to “the number of literature references that a part entry has” instead of “having knowledge of a molecular structure or the kinetic parameters” as intended. The audit trail may be used to adjust the inference process in the future to better achieve the intended expansion by examining when and how the unintended expansion was made in a design solution.

5.1.5 Simulation and Testing

With reference again to FIG. 1, the final steps of the preferred implementation collect the successfully-configured, instantiated, candidate designs 107 that meet the requirement of the input design schema, and then test the candidates. Successfully tested candidates 109, especially those actually constructed and laboratory tested, may then be stored in the invention's design knowledge 110 and 111 for use in future designs. In other embodiments, the methods terminate at steps 106 (with one successful candidate) or 107 (with a number of successful candidates).

Candidate testing may involve computer-based (in silico) simulation or actual construction and laboratory testing. Advantageously, the successful candidates have been also determined to be manufacturable according to the associated manufacturing protocols in the knowledge-base. Then, candidates may be constructed or synthesize following the output manufacturing instructions. Alternatively, the user can manually construct manufacturing instructions from protocols known in the biological sciences. Once constructed, a candidate is tested as necessary to confirm that the design purpose is achieved, and optionally to look for additional behaviors that should also be stored in its design representation.

The invention also encompasses optional computer-based testing using primarily available tools. Simple testing may provide visual representations of a candidate design that a user may manipulate to investigate its shape, possible interactions, unexpected hindrances, and so forth. Manipulation may involve rotation, zooming, plotting of surface properties (electrostatic potential, hydrophobicity, and so forth), as known in the art. More sophisticated computer based testing may involve verification of structure predicted as a result of the instantiation process. This process constructs structures in a formal manner and tests them subject to semantic configuration rules. An advantageous further step is to check these structures by known determination methods, including use of homology to known structures, molecular dynamics, and other modeling tools. Further testing sophistication may involve confirmation of predicted and expected interactions. For example, where biomachine operation involves ligand binding, subunit assembly, and so forth, these interactions may be checked with docking software and the like. Lastly, where feasible, ab initio structures and interaction techniques may be applied. Simulation may also be used to predict possible new behaviors of a new or prior design. Available simulation tools include those from Tripos, Inc. (Alchemy 2000 for docking), or Freie 2000 (and references therein for predicting allosteric movements).

In further embodiments, simulation planning and simulation tool use may be assisted by design knowledge. Tools and their use may be organized in a domain model to assist the selection of correct tools. At a detailed levels, particular tools and their parameters may be aspects of assembly rule information, which may be used during evaluation step 106 or set aside for optional later use in simulation testing step 108.

Output of the present invention includes the following. First, digital representations of all aspects of a successful design may be output at termination 109. These representations include components such as the design itself (including representations of the component parts), the results of assembly rule evaluation, manufacturing protocols (including use of transition rules if necessary), audit trails of the design process from which related designs may be determined, and so forth. Output also includes digital representation of databases of design, parts, and so forth.

Output at termination may also include the actually synthesized or constructed design in laboratory or commercial quantities, kits for construction or use of the designs, and accessories of use with the design. Collections, sets or kits of multiple synthesized designs are also encompassed.

Properties that can be simulated include chemical and physical properties such as number and type of nucleophilic or electrophilic moieties; number and type, (e.g., sp, sp² or sp³) of covalent bonds; number of substantially ionic bonds; strengths of certain interatomic bonds; refractive index; pH and pK values; spectroscopic information such as portions of NMR, IR, and UV spectra; as well as other computable chemical or physical properties. Chemical and physical properties may be calculated by physics-based computational programs employing, for example, Monte Carlo methods, molecular dynamics, semi-empirical quantum mechanics methods, ab initio quantum mechanics methods, or so forth. See, e.g., Hehre et al., A Brief Guide to Molecular Mechanics and Quantum Chemical Calculations. Quantum-mechanics-based programs can also provide molecular surface characteristics at, for example, the highest occupied orbital or the lowest unoccupied orbital, and can evaluate surface distributions of charge, nucleophilicity or electrophilicity. Such surface distributions can then be used in further fitness functions evaluating the likelihood of a compound binding to or reacting with a target.

A useful class of properties originates from empirically-derived models which correlate certain molecular structures (or other properties) with a particular property. Correlation may employ regression methods, neural networks, or other tools of statistical pattern recognition. QSAR models are examples of this class fitness functions. See, e.g., Grund, 1996, in Guidebook on Molecular Modeling in Drug Design (Cohen, ed.), pg. 55, Academic Press, San Diego, Calif.; Fujita, 1990, in Comprehensive Medicinal Chemistry (Hansch, et al., eds.), pg. 497, Pergamon, Oxford. One QSAR-like model of particular interest in drug design is the CLOGP program, which calculates an octanol-water partition coefficient as a measure of hydrophobicity or lipid solubility. See, e.g., Leo. et al., 1990, in Comprehensive Medicinal Chemistry, pg. 497. Such properties may also be used to evaluate aspects of biologic reactivity. For example, reactivity of a number of active compounds with respect to a particular biologic function or, more specifically, at a particular receptor for a number of compounds may be modeled on the basis of particular structural or physical aspects of the active compounds, and the model then used to predict the activity of other compounds. The CoFMA program is an example of such a model of particular interest that also makes use of 3D conformations of compounds and targets. See, e.g., Cramer et al., 1988, J. Amer. Chem. Soc. 110:5959. Other QSAR-like methods may also be used in the present invention. See, e.g., Kier et al., 1999, Molecular Structure Description, Academic Press, San Diego, Calif. A further class of properties particularly useful for drug design may, for example, be derived from docking programs, which use knowledge of the structure and properties binding region of a receptor to evaluate the binding affinity of target molecules. For example, a docking program uses knowledge of the spatial distributions of hydrophobicity, charge, and hydrogen-bonding potential in a binding region to determine compound molecule affinity from the complementarity of the corresponding spatial distributions of the compound. Examples of docking programs are well known in the art and are commercially available. See, e.g., Bohm et al., 1999, J. of Comp.-Aided Mol. Design 13:51-56; Itai et al., 1996, and Koehler et al., 1996, in Guidebook on Molecular Modeling in Drug Design (Cohen, ed.), pg. 93 and 235. If a compound to be docked is known, its structure may be retrieved from known structure databases, such as the Cambridge Structure Database (available in the United States from Daylight Chemical Information Systems, Inc.) If no structure is available for the compound, for example if it is novel, then its structure (especially for small compounds with molecular weights less than about 500 or 1000) may be determined by methods well known in the art which are implemented in various commercially available programs. See, e.g., Sadowski et al., 1990, J. Tetrahedron Comput. Method. 3:537;

Examples of empirical rules for determining protein structure can be found in, e.g. Brannnetti et al., 2000, SH3-SPOT: an algorithm to predict preferred ligands to different members of the SH3 gene family, J. Mol. Biol. 298(2): 313-28; Baxter et al., 1998, Flexible docking using Tabu search and an empirical estimate of binding affinity, Proteins 33(3): 367-82; Bohm, 1998, Prediction of binding constants of protein ligands: a fast method for the prioritization of hits obtained from de novo design or 3D database search programs, J. Comput. Aided Mol. Des. 12(4): 309-23; Eldridge et al., 1997, Empirical scoring functions: I. The development of a fast empirical scoring function to estimate the binding affinity of ligands in receptor complexes, J. Comput. Aided Mol. Des. 11(5): 425-45; Kauvar et al. 1995, Predicting ligand binding to proteins by affinity fingerprinting, Chem. Biol. 2(2): 107-18; Murray et al., 1998, Empirical scoring functions. II. The testing of an empirical scoring function for the prediction of ligand-receptor binding affinities and the use of Bayesian regression to improve the quality of the model, J. Comput. Aided Mol. Des. 12(5): 503-19. The following references describes uses of empirical rules and chemical knowledge common in the art for modifying ligand binding specificity and affinity, e.g., DelValle et al., 1995, Construction of a novel bifunctional biogenic amine receptor by two point mutations of the H2-histamine receptor, Mol Med 1(3): 280-6; Riechmann et al., 1992, Improving the antigen affinity of an antibody Fv-fragment by protein design, J. Mol. Biol. 224(4): 913-8.

Other exemplary rational simulation techniques are based on methods of homology modeling known in the art. Homology modeling methods generally approximate the structure or properties of a candidate polypeptide domain by the structures of homologous proteins and protein fragments found in protein structure databases. Homologous proteins preferably have statistically-significant amino-acid-sequence similarities, and optionally similar biological derivations. Approximate structure for an alternative candidate may be obtained by homology modeling, and then used to estimate the binding of the new target peptide, by, for example, use of docking tools that estimate new target binding by searching for a lowest energy alignment of the new target in the approximate structure determined for the binding pocket of the alternative candidate. Candidates with the best estimated binding energies are selected for subsequent processing. Conversely, as described below, homology modeling may be used to select new candidates. For example, proteins found by modeling to be homologous to the certain structural alternatives may provide sequence substitutions defining improved candidate domains. Homology has other application in the present invention. For example, consensus binding sequences in protein structure databases that bind to short peptide sequence fragments (for example, of 1-4 amino acids) may be combined in “chimeras” that are likely to be binding candidates for longer target peptide sequences. Homology modeling may also be used to improve the stability of newly found candidate (perhaps even one with adequate binding). Tools for homology modeling include WHATIF (Vriend, 1990, Mol. Graph. 8:52). Improving candidate stability by sequence comparison or empirical approximation are described in,.e.g., Wang et al., 2000, Stabilization of GroEL mini-chaperones by core and surface mutations, J Mol Biol 298(5): 917-26; and Lopez-Hernandez et al., 1995, Empirical Correlation for the Replacement of Ala by Gly: Importance of amino acid secondary intrinsic propensities, PROTEINS: Struct. and Function 22: 340-349. Methods for producing chimeric proteins with synergistic target-binding properties are described in, e.g., Campbell et al., 1997, Chimeric proteins can exceed the sum of their parts: implications for evolution and protein design, Nat. Biotechnol. 15(5): 439-43; Guerrini et al., 1998, Rational design of dynorphin A analogues with delta-receptor selectivity and antagonism for delta- and kappa-receptors, Bioorg. Med. Chem. 6(1): 57-62; Shimoji et al., 1998, Design of a novel P450: a functional bacterial-human cytochrome P450 chimera, Biochem. 37(25): 8848-52.

5.2 Systems

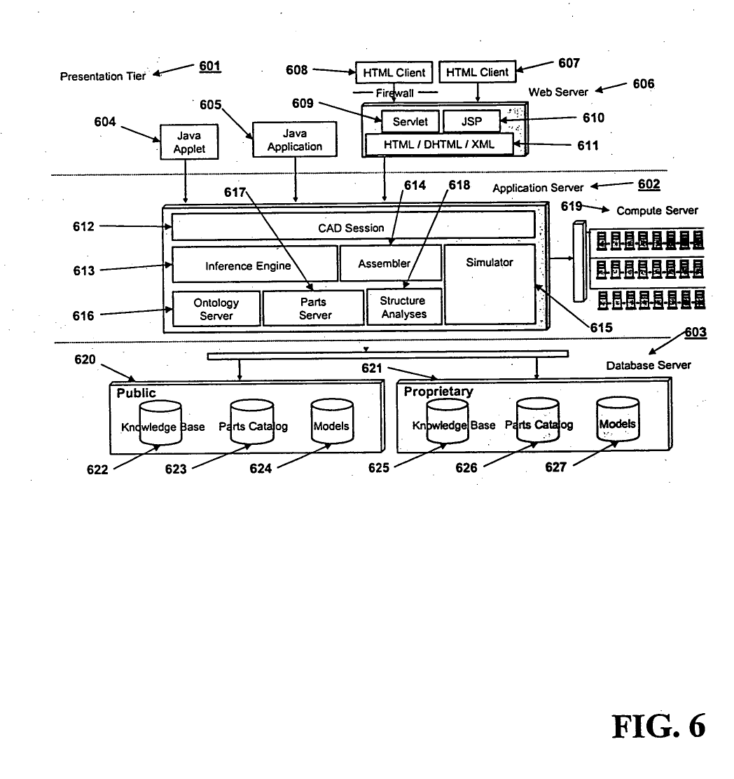

In this exemplary implementation, the system is divided into three tiers, namely presentation, business and data. These three tiers are exemplified in FIG. 6 by the sections of the system labeled the presentation tier 601, the application server 602 and the database server 603.

The presentation tier 601 includes a user interface through which the engineer/client accesses and interacts with the Biomolecular CAD session 612. In an exemplary embodiment of the system, the user interface includes a graphical user interface for the state diagram and interactive Q&A session. The graphical/input interface could employ Java applet 604, a Java application program 605, or a web server 606 with an HTML user interface page. In an embodiment of the system the engineer/client has direct access to the system via the HTML 607 user interface, or in yet another embodiment access to the Biomolecular CAD session 612 via the HTML graphical interface is protected by a firewall 608. The web server 606 can be supported by Servlet 609, JSP 610, or HTML, DHTML or XML 611 programs. Means of input of the requirements of the design include real text, selection from a list of presented options (drop down list), or as graphic input (sketched with symbols) via a graphical interface that supports UML. The graphical/input user interface can include PC's or computer workstations.

The Application server 602 exemplifies the business tier of the system. In an exemplary embodiment, the engineer/client is able to access (initiate/navigate) the Biomolecular CAD session 612 through a graphical/input interface. The Biomolecular CAD session 612 includes an inference engine 613, an assembler 614, a parts server 617, a structure analyzer 618, an ontology server 616 and a simulator 615. The inference engine used in this exemplary implementation of the invention is JESS, a JAVA based system that supports the Rete algorithm for tree searches, however, the inference engine of the present invention is not limited to only JESS. In another embodiment of the system, the graphical/input interface is capable of browsing the parts ontology and other ontological systems 616. In an exemplary embodiment of the system, the engineer/client is also able to use the graphical/input interface to submit a design for testing to the simulator 615 and assembler 614. In the embodiment of the system of FIG. 6, the elements included in the Biomolecular CAD session 612 can access a server 619 for computation. In yet another embodiment of the system, the application server functions are distributed on computer readable media, such as CD-ROMs, high capacity digital tapes or DVDs.

The third tier of the system includes the database server 603. In different embodiments, the database server 603 either allows public access 620 or access is proprietary 621. The public server includes a knowledge-base 622, a parts catalog 623 and models 624. The proprietary server similarly includes a knowledge-base 625, a parts catalog 626 and models 627. In an embodiment of the system, the graphical/input interface is capable of browsing the parts catalog of the database server 624, 626. The structure of the database server can be implemented in many different ways, including RDMS, XML, PROLOG, LISP or flat files with keywords. In this exemplary implementation, Oracle, an RDMS, is chosen for performance reasons. In another embodiment of the system, the graphical interface could be used for selecting a list of parts or classes of parts for design suggestions.

Exemplary embodiments of the systems of this invention can include computer-assisted manufacturing (CAM) modules that convert, or assist in converting, manufacturing protocols and rules into instructions to automatic laboratory equipment and robots, so that synthesis and testing of designs may be facilitated.

Exemplary embodiments of the system can gather data to enrich the knowledge-base and mine for patterns from experimental data. This can be accomplished through means including interaction with experts, automated data mining systems, literature mining systems for QA and data acquisition, and genomic mining systems.

In an exemplary embodiment of the system, the functions of the system could all be contained on one computer. In another embodiment of the system, the functions could be distributed in any number of ways among any number of systems. Access to the functions can be though PC's or computer workstations, in different embodiments. In yet another embodiment of the system, the database server can be distributed on computer readable media, such as CD-ROMs, high capacity digital tapes or DVDs.

The separation of the various application and data modules anticipates the need for incremental upgrades of various analysis algorithms as well as the need to integrate multiple access-protected proprietary databases with public versions of the same databases and to integrate databases annotated at different sites. An alternative implementation strategy for the integration layer includes using COBRA based exchange server, a XML based exchange server, or Window COM+.

5.3 Preferred Applications

5.3.1 Exemplary Use Scenarios

A First Use Scenario

1) A typical use scenario of the Biomolecular CAD system includes designing a biomolecular device to meet a specific need, for example, a sensor.

A biomolecular engineer submits the requirements for a biomolecular device (a product) to the CAD system. The requirement could be either inputted as or translated to a state diagram (e.g., a flow diagram or a decision tree) that models the physical, biological and/or chemical states that the user expects from the device under design, as well as the constraints describing the system in which the device will operate.

The CAD's inference engine then translates the requirement diagram and reasons each element of the description for the best matches in the parts knowledge-base (see FIG. 4). Depending on the degree of ambiguity in the requirement description, the inference engine could interact with the user to confirm, expand or narrow various features in the product requirement specified. For example, the user might ask for a device that reports the presence or absence of a particular protein fragment. Referencing the BEO, the inference engine translates the requirement “presence and absence of a protein fragment” to be a search in the network neighborhood of the “Sensor” class of parts. The inference engine will discover that in this region of the network there are paths that discriminate among the characteristics of the ligand that the sensor would recognize, such as size, conformation or sequence, and develops questions to assist the user in refining the requirements (for example by formulating a textual question or presenting a list of suggestions). The refinement steps will repeat until each requirement can be mapped onto one or more candidate classes and subclasses of parts or the request is forfeited. The classes and subclasses of parts could be used as keys to retrieve the specific candidate parts from the parts knowledge-base (FIG. 4).

The entries in the parts knowledge-base are linked to a series of attributes that describe the part's input and output parameters, as well as other descriptions including its source, geometry, composition, and the specific conditions under which the part had been utilized both in natural, and in engineered environments, and its performance under these conditions. This parts information determines the candidate combinations and/or configurations possible. A proposed machine as described by the refined state diagram and the corresponding set of candidate parts can usually assume more than one configuration.

The inference engine working with the knowledge base containing the integration/assembly rules will evaluate each combination (example given in FIG. 3). To avoid unnecessary and costly searches, the inference engine will bypass drilling deep into branches that scored low at the upper nodes. Of the possible configurations, some arrangements might not be viable or might be less desirable. For example, issues might arise with the incompatibility of the neighboring parts for integration, such as lack of appropriate non-interfering contact patches, lack of cross-linking chemistry for the required contact areas, inability to formulate a sequence of amino acids that would fold into the appropriate complement of adjoining parts, or with ineffective communication of force or substrates between neighboring parts. Each combination will be sorted by appropriateness of the configuration to the requirement.

Keeping an informed list of alternative candidate combinations is necessary. An explanation of the rating will be reported for each configuration, as well as for the choice of the components to assist the user in choosing the appropriate design. One can think of instances where a particularly good design failed to score higher due to the imprecision of the match between the desired performances, the performance of available parts, or the cost to manufacture a given part.

Of all of the proposed designs, a user can choose a promising design for further evaluation in the simulation environment provided by the CAD. The simulation environment applies various structure-function principles to evaluate the design. For example, one can test the new biomolecular device for such behaviors as thermostability, pH sensitivity or ligand selectivity. The range of conditions that will be simulated depends on user selection and availability of simulation models.

Current implementation would integrate such structural-function models as molecular docking from Tripos or Freie 2000 (and references therein for predicting allosteric movements). In the course of the simulations, the CAD might identify a property that is not compatible with the product requirements, in which case, the user might try another design or manually replace certain components.

Alternatively, the simulation might reveal unique properties that are lacking in the inventory of parts, in which case the new assembly will be added to the parts knowledge base under the appropriate classification.

Once the engineer approves the design, the CAD will proceed to tabulate the history of the design session and the simulation session, and output the biomachine plan. The output includes the refined design and an assembly/manufacturing plan (which results from evaluating the design).

In addition, the CAD system might be used to send the synthesis instructions to a CAM system, which in turn could interact with a LIM-based QA system that could return the test value of the prototype for fine-tuning the knowledge base or directing a second round of design refinements.

A Second Use Scenario

2) An alternative use scenario of the Biomolecular CAD system includes accurately retrieving a set of biomolecular parts.

An engineer has a design for a biomolecular device that requires a part with a specific function, for example a biosensor with the capability of sensing the presence of a toxic small molecule (e.g. a gram-negative bacterial toxin), perhaps at a concentration of 1 nM or less, and which can be synthesized as a single polypeptide.

In an exemplary embodiment, these specifications are inputted as definition statements such as “the device is a single strand polypeptide” as well as conditional statements such as ” if Anthrax is present, the device's light output changes from 420 nm (blue) to 550 nm (yellow).” These requirements would be translated by the inference engine supported by the Biomolecular Engineering Ontology into query statements for searching the Parts Database. The user is then presented with a list of parts that matches the requirements, including a naturally occurring antibody that binds to Anthrax, and an engineered antibody that is currently used for Anthrax vaccines.

Each part record can be expanded to expose various categories of information such as sequence composition, vendor contact, cost, fabrication time, or operational conditions. Alternatively, the user might further refine the returned list by providing additional requirements, or by specifying the acceptable value of specific variables in the record.

Further Use Scenarios

3) An alternative use scenario of the Biomolecular CAD system includes browsing the various types of parts in the knowledge-base with the purpose of developing novel ideas for a biomolecular device.

The engineer will begin their browsing via the parts knowledge-base search interface. They will begin by selecting from the major classes of parts in the parts ontology (see FIG. 4). In this example, the engineer will select the “Sensor” class. In response, the CAD would provide a tree view of the various subclasses of Sensor with the number of sensor objects found indicated at the node of each branch.

4) An alternative use scenario of the Biomolecular CAD system includes exploring novel combinations from a given list of biomolecular parts or part classes.

The engineer might start by inputting a list of Part_ID and seeing what might be made with these or similar parts.

5) An alternative use scenario of the Biomolecular CAD system includes testing a design for a specific behavior.

The output from the Biomolecular CAD system includes data for making a biomachine, database products of biomachines, methods of making the biomachine, actual biomachines; etc.

5.3.1 Exemplary Application

gp120 Reporter System

Application of the Biomolecular CAD in the development of a gp120 specific reporter system.

The importance of the gp120 reporter system is linked to its application as an HIV detector. In an exemplary embodiment, the gp120 reporter system (hereafter referred to as the gp120 clasp) is an all protein device that recognizes a portion of the gp120 glycoprotein, which is found on the surface of the HIV-1 virus. In an embodiment of the gp120 reporter system (see FIG. 18), when gp120 is bound to this species of reporter system, a fluorescent shift takes place, and can be detected with a spectrophotometer centered at wavelength 550 nm. Otherwise, in the case that there is no gp 120 present, or it is present in amounts less than a threshold value, the fluorescent emission is centered at around 460 nm (see FIGS. 17 and 18).

During the design phase of the gp120 Clasp, the engineer collects a set of functional requirements from the users and scientists. These requirements could be translated into definition and conditional statements. For the gp120 Clasp, the portions of the requirements/constraints that are definitions could be presented as follows, including statements such as:
All components are genomic translations.
All components are functional without post-translational modifications.
The components are contiguous.
The system reports by a light signal.
No external chemical input is required for signaling.
All components are well characterized.
The components are not IP bound.
gp120 is a ligand.

In exemplary embodiments, the system's possible function-purpose/operational states can be described by a series (incremented by time or space) of “If-Then” statements via a text-based interface. Alternatively, in another embodiment, the conditions can be graphically inputted via a graphical interface that supports UML. The possible states of the gp120 Clasp can be described as follows:
If gp120 is present, then an input radiation at a wavelength of X nm is converted to an output radiation at a different wavelength of Y nm.
If no gp120 is present, but another molecular ligand is present, then an input radiation of X nm would be converted to an output radiation of Z nm.
If no molecular ligands are present, then an input radiation of X nm would be converted to an output radiation of Z nm

The requirements of the “If-Then” statements would then be translated into a design by the present invention. FIGS. 7A-C show exemplary design items that are used in the design of a generic detection system, while FIG. 7D shows the result of their combination. FIG. 7A exemplifies a generic state machine of a sensor for a specified ligand. The sensor has a given conformation, where two sections of the sensor 701 are separated by Distance 1, when either the specified ligand is absent or some other (undesired) molecular ligand is present. When the specified ligand binds to the sensor, the conformation changes such that a different Distance 2 separates the two sections of the sensor 702.

FIG. 7B exemplifies the generic state machine of a FRET-based transducer pair. When the transducers 706 are closer to each other than a certain threshold separation (i.e. by a distance<A), and they are irradiated by light of wavelength λ₁ 707, the output from the transducers 708 is light emitted at wavelength λ_{E1}, where λ₁≠λ_{E1}. When the transducers 709 are farther apart than the previously defined separation B (i.e. distance>B), and they are irradiated by light of wavelength λ₁ 710, the output (from the coupled transducers 711) is light emitted at a different wavelength λ_{E2}, where λ₁≠λ_{E1}≠λ_{E2}. FIG. 7C illustrates configuration information, whereby the distance changes of the detector 712 (i.e. conformational changes with and without the specified ligand being bound) are coupled to the transducer pair 713. FIG. 7D shows the combination of these three different design items (FIGS. 7A-C) to form the instantiation of the resulting biomachine design, which graphically translates the previous “If-Then” statements.

In this instantiation (FIG. 7D) of the generic detector system 714, the detection limit for gp120 is set at 1 nM. The incident radiation λ₁ is centered at a different wavelength from that of the output radiation λ_{E1} and λ_{E2}. In the exemplary embodiment of the generic machine (according to the “If-Then” statements) the trandsucers are chosen such that, if the incident radiation is λ₁=X nm 716, and there is more than 1 nM of gp120 present in the sample 715, then the output radiation λ_{E1} is centered at Y nm 717. Otherwise (i.e. there is less than 1 nM of gp120 720 or other ligands are present), the output radiation is λ_{E2} centered at Z nm 722 (still with λ₁=X nm 718, 721). This invention, however, is not limited to transducers with only these choices of incident and emission wavelengths. From the state diagram a series of “If-Then” conditional statements can be derived automatically (example of such an automated translator includes CASE tools with code-generation capabilities such as Rational Rose by Rational Software and MetaMill from MetaMill Software, Inc.)

FIG. 8 exemplifies design ontology segments, illustrating the branches of the decision tree searched by the inference engine to locate the transducer process that would return a response according to the sort of behavior (of the biomachine) that the “If-Then” statements require. The designed biomolecular machine should emit energy into either of two output channels, both of which are in a different energy range from that of the input channel (i.e. the input and the two outputs are all distinguishable from each other). The “If-Then” statements further require that only one of the two output channels from each individual biomachine should be triggered at any given instant, and that that energy emission should take the form of electromagnetic radiation. The decision tree leads to fluorescent resonance energy transfer (FRET) as a suitable signaling process.

The CAD inference engine will treat the sum of all of the statements and conditions in the requirement as a model or a hypothesis. In expanding the terms in the hypothesis using the Biomolecular Engineering Ontology, external and internal database cross-references and guided questionnaire for the user, the CAD's inference engine would attempt to populate missing information and expand on the detail of the requirement model. Definitions that yielded no ontology mapping might be used for training of the knowledge-base through a supplementary software module for knowledge acquisition.

In traversing the Biomolecular Engineering Ontology, the inference engine would cross-reference terms classifying parts and designs. The evolving specification of the model in the form of definition and conditional statements is visible to the user, and the user can change the definition directly. For example, the possibility that the biomachine being designed for gp120 detection could be realized by linking a sensor to a transducer would result from interactions with the design database.

Concurrent to the search along the Parts portion of the ontology, a parallel search takes places along the “Design” portion in an attempt to find known biomolecular machine designs. In the gp120 reporter system example, the design model as described by the IF-THEN statements requires a light-based device with one input and two output states.

Statements that include-undefined terms (e.g., specific nouns such as “gp120” or “ligand”) will be resolved via a search in the Biomolecular Engineering Ontology. For example, since gp120 is a specific noun and is initially an unknown term to the CAD, but the input requirement identified it as a ligand, then the CAD's inference engine will search for “ligand” in the Biomolecular Engineering Ontology. The node containing “ligand” 902 can be found by a number of ways including a search of the index of Node Names or an index of Slot Value or step-wise traversal of the semantic network. In this exemplary version of the ontology, “ligand” occurs in two segments of the ontology 901, 902 (see FIG. 9).

Since gp120 is identified as a ligand 902, and as a ligand can be an organic or an inorganic molecule, and as an organic molecule can be a protein, an RNA or a DNA strand 903, the CAD's inference rule for expanding the definition of terms can follow these leads to activate two possible processes:
1) It searches the individual databases containing inorganic ligand such as Tripos's small molecule database RS-Cube and protein databases such as SwissProt or Trembl or the Parts Database for the term “gp 120”.
2) Or, it queries the user to resolve which of the possible branches of definitions is most valid and as a result restricts the searches to protein databases.
   If there is a successful return of a match for gp120 in the protein database or the ambiguity was resolved by questioning the user, additional fact or definition such as “gp120 is a protein molecule” will be added to the requirement model.

For example, the expansion of the “ligand” concept also captures the fact that the part required to recognize gp120 is a kind of sensor 901 and more specifically a sensor for a protein ligand named gp120, and a sensor is an entry in the parts ontology (see FIG. 4). The following new fact would then be added to the requirement model: The biomolecular part that recognizes gp120 is a sensor. Therefore, there is one segment that expands on the concept of a sensor 901, while another segment expands on the concept of a ligand 902.

The inference engine would then activate a parallel process to search on the branches containing sensors within the parts knowledge-base/ontology to identify one or more classes of parts that match the facts collected so far about the required sensor, or to query the user with questions to resolve the decision regarding on which branch of the ontology to descent. FIG. 9 exemplifies the sensor ontology segments that are searched by the inference engine to find the appropriate sensor for ligand binding.

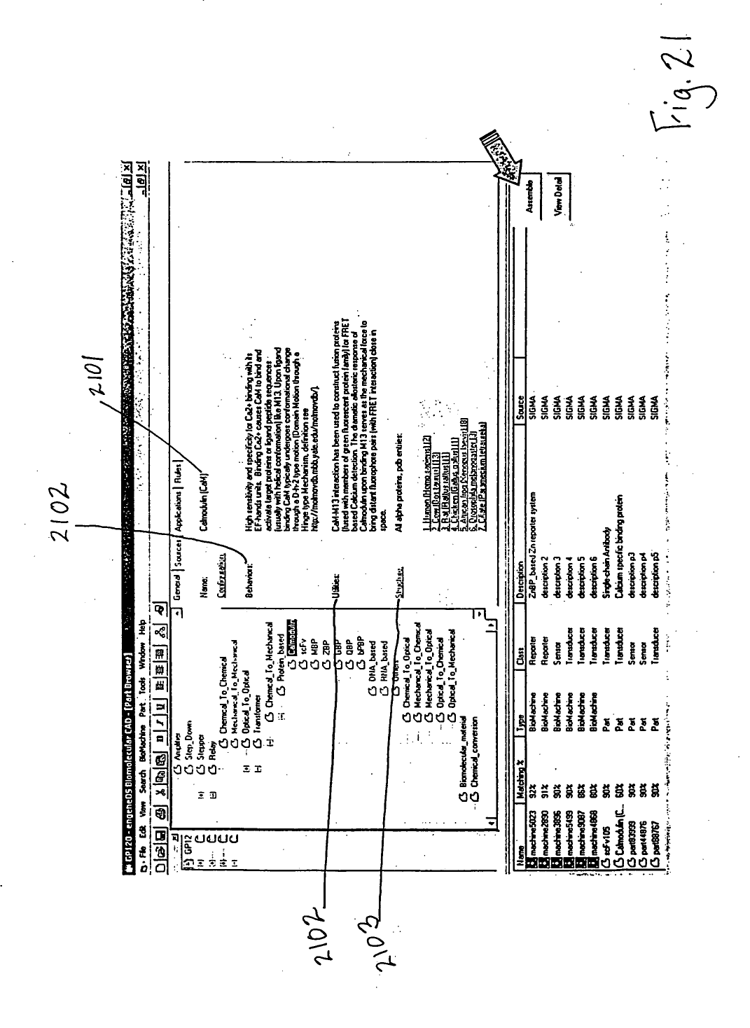

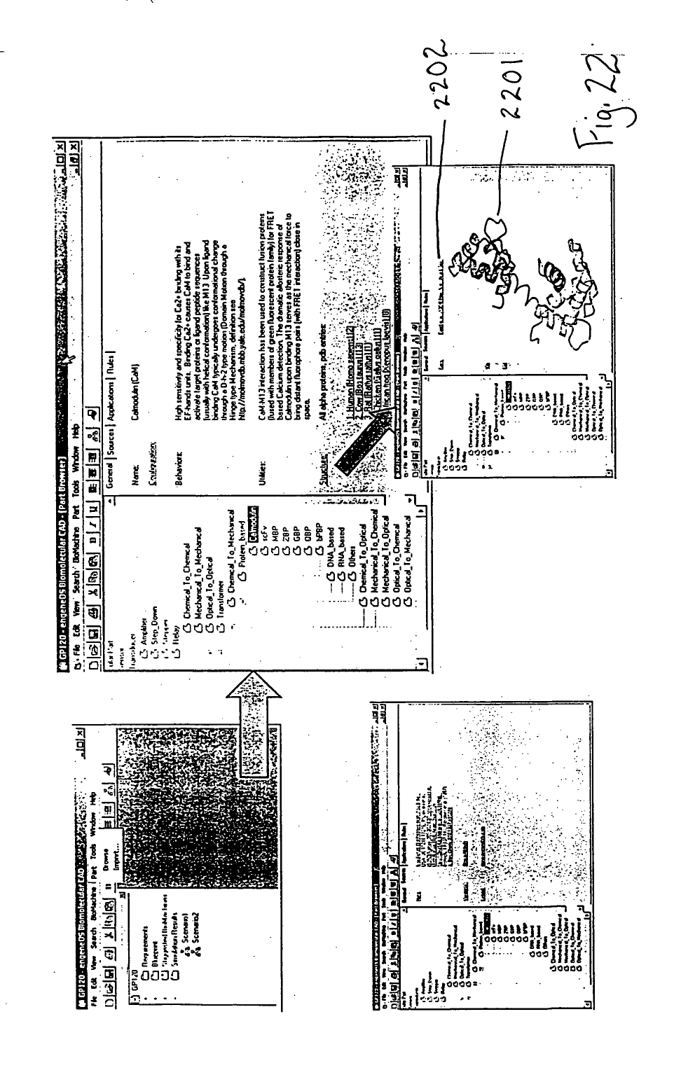

The “Peptide Ligand” branch in turn distinguishes among the various epitope types. Distinguishing factors include whether the site of recognition is based on the sequence of the peptide, or its structure, or its post-translational modification, or when it is in complex with other molecules through the implementation of transition rules (for example, an antibody that is specific to gp120 when it is in complex with CD4). (FIG. 18 exemplifies the GUI 1801, wherein the user inputs the target analyte, in this case gp120.) For example, if the user wanted to create a biomolecular machine to detect calcium ions (Ca²⁺), and given that many effects of Ca²⁺ in cells are mediated by Ca²⁺ binding to calmodulin to form CaM (which causes CaM to bind and activate target proteins or peptide sequences), then the inference engine could choose a sensor with calmodulin or a calmodulin-related protein as the binding protein. FIG. 21 exemplifies the system results for Calmodulin 2101, listing its behavior 2102, utilities 2102, and structure 2103. When the user chooses to view the structure of Calmodulin, the system returns a graphical model of the structure of Calmodulin 2201 (as exemplified in FIG. 22), along with the journal reference 2202. Alternatively, the inference engine could also return a protease sensor, along with the transition rules for transforming a protease reporter into a calmodulin reporter (which requires substituting a sensor domain). As another example, if the user wanted to create a biomolecular machine for maltose detection, then a maltose binding protein (MBP) would be the sensor chosen from the parts knowledge-base. Although all these choices of sensors are appropriate for ligand binding, the exact nature of the actual ligand to be bound makes the final determination. The binding protein would need to have a peptide-binding region for binding the desired analyte.

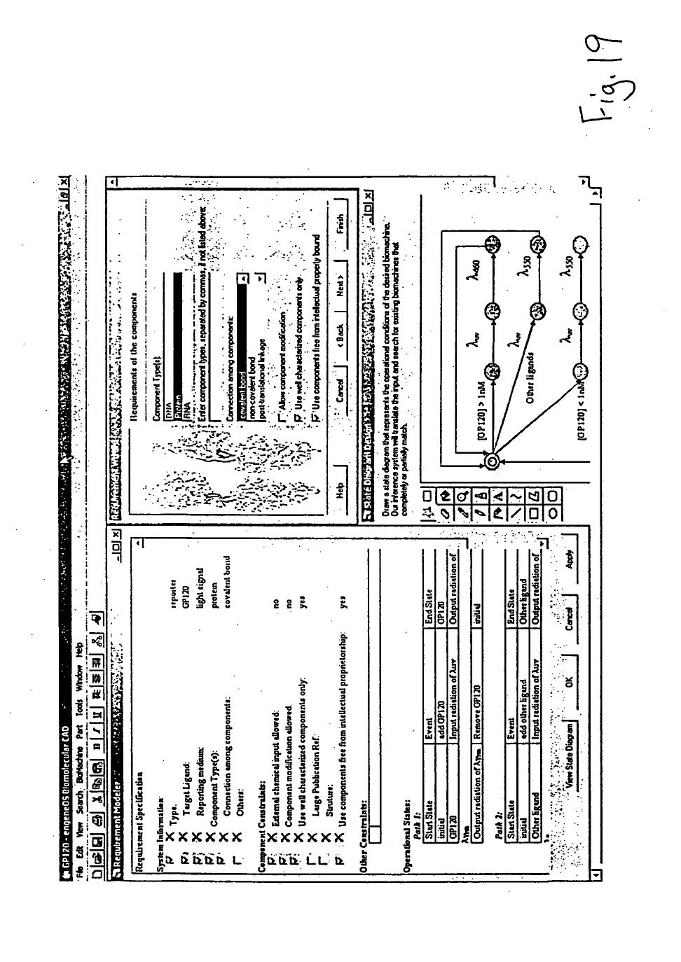

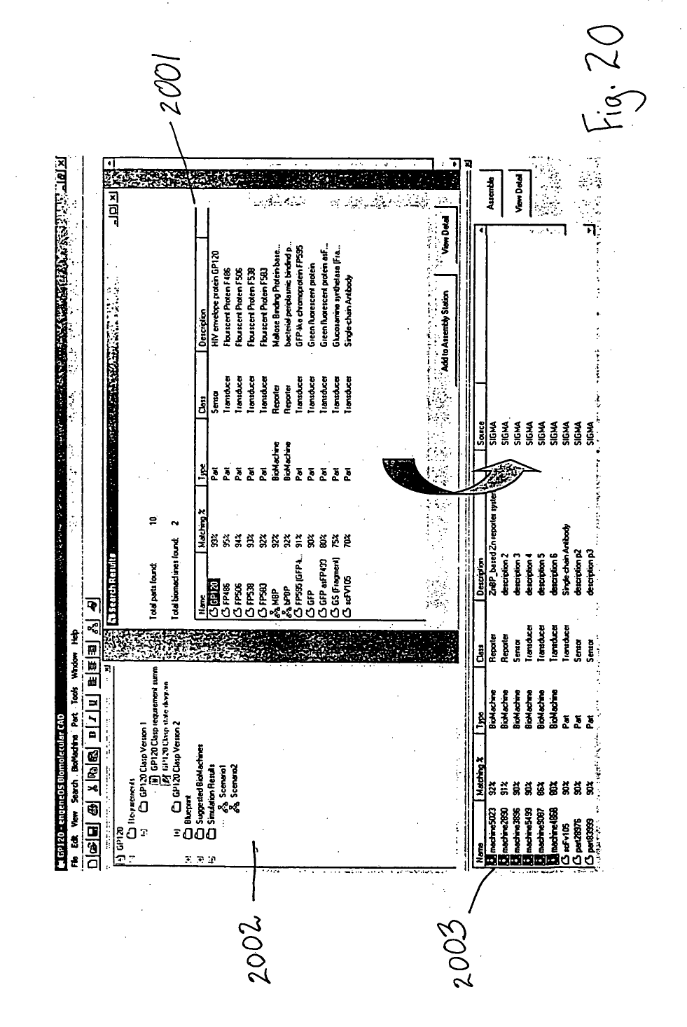

Since the model of the specification has no further information on the ligand that would resolve these discriminating factors, the CAD can take two paths: 1) ask the user to choose among the discriminating factors, using the questions residing in the nodes as a guide, and 2) retrieve all peptide sensor with specificity to the glycoprotein gp120. The user might be especially interested in a sensor that recognize only the glycosylated portion of a ligand, but in most cases the users are interested in seeing all of the options. FIG. 19 exemplifies a GUI, where the system communicates with the user to input and modify the requirements of the biomachine to user satisfaction. The system also returns a list of suggested parts and biomachines 2001 that potentially match the requirements (as exemplified in FIG. 20). Each stage of the design process is saved in a project workspace 2002, which is maintained 2003 for the user.

Through combining the Class ID found in the node for “peptide sensor” and the ligand name equals to “gp120”, an SQL statement can be formulated to retrieve all parts from the parts knowledge-base matching these conditions. In an exemplary implementation of the parts knowledge-base, eleven sensor parts that recognize gp120 (Wyatt, R. et al., Nature (1998) 393: 705-710) as listed in Table 1.

TABLE 1

| SENSOR | REFERENCE |
|---|---|
| F105 | Posner, M. et al., J. Immunol., 1991, 146: 4325-4332 |
| 15e | Ho, D. et al., J. Virol., 1991, 65: 489-493 |
| 21h | |
| 1125h | Thali, M. et al., J. Virol., 1992, 66: 5635-5641 |
| 448D | |
| 39.3 | |
| IgG1b12 | |
| 830D | |
| 17b | Thali, M. et al., J. Virol., 1993, 67: 3978-3988 |
| 48d | |
| 2G12 | Trkola, A. et al., J. Virol., 1996, 70: 1100-1108 |

More illustrative of the use of the parts ontology and the parts knowledge-baseis the search for a transducer to fit the requirements. The conditional conversion of a light 1002 input from one wavelength to another wavelength is a characteristic of a “Transducer”, as defined by the Biomolecular Engineering Ontology. FIG. 10 illustrates an exemplary logical hierarchy, showing the branches of the transducer ontology segment 1001 that would be searched for the appropriate transducer that satisfies the stated requirements. In traversing the parts ontology tree, the inference engine will activate questions residing in slots at each node that help to resolve the characteristics of the various transducers. The end result includes a path to one or more leaf nodes. For example, transducers are classified by their input and output modality and amplitude, such that a transducer that converts chemical energy to mechanical energy is separately classified from the transducers that converts optical signal from one wavelength to another wavelength.

In an exemplary embodiment, evaluating the gp120 Clasp model leads to the selection of a “no post-translation modification required”, “protein”, “fluorescent” class of transducers, which include two subclasses of parts, Green Fluorescent Protein (GFP) and DS Red. FIG. 11 illustrates an exemplary heirachy, showing the optical transducer ontology sub-segments that eventually lead to a choice of either GFP or DS Red. The system could also return transition rules for transforming one of the variants of GFP, e.g. a cyan-fluorescent protein “CFP”, into another variant, e.g. yellow-fluorescent protein “YFP” (which requires changing a few known amino acids). In an exemplary embodiment, searching the parts knowledge-base will return 15 records for Green Fluorescent Proteins and variants (see, for example, Tsien, R. Y. et al., (1998) Ann. Rev. Biochem. 67:509-544) and 2 records for DS Red and variants (see, for example, http://www.clontech.com/products/catalog01/Sec5/DsRed2.shtml). However, the conditional statement that the components of the desired biomachine are well characterized and not bound by IP could limit the choice of transducers to only GFP or its variants.

Examples of Parts Knowledge-Base Records for Aqueorea-Related GFP and Variants
Name: S65T
Part Class: Green fluorescent protein (GFP)
Classes: fluorophore
Behaviors: excitation maximum at 489 nm; emission maximum at 511 nm
Related parts: blue fluorescent protein (BFP); blue-green fluorescent protein (B-GFP); yellow-green fluorescent protein (Y-GFP)
Refs: Tsien, R. Y. et al., (1993) Trends Cell Biol. 3:242-245.
Name: P4-3
Part Class: Blue fluorescent protein (BFP)
Classes: fluorophore
Behaviors: excitation maximum at 381 nm; emission maximum at 445 nm
Related parts: green fluorescent protein (GFP); blue-green fluorescent protein (B-GFP); yellow-green fluorescent protein (Y-GFP)
Refs: Tsien, R. Y. et al., (1993) Trends Cell Biol. 3:242-245
Name: W1B
Part Class: Blue-green fluorescent protein (B-GFP)
Classes: fluorophore
Behaviors: excitation maximum at 432 run; emission maximum at 476 nm
Related parts: blue fluorescent protein (BFP); green fluorescent protein (GFP); yellow-green fluorescent protein (Y-GFP)
Refs: U.S. Pat. No. 5,998,204
Name: 10C
Part Class: Yellow-Green fluorescent protein (Y-GFP)
Classes: fluorophore
Behaviors: excitation maximum at 513 nm; emission maximum at 527 nm
Related parts: blue fluorescent protein (BFP); blue-green fluorescent protein (B-GFP); green fluorescent protein (GFP)
Refs: U.S. Pat. No. 5,998,204

Based on the specification of the model, the transducer chosen is a relay of an optical signal from one wavelength to another wavelength. But the model also specified that the conversion occurs only when a sensor is activated (the first “If-Then” Statement). The restrictions on the choice of transducers also require that they be compatible with the sensor component of the biomolecular machine. The assembly rules then further restrict the candidate transducer parts, based on their compatibility with the chosen sensor parts.

As exemplified in FIG. 3, several design combinations of sensors and transducers could be ruled out as non-viable as a result of the application of the assembly rules. If the system cannot find the right combination of parts in an initial search, then it will backtrack to the parts knowledge-base and apply transition rules to a part (which performs closely to the desired part) in order to manufacture another candidate part. Exemplifying this is the choice of sensor for the gp120 detector. The multi-chain anti-body (IgG) with the desired specificity may not be compatible with the choice of transducers, due to disruption of the activity of both (sensor and transducer) portions of the biomolecular machine once they are linked together. Transition rules in the anti-body class would be applied, which can change the multimeric anti-body into a scFv with the same specificity as the IgG. As explained in further detail in the next section, the scFv forms a viable exemplary biomachine with the chosen transducers.

FIGS. 12A-D exemplifies the schematic design case for a more specific allosteric ligand sensor (a molecular clasp), which detects the desired analyte, and which incorporates all of the constraints and function-purpose/operational states of the requirements as inputted by the user. FIG. 12A exemplifies a design item that serves as the sensor portion 1200 of the molecular clasp (which satisfies the conditions of the generic detector illustrated in FIG. 7A). This sensor portion has two states (i.e. two conformations). Without the desired ligand being bound to the sensor 1201 (which has two domains linked by a linker), two portions of the sensor are Distance 1 apart. When the sensor binds the desired ligand, the said two portions of the sensor move to Distance 2 (through the action of a transducer 1203, which is part of the sensor portion).

FIG. 12B exemplifies a more specific fluorophore pair chosen for this embodiment of the molecular clasp, which serve as the signal transducers (as exemplified in FIG. 7B), and which performs the FRET process needed to satisfy the conditional “If-Then” statements. When the fluorophores 1204, 1205 are farther than distance B apart, and for incident radiation at wavelength λ₁, then one of the two fluorophores 1204 preferentially absorbs the incident photons, and radiatively emits a photon of wavelength λ_{E2} (where λ_{E2}≠λ₁). When the fluorophores 1204, 1205 are closer together than distance A, energy is transferred (generally through non-radiative processes) from the first (absorbing) fluorophore 1204 to the second fluorophore 1205, which then emits radiation at a completely different wavelength λ_{E1} (where λ₁≠λ_{E1}≠λ_{E2}) Parameters such the efficiency of FRET coupling of the two fluorophores chosen, and their separation during the FRET process, affect the amount of light emitted by the second fluorophore 1205.

FIG. 12C is an exemplary representation of assembly rules, which indicate that the distance changes of the detector (sensor conformation before and after ligand binding) must be transferred to the transducer pair (FRET-based fluorophores). Although the behavior of a fluorophore is largely specified by the wavelengths of the incident and emitted radiation (independent of its internal chemical structure), this structure is relevant to such assembly rules as the conjugation chemistry needed to link the fluorophore to a sensor and to steric hindrance of the fluorophore on sensor operation. Linkers are chosen that are compatible with the allosteric sensor and the fluorophore pair, i.e. they link the fluorophore to the portion of the allosteric sensors located away from the binding site (and which performs the distance changes). Linking protocol 1206 is followed, such that the linkers transfer the distance changes of the allosteric sensor portion 1200 to the FRET fluorophore pair 1204, 1205. Additionally, the allosteric sensor portion 1200 and linking protocol 1206 must be chosen such that the minimum separation of the sensors (Distance 2) is transferred to the fluorophore pair, and such that the final separation of the fluorophores is small enough to allow the FRET process between them to occur (i.e. Distance 2 (as affected by linkers and linking protocol)≦Distance A).

FIG. 12D exemplifies an embodiment of the generic ligand detector (the molecular clasp 1207), which includes the sensor portion 1200, the linkers 1208, 1209, and the fluorophore pair 1204, 1205. In the absence of the desired analyte 1202, electromagnetic radiation of a particular wavelength (λ_{E2}) is returned. However, on binding of the analyte 1202 (ligand), electromagnetic radiation of a completely different wavelength (λ_{E1}) is returned, since the distance change of the sensor portion 1200, as transferred to the fluorophore pair 1204, 1205 by the linkers 1208, 1209, allows the FRET process between the fluorophores. In this exemplary representation (FIG. 7D) of the generic detector system, the detection limit for gp120 is set at 1 nM. The incident radiation λ₁ is centered at a different wavelength from that of both of the output radiation λ_{E1} and λ_{E2}. In one embodiment of the molecular clasp the fluorophore pair are chosen so that, if the incident radiation (λ₁) is in the ultraviolet (UV) region of the electromagnetic spectrum (λ<400 nm), then output signal of λ_{E1}=550 nm is radiated when the desired analyte binds to the sensor, and the output radiation is λ_{E2}=460 nm otherwise. FIG. 17 exemplifies a GUI for drawing the desired operational states (as described above) of the biomachine, to form the “State Diagram Design” 1702.

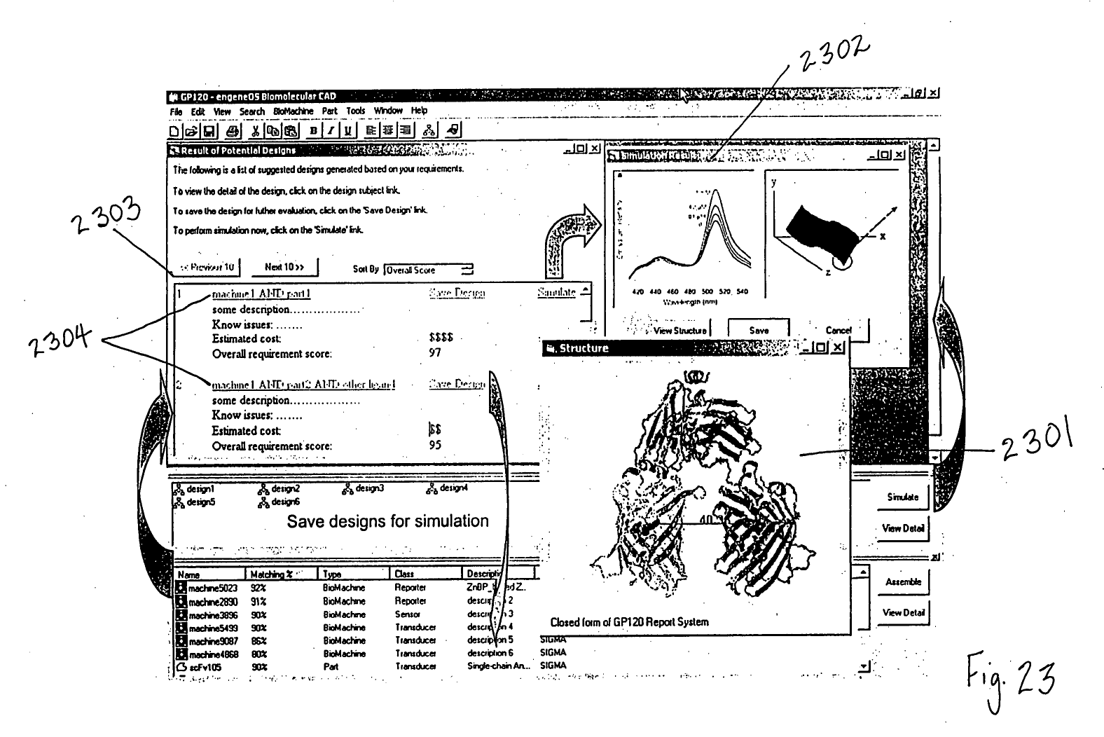

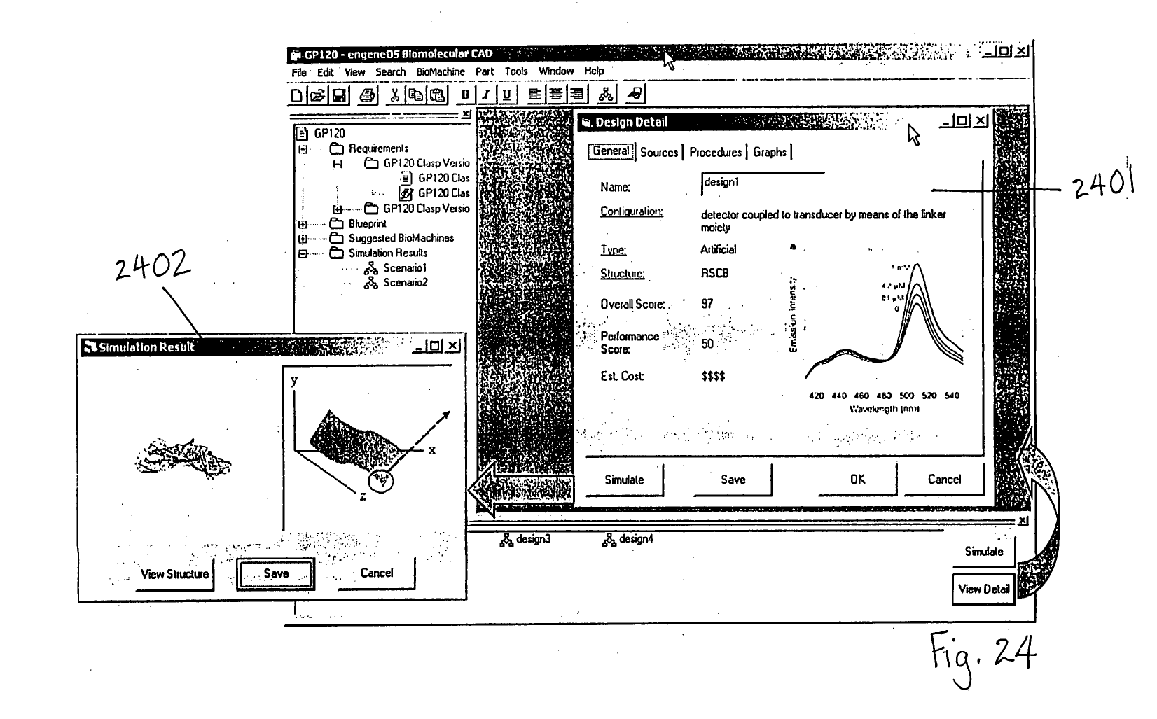

FIGS. 13 and 14 exemplify a specific instantiation of the detector of the generic class represented by FIG. 12D. FIG. 13 shows the scFv allosteric sensor 1301 as part of a Molecular Clasp 1300, as it is linked to the YFP-CFP fluorophore pair 1302, 1303. FIG. 13 shows the Clasp 1300 in its “open” conformation, where the YFP-CFP fluorophore pair 1403, 1404 is separated by 88.79 Å (i.e. too far apart for the FRET process to occur). If the Molecular Clasp were irradiated with UV light (wavelength<400 nm), then the output emission would be centered at 460 nm. FIG. 14 shows the change in comformation of the sensor 1401 portion of the Clasp 1400 in its “closed” comformation. As a result of the gp120 ligand 1402 binding, the YFP-CFP fluorophore pair 1403, 1404 is now only 40.38 Å apart. If the Molecular Clasp were irradiated with UV light, then the output emission would be centered at 550 nm. FIG. 23 exemplifies the assembly and simulation of the specific design of the gp120 reporter system, showing the Clasp in the “closed” conformation 2301. The user is able to simulate the results of the operation of the gp120 reporter 2302, and also gains additional information on the biomachine, including the cost 2303, etc. Throughout the design and simulation process, the user interacts with the system and tests different designs (using different parts) 2304, to find the optimal desired gp120 reporter. FIG. 24 exemplifies the GUI showing details of the design 2401 and the simulation results 2402 for the chosen gp120 reporter.

The example section below illustrates several design cases of biomolecular machines.

### 6. EXAMPLES

This section provides examples of design items, both individual parts and design schema (or cases), which may, for example, be derived from databases, reference publications, prior design activities according to the present invention, and commercial sources. Also, this application incorporates U.S. patent application Ser. No. ______ (to be determined), filed Nov. 28, 2001, titled “MODULAR MOLECULAR CLASP AND USES THEREOF,” by Carlo Rizzuto et al., by reference in its entirety and for all purposes, but especially as an example of the use of the methods of the present invention.

These examples are illustrative of a currently preferred embodiment and are not to be taken as limiting the scope of the present invention. For example, the prior detailed descriptions of the present invention made use of other examples that are illustrative of alternative, more comprehensive preferred embodiments. In most cases, design items will be described by a large number of attributes, only the most basic of which can be illustrated here. Further, although the following description is in terms of linked frames with attribute slots, these examples could equally well be implemented as a relational (or other format) database.

### Example 6.1

This subsection presents exemplary frame structures for design and part schema. For both schema, the named slots are accompanied by descriptions of their intended contents.

An exemplary format for a design schema is the following:

Attribute Contents Name
Design_ID: identifier (id.) for this design case/schema or schema class
Name: text name of schema (e.g.: for display)
Classes: schema classes or schema directly related: “up” from this instance, perhaps into ontology; or “down” from this instance to more specific instance; designated, preferably, by design ids.
Purpose: the purpose for which this design is intended; may be represented informally by, e.g., a description of activities and response to stimuli, or formally by, e.g., a state diagram, or if-then rules, or so forth
Behaviors: other activities and responses known or expected for this schema; may be represented informally or formally; a behavior may be a part of the purpose, or it may be incidental to the purpose
Parts/schemas: (i) component parts of the schema represented as classes of suitable parts or as individual parts; (ii) a schema may also include sub-schema or classes of sub-schema playing the role of a part; (iii) designated, preferably, by design or part ids.
Config: structure relationship of parts so that purpose of schema is achieved; also included are physical, structural, or chemical parameters of the schema (e.g.: size; primary, secondary, tertiary structures; binding affinities; enzymatic capabilities; or so forth)
A. rules: assembly rules provide constraints, limitations, or requirements so that a biomachine may be actually be made according to the configuration to carry out the purpose; these rules usually depend on physical, structural, or chemical parameters on the parts (or part classes), perhaps in relation to the behaviors and parameters of the schema
T. rules: transition rules, especially for design classes: assembly-type rules providing requirements and constraints for relating or converting one design in the class into another design in the class; and manufacturing-type rules providing instructions or protocols for performing such conversion
M. rules: manufacturing rules provide instructions, or protocols for an artisan using both common knowledge and specialized knowledge, or protocols or reagents, to make a physical instance of the schema (or an instance of a schema of the schema class); specialized knowledge may be in the form of references to external data or to special manufacturing knowledge stored within the present invention; if a schema is commercially available, then M. rules may need only refer to the commercial source
Refs: pointers to data external to the present invention; external data may include journal references, sequence databases, structure databases, function databases, and so forth.

An exemplary format for a part schema is the following:

Attribute Contents Name
Part_ID: identifier (id.) for this part or part class
Name: text name of part (e.g.: for display)
Classes: (as for design schema)
Behaviors: activities and responses known or expected for this part; for example, substrates and products, or allosteric changes, or so forth; may be described informally or represented formally (e.g., as a state diagram);
Config: for a part, distinguishing characteristics within its nearest super-class; for a part class, type and structure or parts in class; parameters describing how this part may structurally relate to other parts; also individual physical, structural, or chemical parameters of the schema (e.g.: size; primary, secondary, tertiary structures; binding affinities; enzymatic capabilities; or so forth)
Related parts: parts classes or parts that may be structurally related to this part in designs; designated, preferably, by design or part ids.
A. rules: assembly rules provide constraints, limitations, or requirements required so that this part may be structurally related to other parts in a manner preserving its behaviors; these rules usually depend on physical, structural, or chemical parameters of related parts (or of the part classes)
T. rules: transition rules, especially for parts classes: assembly-type rules providing requirements and constraints for relating or converting one part in the class into another part in the class; and manufacturing-type rules providing instructions or protocols for performing such conversion
M. rules: (as for design schema)
Sources: (as for design schema)
Refs: (as for design schema)

As described, instances of these design-item frames are variously related to represent important aspects of design knowledge. One such relation is a generic-specific descriptive hierarchy generally known as an “isa” hierarchy, according to which occurs attribute inheritance as illustrated in these examples. Therefore, when a more-specific instance is silent about the value of an attribute, the correct value is inherited from the first explicit occurrence found in the related more-generic instances.

The following representations of what is contained in the database have been rephrased for ease in human understanding. The actual database representation in the relational database would be more coded (i.e. less verbose).

### Example 6.2

This example provides an abbreviated taxonomy of parts and design schema starting from a generic class of ligand sensors and terminating in concrete instances of biomachine designs with previously confirmed ligand sensing behaviors.
Design_ID: ligand sensor (three part construction)
Classes: (isa—sensor)
Purpose: to detect the existence of a ligand through specific sensitive binding activity
Behaviors: to produce a signal upon ligand binding
Parts/schemas: ligand detector; transducer; linker moiety)
Config: detector coupled to transducer by means of the linker moiety
A. rules:—on ligand binding, the ligand detector produces response to which the transducer is responsive
   the detector's response is such that a linker moiety can couple the it to the responsive transducer
   the detector and the transducer are of a nature that permits responsive coupling by a linker moiety
   coupling by the linker moiety is arranged so that neither the detector's response to ligand binding nor the transducer's response to ligand binding at the detector is detrimentally affected
T. rules:—the linker moiety may be eliminated if the detector and the transducer can responsively couple directly to each other
M. rules:—coupling of the detector and the transducer is according to protocols appropriate to the linker.
Part_ID: ligand detector
Classes: (isa—part)
Behaviors: reversible transition between one state in the absence of specified ligand and another state in the presence of the ligand at a threshold or greater concentration, where the two states have different values of certain physical parameters
Config: (not specified)
Related parts: bPBP proteins; Abs
A. rules: ligand binding and unbinding is is reversible, sensitive, and pose no impedance to other necessary function(s) of detector
T. rules: minor modification at ligand binding site can transform it into different detector with different binding specificity
M. rules: (not specified)
Sources: (not specified)
Refs: (not specified)
Part_ID: bacterial-periplasmic-binding-protein family (bPBP)
Classes: isa—ligand detector; isa—prokaryotic protein
Behaviors:—members of this protein super-family bind to metabolic ligands and are targeted to the periplasmic space
   on ligand binding, members have significant allosteric response
Config: (not specified)
Related parts: (not specified)
A,T,M rules: (not specified)
Sources: (not specified)
Refs: Quiocho et al., 1997, Structure 5:997
Part ID: Maltose binding protein (MBP)
Classes: isa—ligand detector; isa—pPBP
Behaviors: ligand is maltose
Config: primary structure: Genbank id: V00303; tertiary structure: RSBD ids. 1 OMP without and 1 DMB with bound maltose
Related parts: glucose binding protein (GBP); glutamine binding protein (QBP)
A. rules:—conjugation sites must not detrimentally effect—sterically or otherwise—either the maltose binding pocket between two protein domains, or the allosteric response of the domain upon maltose binding
T. rules:—mutation of residues in binding pocket different may lead to different ligand specificities
M. rules: commercial source for protein; commercial source for cloning or expression reagents
Refs: Marvin et al, (1997) Proc. Natl. Acad. Sci. USA 94:4366-4371).
Part_ID: Glucose binding protein (GBP)
Classes: isa—ligand detector; isa—pPBP
Behaviors: ligand is glucose
Related parts: maltose binding protein (MBP); glutamine binding protein (QBP)
Part ID: Glutamine binding protein (QBP)
Classes: isa—ligand detector; isa—pPBP
Behaviors: ligand is glutamine
Related parts: maltose binding protein (MBP); glucose binding protein (GBP)
Part_ID: MBP-derived zinc binding protein (ZnBP)
Classes: isa—ligand detector; isa—pPBP
Behaviors: ligand is Zn²⁺
Related parts: maltose binding protein (MBP)
M. rules: derived from MBP by known point mutations; use known mutagenesis, cloning, expression protocols
Refs: Marvin et al, (2001) Proc. Natl. Acad. Sci. USA 98:4955
Part_ID: Antibody protein family (Abs)
Classes: (isa—eukaryoic protein)
Behaviors:—Abs bind to ligands of all sorts with various in vivo and in vitro behaviors
Config: multimeric (IgG, etc.); monomeric (scFv, etc.)
Related parts: (not specified)
A,T,M rules: well known in vivo and in vitro protocols to raise polyclonal and monoclonal antibodies of desired specificities; protocols to engineer and evolve specificities; protocols to convert between all types of Abs
Sources, Refs: many commercial sources; vast literature available
Part_ID: gp120—scFv
Classes: (isa—Abs)
Behaviors: —Abs bind to ligands of all sorts with various in Vivo and in vitro behaviors
Config: multimeric (IgG, etc.); monomeric (scFv, etc.)
Related parts: (not specified)
A,T,M rules: well known in vivo and in vitro protocols to raise polyclonal and monoclonal antibodies of desired specificities; protocols to engineer and evolve specificities; protocols to convert between all types of Abs

Sources, Refs: many commercial sources; vast literature available
Part_ID: parameter transducer
Classes:
Behaviors: transduces changes in certain parameters to a detectable output signal
Config: (not specified)
Related parts: (not specified)
A,T,M rules: (not specified)
Sources: (not specified)
Refs: (not specified)
Part_ID: linker moiety
Classes:
Behaviors: produce a detectable change in output signal in response to changes in certain physical parameters
Config: (not specified)
Related parts: (not specified)
A,T,M rules: (not specified)
Sources: (not specified)
Refs: (not specified)
Design_D: bacterial-periplasmic-binding-protein (bPBP)-based sensor
Classes: isa—ligand sensor—two-part construction
Purpose: on binding to ligand, produce changed fluorescent signal
Behaviors: (same)
Config:
Parts/schemas: a member of bPBP family binding to ligand; a fluorophore sensitive to environmental perturbations conjugated to protein
A. rules:—conjugation site at protein surface region with significant local motion in order to produce changed fluorescent signal
   conjugation site located so that fluorophore does not produce steric or other effects to remainder of protein or to ligand binding pocket
T. rules:—replace bPBP by a monomeric protein with relatively large allosteric effect on ligand binding
   replace single environmentally-sensitive fluorophore by a pair of fluorophores with a FRET (fluorescent resonance energy transfer) interaction
M. rules: commercial protein source (or cloning and expression protocols); commercial fluorophore source; if necessary, protein mutagenesis protocols to make conjugation site reactive; conjugation protocols
Refs: Marvin et al., (1997) Proc. Natl. Acad. Sci. USA 94:4366-4371).
Design_D: MBP-based maltose sensor
Classes: isa—bacterial-periplasmic-binding-protein (bPBP)-based sensor
Purpose: on binding to maltose, produce changed fluorescent signal
Config: thiol conjugation chemistry
Parts/schemas: E. coli maltose binding protein (RSBD ids. 1OMP without and 1 DMB with bound maltose); IANDB fluorophore (environmentally-sensitive and thiol reactive iodoacetamide fluorophore)
A. rules: (no new rules—a tested, physical sensor)
T. rules:—replace IANDB with a different environmentally-sensitive and thiol reactive iodoacetamide fluorophore
   use different conjugation site on MBP
   use MBP mutated to have a different binding specificity
M. rules: expression protocol for MBP mutated to have cysteine at conjugation site; conjugation chemistry protocols
Refs: Marvin et al., (1997) Proc. Natl. Acad. Sci. USA 94:4366-4371).

### Example 6.3

Numerous examples of fluorophore pairs, with the attribute that they are capable of supporting fluorescent resonance energy transfer (FRET), exist in the literature (found through a pointer to the literature database), including protein and small molecule fluorophores. For each pair, one fluorophore serves as a donor and one fluorophore serves as an acceptor. A key feature of the pair is that the emission spectrum of the donor fluorophore overlaps significantly with the excitation spectrum of the acceptor fluorophore. Thus, energy can be transferred non-radiatively from donor to acceptor, and is then emitted by the acceptor at a wavelength distinguishable from the natural emission from the donor. The efficiency of energy transfer is governed by the distance separating the fluorophores and by their relative orientation. The behavior of this Molecular Clasp includes to decrease the distance between its actuator modules (i.e. fluorophores) in response to ligand binding, thus increasing the efficiency of FRET. Green fluorescent protein (GFP) and related variants (Tsien, R. Y., Annu. Rev. Biochem. (1998) 67:509-44). Selected GFP variants are employed to enable fluorescence resonance energy transfer (FRET), which can be enhanced or diminished by ligand binding to the peptide sequence and consequent apposition or separation of the GFPs. In a preferred embodiment, the blue fluorescent protein (BFP) variant serves as the photon donor and GFP serves as the acceptor. In another preferred embodiment, cyan fluorescent protein (CFP) serves as the donor and yellow fluorescent protein (YFP) serves as the acceptor. FIG. 13 shows a molecular model of this preferred embodiment of the Molecular Clasp, with the CFP—YFP pair labeled, while the clasp is in its open comformation (separation of the fluorophore pairs is on the order of 89 nm). FIG. 14 shows this embodiment of the Molecular Clasp in its closed conformation, which occurs as a result of the GP120 ligand binding. The decrease in separation of the fluorophore pairs (from 89 nm to 40 nm) as a result of ligand binding results in increased efficiency of the FRET process between the fluorophores.

This is an Example of the Configuration of Parts in the Design of Parental CFP-YFP Vector for Cloning.

CFP AA 1-230 will be used. Ile230 will be substituted by Arg (deletion and mutation analysis of GFP has demonstrated that position 230 can tolerate non-conservative amino acid substitutions without loss of fluorescence). Introduction of Arg facilitates SalI restriction site engineering, which will be used for subsequent cloning of single chain sequences.

YFP AA 4-230 will be used. It has been demonstrated that AA 2 and 3 of GFP are not part of the beta barrel structure and, as such, are flexible. There is a SrfI half site encoded by the last nucleotide of Lys4 and the 3 nucleotides for E5.

For ease of purification a His6 tag is added at the C-terminal end of YFP followed by two stop codons to ensure a translational stop.

We wish to express EFCs in bacterial, yeast and insect cells. The ECHO cloning system from Invitrogen was chosen as a desirable cloning system. This system permits cloning of coding regions of proteins into a donor vector (pUni) followed by subsequent crelox mediated mobilization into highly inducible bacterial, yeast, insect vectors. Expression vectors with lower levels of expression are also available. For these experiments pUniHisV5Blunt was chosen as the donor vector. PCR-T7E, pYES2.1E and pIBxx were initially chosen as acceptor vectors.

Creation of a CFP-YFP Vector for Modular Cloning of Engineered Single Chain Antibodies Containing Variable Linker Regions.

Oligonucleotides M1 and M2 were used to amplify the desired fragment from CFP, including a SalI site, which also encoded the first amino acid of the single chain fragments to be cloned into the EFC. Oligonucleotides M3 and M4 were used to amplify the desired fragment from YFP creating a SrfI site. Oligonucleotides M2 and M3 share overlapping sequence such that the templates generated by the PCR described above can be used as template for overlap PCR with oligonucleotides M1 and M4 creating coding regions of CFP (AA 1-230) and YFP (AA 5-230) separated by 4 amino acids. The linker region between CFP and YFP contains SalI and SrfI sites, enabling subsequent cloning of single chain antibody variants as sticky-blunt end PCR products.
Part name: AA 1-230
Part_ID: Cyan fluoroescent protein (CFP)
Classes: isa—fluorophore
Part name: AA 4-230
Part_ID: Yellow fluorescent protein (YFP)
Classes: isa—fluorophore
Source: ECHO cloning system, from Invitrogen

### Example 6.4

Manufacturing protocol of a part—ScFv105 (parts class Binding Module) is a single chain antibody capable of recognizing the HIV protein gp120 with high specificity. We wanted to identify the minimal domain of ScFv105 that was involved in binding to antigen. The amino acids contributing to beta sheet structures in VH and VL were identified. The linker between VH and VL was fifteen amino acids in ScFv105 and we engineered variant linkers of 3, 6, 9 and 12 amino acids respectively (comprising different numbers of amino acids). GGS was chosen as the minimal linker sequence. Desired regions of VH and VL were amplified from ScFv105 using oligonucleotides M7, M8 and M9, M10 respectively. The PCR products corresponding to VH and VL were cloned into pUniBlunt to serve as templates for building F105-L12, F105-L9, F105-L6 and F105-L3.

Oligonucleotides M5 and M6 were used to amplify the desired VH and VL domains, separated by a 15 amino acid linker, from ScFv105. The PCR product was digested with SalI and cloned into SalI and SrfI digested CFP-YFP to generate F105-L15.

Alternate manufacturing protocol 1—PCR products generated by M6, M11 and M5, M12 were used as substrates for overlap PCR with M5 and M6 to generate an engineered single chain antibody with a 3 amino acid linker-capable of recognizing gp120. The PCR product was digested with SalI and cloned into SalI and SrfI digested CFP-YFP to generate F105-L3.

Alternate manufacturing protocol 2—PCR products generated by M6, M13 and M5, M14 were used as substrates for overlap PCR with M5 and M6 to-generate an engineered single chain antibody with a 6 amino acid linker capable of recognizing GP 120. The PCR product was digested with SalI and cloned into SalI and SrfI digested CFP-YFP to generate F105-L6.

Alternate manufacturing protocol 3—PCR products generated by M6, M15 and M5, M16 were used as substrates for overlap PCR with M5 and M6 to generate an engineered single chain antibody with a 9 amino acid linker capable of recognizing gp120. The PCR product was digested with SalI and cloned into SalI and SrfI digested CFP-YFP to generate F105-L9.

Alternate manufacturing 4—protocol 4—PCR products generated by M6, M17 and M5, M18 were used as substrates for overlap PCR with M5 and M6 to generate an engineered single chain antibody with a 12 amino acid linker capable of recognizing gp120. The PCR product was digested with SalI and cloned into SalI and SrfI digested CFP-YFP to generate F105-L12.

### Example 6.5

This design case describes the use of the class of parts.(contained in the parts database) of E. coli maltose binding protein (MBP) in a biomachine, which purpose is to serve as a maltose biosensor. The E. coli MBP has the attribute that it undergoes a significant conformational change upon ligand binding, as referenced though a pointer to literature database containing the article by Zukin et al. ((1977) Proc. Natl. Acad. Sci. USA 74:1932-6). The assembly protocol for the biosensor involves the judicious placement of fluorophores (a different class of parts) into the MBP structure, as referenced though the pointer to the article by Marvin et al ((1997) Proc. Natl. Acad. Sci. USA 94:4366-4371). The modified MBP behaves as a biosensor through a change in fluorescence due to relative rearrangement of the MBP domains (and attached fluorophore) in response to maltose binding. Here is an example of the design database entry for a maltose sensor:
Design case: Ligand reporter
Purpose: Maltose sensor
Behavior: Maltose binding causes change in fluorescence due to relative rearrangement of MBP and fluorophore domains.
Config: Chemically conjugated to protein in allosteric fashion
Part name: E. coli Maltose Binding Protein
Description: Genbank record(s)
Classes: isa—allosteric protein
Structure: RSCB id
Source: SIGMA part no.
Classes: isa—fluorophore
Reference: Marvin et al., (1997) Proc. Natl. Acad. Sci. USA 94:4366-4371).

### Example 6.6

A sensor for the purpose of detecting epitopes is designed using the parts alkaline phosphatase and epitopes from the parts database. The assembly protocol for the insertion of epitopes into alkaline phosphatase is a rule in design item database that is derived from the art; references to its derivation are in record, e.g. Brennan et al. ((1995) Proc. Natl. Acad. Sci. USA 92: 5783-5787) in the literature database. The biomachine behaves as a sensor, as its catalytic activity is rendered sensitive to the presence of antibodies specific for the epitopes. Variants of alkaline phosphatase were positively or negatively regulated by antibody binding.

Design Database Entry:
Design case: Sensor
Purpose: Epitope sensor
Behavior: Catalytic activity of alkaline phosphatase is rendered sensitive to the presence of antibodies specific for a given epitope
Config: Chemically conjugated to protein in allosteric fashion
A. rules: (not specified)
Part name: Alkaline phosphatase
Description: Genbank record(s)
Classes: isa—enzyme
Structure: RSCB id
Source: SIGMA part no.
Part_ID: Epitope
Source: SIGMA part no.
Reference: Brennan et al., (1995) Proc. Natl. Acad. Sci. USA 92: 5783-5787

### Example 6.7

This is an example of different parts and their attributes, described only by their design entries:

Design Case 1
Design_D: Calmodulin-based calcium sensor
Purpose: on binding to calcium, produce changed fluorescent signal
Parts/schemas: Calmodulin; fluorophore
Reference: U.S. Pat. No. 5,998,204; Baird et al. (1999) Proc Natl. Acad. Sci. USA 96:11241-11246; Miyawaki et al. (1997) Nature 388:882-887; Miyawaki et al. (1999) Proc Natl. Acad. Sci. USA 96:2135-2140; Nakai et al. (2001) Nat. Biotech. 19:137-141; Rosomer et al. (1997) J. Biol. Chem. 272:13270-13274
Name: S65T
Part_ID: Green fluorescent protein (GFP)
Classes: isa—fluorophore
Behaviors: excitation maximum at 489 nm; emission maximum at 511 nm
Related parts: blue fluorescent protein (BFP); blue-green fluorescent protein (B-GFP); yellow-green fluorescent protein (Y-GFP)
Name: P4-3
Part_ID: Blue fluorescent protein (BFP)
Classes: isa—fluorophore
Behaviors: excitation maximum at 381 nm; emission maximum at 445 nm
Related parts: green fluorescent protein (GFP); blue-green fluorescent protein (B-GFP); yellow-green fluorescent protein (Y-GFP)
Refs: Tsien, R. Y. et al., (1993) Trends Cell Biol., 3:242-245

Design case 2
Design name: Beta-lactamase sensor
Purpose: Beta-lactamase sensor
Part_ID: Ligand Binding Protein
Name: E. Coli maltodextrin-binding protein (MBP)
Classes: isa—enzyme
Name: TEM beta-lactamase
Config: TEM beta-lactamase is inserted into two loops of E. Coli MBP
A. rules: (not specified)
Behavior: Activity of beta-lactamase modulated by presence of maltose
Reference: Betton et al. (1997) Nature Biotech. 15:1276-1279

Design case 3
Design_ID: Epitope sensor
Purpose: Epitope sensor
Behavior: Catalytic activity of beta-galactosidase is rendered sensitive to the presence of antibodies specific for a given epitope
Config: Chemically conjugated to protein in allosteric fashion
A. rules: (not specified)
Name: Beta-galactosidase
Description: Genbank record(s)
Classes: isa—enzyme
Structure:. RSCB id
Source: SIGMA part no.
Part ID: Epitope
Source: SIGMA part no.
Reference: Benito et al. (1996) J. Biol. Chem. 271: 21251-21256beta-galactosidase

Design case 4
Design_ID: Beta-lactamase sensor
Purpose: Beta-lactamase sensor
Behavior: GFP fluorescence activity rendered sensitive to a ligand for beta-lactamase, beta-lactamase inhibitory-protein
Config: Insert beta-lactamase internally into GFP
A. rules: (not specified)
Name: Beta-lactamase
Description: Genbank record(s)
Classes: isa—enzyme
Structure: RSCB id
Source: SIGMA part no.
Part_ID: Green Fluorescent Protein (GFP)
Source: SIGMA part no.
Reference: Doi, N. and Yanagawa, H. (1999) FEBS Lett. 453: 305-7

Design case 5
Design Class: Insertion of an enzyme within sequence of a second enzyme
Config: BLA was inserted within PGK
A. rules: (not specified)
Name: Phosphoglycerate kinase (PGK)
Description: Genbank record(s)
Classes: isa—enzyme
Structure: RSCB id
Source: SIGMA part no.
Name: Beta-lactaniase (BLA)
Source: SIGMA part no.
Reference: Collinet et al. (2000) J. Biol. Chem. 275:17428-17433

Design case 6
Design Class: Insertion of an enzyme within sequence of a second enzyme
Config: DHFR was inserted within PGK
A. rules: (not specified)
Name: Phosphoglycerate kinase (PGK)
Description: Genbank record(s)
Classes: isa—enzyme
Structure: RSCB id
Source: SIGMA part no.
Part_ID: Dyhydrofolate reductase (DHFR)
Source: SIGMA part no.
Reference: Collinet et al. (2000) J. Biol. Chem. 275:17428-17433

Design case 7
Design Class: Mutagenesis of a non-allosteric protein
Config: Replacement of an amino acid
A. rules: (not specified)
Name: Pyruvate kinase M₁
Description: Genbank record(s)
Classes: isa—non-allosteric enzyme
Structure: RSCB id
Source: SIGMA part no.
Part_ID: Amino acid
Reference: Ikeda, Y. et al. (1997) J. Biol. Chem. 272:20495-20501

### Example 6.8

The engineering of a single chain antibody variant is an example of an assembly protocol, wherein a part from each of the parts class of Binding Modules and Actuator Modules are linked together with different Transducer Modules to create variations in the design case of a sensor for gp120.

In an exemplary embodiment of the Molecular Clasp, the binding module is the single chain antibody, F015 (scF105). The salient attribute of this part for this embodiment is that it binds specifically to the HIV-1 protein, GP120. In which case, this embodiment serves the purpose of a sensor for GP120. Contained within the scF105 binding module is a transducer module, which behavior is to convert recognition of GP 120 into a conformational change that will alter the physical proximity of the actuator modules. The biomachine contains two actuator modules, and is designed to provide detection of GP120 based on Fluorescence Resonance Energy Transfer (FRET) or fluorescence quenching between two fluorophores.
Database Entry:
Design case: GP120 Molecular Clasp
Purpose: Sensor for HIV-1 protein, gp120 sensor
Behavior: Convert recognition of gp120 into conformational change that alters physical proximity of two fluorophores, resulting in Fluorescence Resonance Energy Transfer (FRET) effect in fluorophore pair
A. rules: (not specified)
Name: F015 (scF105)
Classes: isa—sensor
Behavior: Binds gp120
Description: Genbank record(s)
Classes: isa—single chain antibody
Structure: RSCB
Source: SIGMA
Part_ID: Green fuorescent protein (GFP)
Classes: isa—fluorophore
Behavior: absorption at 400<λ<500 nm; emission at λ>500 nm
Reference: Tsien, R. Y., Annu. Rev. Biochem. (1998) 67:509-44
Part_ID: Blue fluorescent protein (BFP)
Classes: isa—fluorophore
Behavior: absorption at λ<400 nm; emission at λ<500 nm
Part_ID: Cyan fluorosecent protein (CFP)
Classes: isa—fluorophore
Behavior: absorption at 400<λ<430 nm; emission at 450<λ<500 nm
Part_ID: Yellow fluorescent protein (YFP)
Classes: isa—fluorophore
Behavior: absorption at 450<λ<500 nm; emission at λ>520 nm

### Example 6.9

The Example Details the Assembly Protocol for the Production of a Molecular Clasp.

A fusion nucleic acid encoding a Molecular Clasp was cloned into pUni and mobilized into pYES2 (URA3, 2 micron) via cre-lox mediated recombination (Invitrogen, CA). The yeast strain NVSC1 (MATα ura3-52, trp1-289, his3 δ1, leu2/MATa ura3-52, trp1-289, his3δ1, leu2) was transformed with the resultant plasmids which contained coding sequences for the Molecular Clasp under control of the inducible GAL1 promoter (Schiestl and Gietz, 1989) and Ura+ transformants were selected. Ura+colonies were grown at 30° C. in synthetic defined (SD) media lacking uracil supplemented with the neutral carbon source, raffinose, at a final concentration of 2%. Expression of Molecular Clasps was induced by addition of galactose to a final concentration of 2% when the cells were at an OD600 of 0.6-1.0. After induction for 6-8 hours at 30° C., cells were pelleted by centrifugation, washed with cold distilled water and frozen under liquid nitrogen.

Frozen cell pellets were thawed on ice, and resuspended in an equal volume of lysis buffer (5% glycerol, 50 mM sodium phosphate pH 8, 300 mM NaCI, 10 mM imidazole, 1 mM PMSF). Chilled acid washed glass beads (400-600 mm) were added to an equal volume. Cells were disrupted by vortexing for 30 seconds, followed by 60 seconds chilling on ice for a total of 4 minutes of disruption. Cell debris was removed by centrifugation and the soluble fraction loaded on Nickel-NTA columns (Qiagen, CA). Washes were performed with up to 100 mM imidazole and pH 6. His tagged proteins were eluted by application of imidazole in a gradient from (100 mM to 1 M). Fractions were analyzed by Western blotting with anti-GFP antibody (Santa Cruz Biotechnology, CA). Molecular Clasp-containing fractions were dialyzed against 20 mM Tris, 2 mM CaCl₂, 100 mM NaCl pH 8 for further analysis.

### Example 6.10

This Examplifies the Detailed Function Model for the use of a Biomachine.

The Molecular Clasp has utility as a diagnostic or analytical tool for detecting the HIV-1 antigen, gp120. Detection of gp120 in a sample would consist of the following steps:
1. Contacting an aliquot of Molecular Clasps with the sample, and possibly with dilutions of the sample
2. Illuminating the mixture with UV light (λ<400 nm)
3. Recording the emission from the mixture at 460 nm and 550 nm
4. Calculating a FRET ratio consisting of the emission at 550 nm divided by the emission at 460 nm-(550/460)
5. Contacting additional aliquots of Molecular Clasps with known concentrations of gp120 to create a standard curve
6. Calculating the FRET ratio (550/460) for each point on the standard curve
7. Comparing the ratio obtained in the experimental sample with the standard to curve to determine the precise concentration, or to determine that the concentration is out of range or undetectable
8. If the experimental concentration is out of range, the process could be repeated with dilutions of the sample

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

A number of references are cited herein, the entire disclosures of which are incorporated herein, in their entirety, by reference for all purposes. Further, none of these references, regardless of how characterized above, is admitted as prior to the invention of the subject matter claimed herein.

1-89. (canceled)

90. A computer-implemented method for providing user assistance in biomolecular biomachine design comprising:
(a) providing a bioengineering knowledge base comprising part-type design items comprising biochemical, protein, genetic, cellular, or multi-cellular items including physical description information and behavior information;
(b) retrieving from said knowledge base one or more digitally-represented candidate biomolecular design items by translating requirements provided for a said biomolecular biomachine according to a bioengineering domain model into queries to the knowledge base for design items capable of implementing the biomachine according to the domain model,
(c) constructing one or more digitally-represented candidate biomachines from the candidate design items by arranging part information represented in the candidate design items according to a selected structure, and
(d) evaluating the candidate biomachines according to bioengineering operability knowledge associated with the candidate design items, wherein operability knowledge associated with a design item specifies requirements for that item to inter-operate with other design items.

91. The method of claim 90 comprising the additional step of (d) backtracking to steps (a), (b), or (c), until at least one candidate biomachine is satisfactorily evaluated.

92. The method of claim 90 wherein the construction step further comprises arranging the part information according to structure information represented in one or more of the candidate design items.

93. The method of claim 90 wherein the digitally-represented candidate biomolecular design items comprises at least one schema-type design item including a selected structure, and at least one part-type design item arranged according to the selected structure.

94. The method of claim 90 wherein the provided biomachine requirements further comprise one or more constraints that the candidate biomachines must satisfy.

95. The method of claim 90 wherein the step of constructing comprises combining digitally-represented manufacturing knowledge associated with the candidate design items of the candidate biomolecular biomachines into manufacturing plans for manufacturing physical realizations of the candidate biomachines, wherein manufacturing knowledge associated with a design item specifies sources for or protocols for making a physical realization of that design item.

96. The method of claim 90 further comprising a step of manufacturing a physical realization of at least one candidate biomolecular biomachine according to a manufacturing plan.

97. The method of claim 90 further comprising a computer-implemented step simulating the operation of a physical realization of at least one candidate biomachine.

98. The method of claim 90 wherein the biochemical items include metabolites, or sugars, or polysaccharides, or lipids, or lipo-polysaccharides, or ions, or metal ion complexes, or coupling moieties, or phosphates, or amino acids, or phospholipids, or polynucleotides, or polypeptides.

99. The method of claim 90 wherein the protein items include enzymatic proteins, or fluorescent proteins, or allosteric proteins, or DNA binding proteins, or signal transduction proteins, or trans-membrane proteins, or transport proteins, or motor proteins, or mutlimeric proteins, antibodies, or single chain antibodies, or protein assemblies, or modified proteins, or proteins with conjugated moieties, or protein domains.

100. The method of claim 90 wherein the genetic items include nucleic acids, or protein-encoding nucleic acids, or transcription control elements, or promoters, or translation control elements, or expression vectors, or poly-linkers, or self-reproducing genetic elements, or cloning vectors, or plasmids, or viral genomes or components thereof, or prokaryotic genomes or components thereof, or eukaryotic genomes or components thereof.

101. The method of claim 90 wherein the cellular items include genetic regulatory networks, or signal transduction networks, or metabolic networks, or protein trafficking networks, or organelles, or lysozomes, or proteosomes, or spliceosomes, or ribosomes, or mitochondria, or chloroplasts.

102. The method of claim 90 wherein said part-type design items further comprise scaffold items include polymer linkers, or polypeptide linkers, or polynucleotide linkers, or lipid membranes, or lipid micelles and vesicles, or planar substrates, or glass substrates, or silicon substrates, or polymer substrates, or nylon substrates, or compartments, or arrangements of compartments linked by channels, or microtitre plates.

103. The method of claim 90 wherein the bioengineering domain model further comprises digital representations of a bioengineering domain ontology, a biomachine parts ontology, and a biomachine design ontology.

104. A computer-implemented method for providing user assistance in biomolecular biomachine design comprising: (a) translating requirements provided for a biomachine according to a bioengineering domain model into one or more digitally-represented candidate design items comprising biomolecular part information, the candidate design items represented being capable of implementing the biomachine requirements according to the domain model, and (b) constructing one or more candidate biomachines from the candidate design items by arranging the part information represented in the candidate design items according to a selected structure, whereby the candidate biomachines provide user biomachine-design assistance.

105. The method of claim 104 wherein the candidate design items comprising biomolecular part information comprise nucleic acids, or protein-encoding nucleic acids, or transcription control elements, or promoters, or translation control elements, or expression vectors, or poly-linkers, or self-reproducing genetic elements, or cloning vectors, or plasmids, or viral genomes or components thereof, or prokaryotic genomes or components thereof, or eukaryotic genomes or components thereof, or genetic regulatory networks, or signal transduction networks, or metabolic networks, or protein trafficking networks, or organelles, or lysozomes, or proteosomes, or spliceosomes, or ribosomes, or mitochondria, or chloroplasts.

106. The method of claim 104 wherein the design items further comprise: (a) schema-type design items having purpose information and structure information for arranging parts to achieve the purpose, and (b) part-type design items having physical description information and behavior information.

107. The method of claim 104 wherein the selected structure includes operability knowledge specifying a likelihood that design items inter-operates with other design items.

108. The method of claim 104 wherein the selected structure includes manufacturing knowledge associated with design items which specify sources for or protocols for making a physical realization of that design item.

109. A computer-readable medium having biomolecular biomachine design knowledge digitally encoded therein, the design knowledge comprising representations of: (a) biomolecular design items including structure information and part information, wherein a plurality of biomachine can be represented by combinations of part information according to structure information, and (b) bioengineering operability knowledge associated with the candidate design items, wherein operability knowledge associated with a design item specifies requirements for that item to inter-operate with other design items.
